(19) United States
(12) Patent Application Publication
(10) Pub. No.: US 2003/0048341 A1
(43) Pub. Date: Mar. 13, 2003

(54) High-throughput biomolecular crystallization and biomolecular crystal screening

(76) Inventors: Mitchell W. Mutz, Palo Alto, CA (US); Richard N. Ellson, Palo Alto, CA (US); Richard G. Stearns, Felton, CA (US)

Correspondence Address: REED & ASSOCIATES, 800 MENLO AVENUE, SUITE 210, MENLO PARK, CA, 94025, US

(21) Appl. No.: 09/765,947

(22) Filed: Jan. 19, 2001

Related U.S. Application Data
(63) Continuation-in-part of application No. 09/727,392, filed on Nov. 29, 2000, now abandoned.
Application No. 09/727,392 is a continuation-in-part of application No. 09/669,996, filed on Sep. 25, 2000, now abandoned.

(51) Int. Cl. G01D 11/00

(52) U.S. Cl. 347/100; 347/46; 347/95

(57) ABSTRACT

The present invention provides a method for the acoustic ejection of fluid droplets from fluid-containing reservoirs to form small volumes high throughput combinatorial experimentation for crystallization. The method is especially suited to preparing combinatorial libraries of small volume crystallization experiments for crystallizing difficult to crystallize biomacromolecules. The small volumes conserve costly and difficult to obtain macromolecules and permit an increased number of experimental crystallization conditions tested for an amount of the biomacromolecule of interest for crystallization. The time required for the experiments is greatly reduced by the scaled down experimental volumes. The invention is conducive to forming high density microarrays of small volume crystallization experiments. Acoustic detection of crystals in situ and distinction between biomacromolecular and non-biomacromolecular crystals is also taught.

### CROSS-REFERENCE TO RELATED APPLICATIONS

This is a continuation-in-part of U.S. patent application Ser. No. 09/727,392, filed Nov. 29, 2000, which is a continuation-in-part of U.S. patent application Ser. No. 09/669,996, filed Sep. 25, 2000, the disclosures of which are incorporated by reference herein.

### TECHNICAL FIELD

This invention relates to the use of focused acoustic energy in the ejection of smaller than nanoliter volumes of fluids for combinatorial chemistry of protein crystallization, specifically for effecting high-throughput screening and production of high resolution crystallographic quality protein crystals for crystallographic structure determination. Focused acoustic energy is used to effect acoustic ejection of fluid droplets of protein solutions, co-crystal components, crystallization promoting and nucleation moieties, and the like in a systematic combinatorial manner that permits control of non-compositional crystallization parameters including temperature while conserving utilization of protein. The small volumes employed permit the conservation of the proteins while reducing the time scale for the kinetic occurrence of crystallization by reducing diffusion times. Such small volume crystallization experiments may conveniently be arrayed on a substrate as virtual wells comprising droplets or the droplets may reside in conventional wells.

### BACKGROUND

In the biomacromolecule arena, research has focused upon discovering new interactions and properties of specific monomer sequences, including ligand and receptor interactions, by screening combinatorial monomer sequence libraries of biopolymers including nucleotidic, peptidic and saccharidic polymers. The material properties of such combinatorial products, as well as both the material and biological properties of other types of biopolymers, including mucopolysaccarides or peptidoglycans, also offer potential utility for both biological and, with respect to the material properties especially, non-biological applications.

For biological molecules, the complexity and variability of biological interactions and the physical interactions that determine, for example, protein conformation or structure other than primary structure, preclude predictability of biological, material, physical and/or chemical properties from theoretical considerations at this time. Specifically, for crystallization of complex asymetric and multi-level structured biomacromolecules such as proteins, despite vast advances in understanding, a theoretical framework permitting sufficiently accurate prediction de novo of crystallization conditions is still lacking.

The immune system is an example of systematic protein and nucleic acid macromolecular combinatorial chemistry that is performed in nature. Both the humoral and cell mediated immune systems produce molecules having novel functions by generation of vast libraries of molecules that are systematically screened for a desired property. For example, the humoral immune system is capable of determining which clones of 10¹²B-lymphocyte clones that make different antibody molecules bind a specific epitope or immunogenic locale, in order to find those clones that specifically bind various epitopes of an immunogen and stimulate their proliferation and maturation into plasma cells that make the antibodies. Because T cells, responsible for cell mediated immunity, include regulatory classes of cells and killer T cells, and the regulatory T cell classes are also involved in controlling both the humoral and cellular response, more clones of T cells exist than of B cells, and must be screened and selected for appropriate immune response. Moreover, the embryological development of both T and B cells is a systematic DNA splicing process for both heavy and light chains that is combinatorial. See, e.g., Therapeutic Immunology, Eds. Austen et al. (Blackwell Science, Cambridge Mass., 1996).

Recently, the combinatorial prowess of the immune system has been harnessed to select for antibodies against small organic molecules as haptens, e.g. attached to a macromolecule; some of these antibodies have been shown to have catalytic activity akin to enzymatic activity with the small organic molecules as substrate, termed “catalytic antibodies” (Hsieh et al. (1993) Science 260(5106):337-9). The proposed mechanism of catalytic antibodies is a distortion of the molecular conformation of the substrate towards the transition state for the reaction and additionally involves electrostatic stabilization. Synthesizing and screening large libraries of molecules has, not unexpectedly, also been employed for drug discovery. Proteins are known to form an induced fit for a bound molecule such as a substrate or ligand (Stryer, Biochemistry, 4^{th} Ed. (1999) W. H. Freeman & Co., New York), with the bound molecule fitting into the site much like a hand fits into a glove, requiring some basic structure for the glove that is then shaped into the bound structure with the help of substrate or ligand. The discovery of new drugs is analogous to finding a hand that fits a glove of unknown or known structure.

Making and testing a large number of different potential ligands and known or potential ligand binding molecules (receptors) and screening for interactions in order to discover new ligand-cognate receptor pairs, is clearly a sound approach in drug discovery and design. Often crystallographic data on the structure of the receptor, perhaps even with bound substrate, or data on the physiological ligand, can help identify basic properties of potentially useful ligands for modulation of the activity of the receptor, thus narrowing the combinatorial scope for certain specific problems. For example, it is widely acknowledged that development of substrate-like and non-substrate like HIV protease inhibitors was spurred by data on the function and substrate for HIV protease and by the high resolution crystallographic structure determination. But the preceding does not preclude the discovery of other HIV protease inhibitors that inhibit at the substrate binding site or elsewhere, through random combinatorial approaches. Further, information does not always exist regarding structure of the physiological ligand and/or substrate, and an efficient combinatorial approach might identify ligands for therapeutic purposes and give some indication of the physiologic ligand and therefore indirect evidence of receptor structure long before, and much more economically than, obtaining a high resolution crystal structure.

In order to increase knowledge of protein structure to complement combinatorial methods of ligand discovery and the like, high throughput protein crystallographic structure determination is highly desirable. This requires efficient, high throughput, systematic combinatorial protein crystallization methodologies to take advantage of advances in obtaining the structure of protein crystals of appropriate quality. The ability to obtain adequate quality crystals for high resolution crystal structure determination has been the rate limiting factor in determining crystal structure from the introduction of protein structure determination by X-ray crystallography. The inability to obtain high resolution quality protein crystals for certain proteins such as membrane proteins and variable or indeterminate structure proteins including those requiring a cocrystal component and possibly another ligand for structure is legendary in the field of protein crystallography. Examples include Zn finger DNA binding proteins ultimately crystallized bound to specific sequence DNA fragments in the presence of Zn²+(Klug et al. (1995) FASEB J (8):597-604) and the intrinsic membrane protein bacteriorhodopsin, crystallized by salt precipitation after solubilization with the surfactant octyl glucoside (Michel et al. (1980) Proc Natl Acad Sci USA 77(3):1283-5)

Methods have been developed for the synthesis and screening of large libraries of peptides, oligonucleotides and other molecules. Geysen et al. (1987) J. Immun. Meth. 102:259-274 have developed a combinatorial peptide synthesis in parallel on rods or pins involving functionalizing the ends of polymeric rods to potentiate covalent attachment of a first amino acid, and sequentially immersing the ends in solutions of individual amino acids. In addition to the Geysen et al. method, techniques have recently been introduced for synthesizing large arrays of different peptides and other polymers on solid surfaces. Arrays may be readily appreciated as additionally being efficient screening tools. Miniaturization of arrays saves synthetic reagents and conserves sample, a useful improvement in both biological and non-biological contexts. See, for example, U.S. Pat. Nos. 5,700,637 and 6,054,270 to Southern et al., which describe a method for chemically synthesizing a high density array of oligonucleotides of chosen monomeric unit length within discrete cells or regions of a support material, wherein the method employs an inkjet printer to deposit individual monomers on the support. So far, however, miniaturized arrays have been costly to make and contain significant amounts of undesired products at sites where a desired product is made. Thus, even in the biological arena, where a given sample might be unique and therefore priceless, use of high density biomacromolecule microarrays has met resistance by the academic community as being too costly, as yet insufficiently reliable compared to arrays made by lab personnel.

Arrays of thousands or even millions of different compositions of the elements may be formed by such methods. Various solid phase microelectronic fabrication derived polymer synthetic techniques have been termed “Very Large Scale Immobilized Polymer Synthesis, ” or “VLSIPS™” technology. Such methods have been successful in screening potential peptide and oligonucleotide ligands for determining relative binding affinity of the ligand for receptors.

The solid phase parallel, spatially directed synthetic techniques currently used to prepare combinatorial biomolecule libraries require stepwise, or sequential, coupling of monomers. U.S. Pat. No. 5,143,854 to Pirrung et al. describes synthesis of polypeptide arrays, and U.S. Pat. No. 5,744,305 to Fodor et al. describes an analogous method of synthesizing oligo- and poly-nucleotides in situ on a substrate by covalently bonding photoremovable groups to the surface of the substrate. Selected substrate surface locales are exposed to light to activate them, by use of a mask. An amino acid or nucleotide monomer with a photoremovable group is then attached to the activated region. The steps of activation and attachment are repeated to make polynucleotides and polypeptides of desired length and sequence. Other synthetic techniques, exemplified by U.S. Pat. Nos. 5,700,637 and 6,054,270 to Southern et al., referenced above, teach the use of inkjet printers, and thus are also substantially parallel because the synthetic pattern must be predefined prior to beginning to “print” the pattern. These solid phase synthesis techniques, which involve the sequential coupling of building blocks (e.g., amino acids) to form the compounds of interest, cannot readily be used to prepare many inorganic and organic compounds.

In combinatorial chemistry of biomacromolecules, U.S. Pat. Nos. 5,700,637 and 6,054,270 to Southern et al., as noted previously, describe a method for generating an array of oligonucleotides of chosen monomeric unit length within discrete cells or regions of a support material. The in situ method generally described for oligo-or polynucleotide synthesis involves: coupling a nucleotide precursor to a discrete predetermined set of cell locations or regions; coupling a nucleotide precursor to a second set of cell locations or regions; coupling a nucleotide precursor to a third set of cell locations or regions; and continuing the sequence of coupling steps until the desired array has been generated. Covalent linking is effected at each location either to the surface of the support or to a nucleotide coupled in a previous step.

The Southern patents also teach that impermeable substrates are preferable to permeable substrates such as paper for effecting high combinatorial site densities, because the fluid volumes delivered in the collective methods taught or suggested, including use of a “mask,” are sufficient to migrate or wick through a permeable substrate and preclude attainment of small feature sizes required for high densities such as those that are attainable by parallel photolithographic synthesis, which requires a substrate that is optically smooth and generally also impermeable. As the inkjet printing method is a parallel synthesis technique that requires the array to be “predetermined” in nature—and therefore inflexible—and has not attained feature sites in the micron range or smaller, there remains a need in the art of non-photolithographic in situ combinatorial array preparation that can enable the high densities attainable by photolithographic arrays, a feat that requires small volumes of reagents and accuracy, without the inflexibility of a highly parallel process that requires a predetermined site sequence association. Also, as permeable substrates offer more a greater surface area for localization of the array constituents, a method of effecting combinatorial high density arrays non-photolitographically by delivery of sufficiently small volumes to permit use of permeable substrates is also an advance over the current state of the art of array making.

As explained above, the parallel photolithographic in situ formation of biomolecular arrays of high density, e.g., oligonucleotide or polynucleotide arrays, is also known in the art. For example, U.S. Pat. Nos. 5,744,305 and 5,445,934 to Fodor and Pirrung et al. describe arrays of oligonucleotides and polynucleotides. Such arrays are described as consisting of a plurality of different oligonucleotides attached to a surface of a planar non-porous solid support at a density exceeding 400 and 1000 different oligonucleotides/cm² respectively. Pirrung and Fodor et al., have developed a technique for generating arrays of peptides and other molecules using these light-directed, spatially-addressable synthesis techniques (U.S. Pat. Nos. 5,143,854, 5,405,783 and PCT Publication No. WO 90/15070). With respect to these photolithographic parallel in situ synthesized microarrays, Fodor et al. have developed photolabile nucleoside and peptide protecting groups, and masking and automation techniques (Fodor et al., U.S. Pat. No. 5,489,678 and PCT Publication No. WO 92/10092).

These patents disclose that photolithographic techniques commonly employed in semiconductor fabrication may be employed in order to form arrays of high density. Photolithographic in situ synthesis is best for parallel synthesis, requiring an inordinate number of masking steps to effect a sequential in situ combinatorial array synthesis. Even the parallel combinatorial array synthesis employing a minimized number of masking steps employs a significant number of such steps, which increases for each monomeric unit added in the synthesis. Further, the parallel photolithographic in situ array synthesis is inflexible and requires a predetermined mask sequence and therefore array pattern.

As photolithographic fabrication requires a large number of masking steps, the yield for this process is lowered relative to a non-photolithographic in situ synthesis by the failure to block or inappropriate photo-deblocking by some of the photolabile protective groups (as in light leakage), and failure to photo-deblock of other photolabile protective groups so employed. These problems with photolabile protective groups compound the practical yield problem for a multi step in situ syntheses in general by adding photo-chemical steps to the synthetic process. Each photo-chemical step can not have a comparable yield in practice throughout the site to the yield from non-photolabile blockers. This is regardless of the advances made in the art of making and using such photolabile blockers for in situ synthesis, in part because of the solid phase photo-deblocking employed that leads to photolabile blocking groups that are shielded from the light or “buried” by the polymer on which they reside or other polymers because of different individual polymer chain conformations at a site, an effect exacerbated with increasing length. Therefore the purity of the desired product at the site is low with significant impurities of undesired products that can reduce both sensitivity and selectivity of each site.

As the photolithographic process for in situ synthesis defines site edges with mask lines, mask imperfections and misalignment, diffractive effects and perturbations of the optical smoothness of the substrate can combine to reduce purity generate similar polymers to the desired sequence as impurities, a problem that becomes more pronounced at the site edges. This is exacerbated when photolithographic protocols attempt to reach maximum site density by creating arrays that have abutting sites. Because the likelihood of a mask imperfection or misalignment increases with the number of masking steps and the associated number of masks, these edge effects are worsened by increased masking steps and utilization of more mask patterns in a set of masks used to fabricate a particular array.

The site impurity by similar polymers to the desired polymer leads to reduced sensitivity and selectivity for arrays designed to analyze nucleotide sequence. Such arrays employ oligonucleotides of desired sequence with properties, including hybridization properties, that are understood well enough that stringency for the measured event, such as specific hybridization, can be controlled.

In combinatorial arrays in general, the desire to demonstrate as many different useful properties of novel compositions of matter, and undiscovered useful properties of known compositions, limits employment of stringency conditions for measured events. Such events may remain undiscovered, or if known, may not be amenable to stringency control without narrowing the scope of the experiment. For example, imposing a stringency condition for an event such as nucleic acid hybridization may preclude or interfere with discovery of receptors for which certain nucleotide sequences are ligands in the combinatorial oligonucleotide array context. Furthermore, the analytic microarray does not consider the impurity as a potential agent of interest, or an agent which in close proximity with the desired synthetic product can significantly affect some useful property, which will not be ascribed to the correct combinatorial product.

Non-photolithographic arrays are also affected by the impurity problem, but the use of photolabile protective groups exacerbates the impurity problem, especially at the edges. For example, arrays made by synthesis of benzodiazepines having different moieties coupled to a given carbon atom that is blocked by a photolabile protecting group, or the combinatorial synthesis of polysaccharides having different monomer sequences would contain more undesired benzodiazepine or polysaccharide side products respectively in addition to the desired products, especially at the edges, than syntheses not employing photolabile blocking compounds.

If an array of different alloys were made by photolithography, then conventional photoresist might be employed in conjunction with evaporative and sputtering techniques or chemical vapor deposition, preferably under conditions promoting epitaxial growth. But these steps are relatively slow, even when compared to typical chemosynthetic steps in, for example, the in situ synthesis of oligonucleotides. Also, the mask pattern must be designed to prevent the sites from abutting each other to prevent inter-site diffusion.

For a combinatorial array wherein the specific structure or makeup of each side product, and the relative representation thereof, at a given site is not discernable, a property of a side product or a side product in concert with the desired product is indistinguishable from a property ascribed to the desired product. Simply stated, for combinatorial arrays employed in the broadest possible manner, the impurity by related products to the desired product at each site is more problematic as the properties and events being screened for are less understood and combined effects or effects ascribable as artifacts of the impurities are difficult to identify. For example, it may require a tremendous effort to determine how to perform the photolabile chemistry for a wide range of materials desirable as elements in the combinatorial library with sufficient purity to have value, and the effort into tangential photochemistry may exceed the value of the results. Photolithographic in situ synthesized arrays are also prohibitively expensive for making small quantities of custom arrays, because complicated masks need be generated for relatively few use cycles. Because of the foregoing considerations photolithographic techniques are generally unsuitable for producing high density nucleotidic arrays wherein the nucleotidic features exceed about 70 units in length.

Some efforts have been directed to adapting printing technologies, particularly, inkjet printing technologies, to form biomolecular arrays. For example, U.S. Pat. No. 6,015,880 to Baldeschwieler et al. is directed to array preparation by a multistep in situ synthesis. A liquid microdrop containing a first reagent is applied by a single jet of a multiple jet reagent dispenser to a locus on the surface chemically prepared to permit covalent attachment of the reagent. The reagent dispenser is then displaced relative to the surface, or the surface is displaced with respect to the dispenser, and at least one microdrop containing either the first reagent or a second reagent from another dispenser jet is applied to a second substrate locale, which is also chemically activated to be reactive for covalent attachment of the second reagent. Optionally, the second step is repeated using either the first or second reagents, or different liquid borne reagents from different dispenser jets, wherein each reagent covalently attaches to the substrate. Additional steps involve addition of reagents to react with reagents attached to the to form covalently attached compounds. The patent discloses that inkjet technology may be used to apply the microdrops.

Inkjet technology generally suffers from a number of drawbacks not found with acoustic ejection methods. Inkjet deposition typically employs heat or piezoelectric means to force a fluid through a nozzle in order to direct the ejected fluid onto a surface. Fluid may be exposed to a surface temperature exceeding 200° C. prior to ejection from a printhead or inkjet nozzle. Biomolecules degrade under such extreme temperatures; changes in conformation are also a problem for proteins at such temperatures, creating denatured proteins with exposed hydrophobic cores that tend to aggregate non-specifically. Moreover, nozzles are subject to clogging, particularly when used to eject an elevated temperature molten fluid, a fluid having a solid solvated or suspended therein, or a fluid containing a heat denatured aggregating protein. The use of elevated temperatures creates a temperature gradient that decreases as the fluid approaches the nozzle tip, promotes solvent evaporation and denatures proteins, resulting in increased deposition of precipitated solids and/or non-specifically aggregated proteins in the nozzle, and especially at the nozzle tip. Clogged nozzles result in misdirected fluid ejection or improperly sized droplets. Even absent clogging, nozzles must be cleaned before being used to deliver different reagent. Nozzle-based printing technology has consequently limited utility in depositing biomolecular reagents to form microarrays. Also, nozzle-based fluid ejection is generally incapable of depositing arrays with feature density comparable to that attainable by photolithography or other techniques employed in semiconductor manufacture.

A number of patents have described the use of acoustic energy in printing. U.S. Pat. No. 4,308,547 to Lovelady et al. describes a liquid drop emitter that utilizes acoustic principles in ejecting droplets from a body of liquid onto a moving document to form characters or bar codes thereon. Lovelady et al. is directed to a nozzleless inkjet printing apparatus wherein spatially directed, drops of ink are propelled by a force produced by a curved acoustic transducer at or below the surface of the ink. In contrast to inkjet printing devices, nozzleless fluid ejection devices are not subject to the potential disadvantages of clogging, including misdirected fluid and improper droplet size.

The applicability of nozzleless fluid ejection has generally been appreciated for ink printing applications. Development of ink printing applications is primarily economically driven by printing cost and speed for acceptable text. For acoustic printing development efforts thus have focused on reducing printing costs rather than improving quality, and on increasing printing speed rather than accuracy. For example, U.S. Pat. No. 5,087,931 to Rawson is directed to a system for transporting ink under constant flow to an acoustic ink printer having a plurality of ejectors aligned in an axis, each ejector associated with a free surface of liquid ink. when a plurality of ejectors is used instead of a single ejector, printing speed generally increases, but controlling fluid ejection, specifically droplet placement, becomes more difficult.

U.S. Pat. No. 4,797,693 to Quate describes an acoustic ink printer for printing polychromatic images on a recording medium. The printer is described as comprising a combination of a carrier containing a plurality of differently colored liquid inks, a single acoustic printhead acoustically coupled to the carrier for launching converging acoustic waves into the carrier, an ink transport means to position the carrier to sequentially align the differently colored inks with the printhead, and a controller to modulate the radiation pressure employed to eject the inks. This printer is stated to be designed for realization of cost savings. Because two droplets of primary color, e.g., cyan and yellow, deposited in sufficient proximity will appear as a composite or secondary color, the accuracy required and therefore effected by the acoustic printer is inadequate for biomolecular array formation. Such a printer is especially inadequate for in situ synthesis requiring droplet deposition at precisely the same surface locale so that the proper reactions occur. That is, the drop placement accuracy needed to effect perception of a composite secondary color is much lower than is required for chemical synthesis at photolithographic density levels. Consequently an acoustic printing device that is adequate for printing visually apprehensible material is inadequate for microarray preparation. Also, this device can eject only a limited quantity of ink from the carrier before the liquid meniscus moves out of acoustic focus and drop ejection ceases. This is a significant limitation with biological fluids, which can be more costly and rare than ink. The Quate et al. patent does not address how to use most of the fluid in a closed reservoir without adding additional liquid from an external source.

Thus, there is a general need in the art of combinatorial array preparation for improved spatially directable fluid ejection methods having sufficient droplet ejection accuracy to permit attainment of high density arrays of combinatorial materials made from a diverse group of starting materials. Specifically, acoustic fluid ejection devices as described herein can effect improved spatial direction of fluid ejection without the disadvantages of lack of flexibility and uniformity associated with photolithographic techniques or inkjet printing devices effecting droplet ejection through a nozzle.

One of the advantages of nozzleless acoustic ejection is the ability to reduce shear, while obtaining better control over droplet volume and a smaller minimum volume. These advantages also apply to the comparison of acoustic ejection to manipulate small volumes of fluids compared to conventional microfluidic channel manipulation of fluids. The reduction of shear is an important advantage for manipulating macromolecule solutes in a fluid, and especially conformationally complex and labile biomacromolecules such as proteins and nucleic acids having higher order structure than primary structure.

Understanding the three-dimensional structure of proteins is critical to understanding mechanisms of protein to binding to other proteins and other ligands including small molecules, poly- and oligo- nucleotides and other moieties of interest. A tremendous interest in the acceleration of high resolution protein structure determination via X-ray crystallography consequently exists. Advances in computational ability and higher quality X-ray sources from synchrotron radiation have drastically reduced the amount of time required to obtain a crystal structure. Synchrotron radiation also permits smaller crystals to be used for crystallographic experiments than required by other methods. A significant impediment to drug discovery through understanding protein structure is the lack of methods for rapid screening of crystallization methods and ultimately for rapid production of high resolution crystallographic quality protein crystals. Another technique, two-dimensional electron crystallography uses electron diffraction to structure lipid bilayer embedded or anchored proteins that form two dimensional crystals or ordered arrays.

The conditions under which 2-D and 3-D protein crystals form are largely unpredictable. Consequently, combinatorial methodologies that screen many combinations of crystallization condition parameters in parallel are utilized to determine optimal buffer composition and other crystallization condition parameters to form protein crystals of appropriate quality. Condition parameters for crystallization experiments include pH, ionic strength, molecular weight and concentration of polyethylene glycol, percent of organic component such as dimethyl sulfoxide, protein concentration, concentration of macromolecule and small moiety co-crystal components and temperature. Given this set of condition parameters, it is impracticable to rapidly screen each possible combination of parameters by conventionally employed methods. Moreover, even using recombinant technology for protein expression, supplies of pure proteins for crystallization are invariably limited relative to amounts required by conventional crystallization screening methods for all conceivable combinations of crystallization parameters, thus limiting the number of combinations tested and reducing the chance of successful crystallization. A significant need therefore exists for methods of combinatorial experimentation in the crystallization of proteins which increase the rapidity of screening and reduce the amount of protein required for each experiment.

A further problem in high-throughout crystallization is detecting nascent protein crystals. The observation of crystals in a solution does not guarantee the presence of high resolution crystallographic or diffraction quality crystals. Salts in the buffer solution may crystallize instead of the desired protein. Current visual inspection methods are usually not able to distinguish between buffer crystals and protein crystals because sizes and morphologies of these crystals overlap. Distinguishing buffer crystals from protein crystals often requires mounting crystals in the diffractometer, an inefficient method of screening that requires removal of crystals from the wells, and manual mounting. Such handling of crystals increases the probability of cracking, melting or otherwise damaging the crystals prior to data acquisition.

Thus a need exists for smaller volume crystallization experiments to conserve moieties of interest for crystallization, especially biomacromolecules, and permit more experiments for a given amount of sample. A further need exists for speeding successful crystallization of quality crystals so that advances in obtaining structures faster from quality crystals are not rendered inconsequential by the “rate determining step” of crystallization. Further, need exists for determining whether crystals of the desired moiety have crystallized, specifically whether microcrystals or precipitates have formed, and in the context of biomacromolecule crystallization whether biomacromolecule or non-biomacromolecule crystals have formed. Finally need exists for the in situ determination of whether crystals are of crystallographic quality.

### SUMMARY OF THE INVENTION

Accordingly, it is an object of the present invention to provide methods and combinatorial libraries that overcome the above-mentioned disadvantages of the prior art.

In one aspect of the invention, a method is provided for preparing a combinatorial library of a plurality of different moieties on a substrate surface using a device substantially as described in U.S. patent application Ser. No. 09/669,996 (“Acoustic Ejection of Fluids from a Plurality of Reservoirs”), inventors Ellson, Foote and Mutz, filed on Sep. 25, 2000, and assigned to Picoliter, Inc. (Cupertino, Calif.). As described in the aforementioned patent application, the device enables acoustic ejection of a plurality of fluid droplets toward designated sites on a substrate surface for deposition thereon, and: a plurality of reservoirs each adapted to contain a fluid; an acoustic ejector for generating acoustic radiation and a focusing means for focusing it at a focal point near the fluid surface in each of the reservoirs; and a means for positioning the ejector in acoustic coupling relationship to each of the reservoirs. Preferably, each of the reservoirs is removable, comprised of an individual well in a well plate, and/or arranged in an array. The reservoirs are preferably also substantially acoustically indistinguishable from one another, have appropriate acoustic impedance to allow the energetically efficient focusing of acoustic energy near the surface of a contained fluid, and are capable of withstanding conditions of the fluid-containing reagent. In some embodiments, e.g., in the preparation of metallic arrays, arrays composed of alloys, or certain other non-biological materials, the device is structured and composed of materials suitable for use of elevated temperatures and reduced pressures to liquify solids at standard temperature and pressure (STP) and/or reduced temperatures and increased pressures for liquefying gases at STP. In such embodiments, the reservoirs, reservoir carriers and components of the device in contact with or proximity to the reservoirs are also preferably made of materials that can withstand typical melting temperatures of metals to permit delivery of acoustically ejected molten metal onto the substrate.

The method generally involves positioning the acoustic ejector so as to be in acoustically coupled relationship with a first fluid-containing reservoir containing a first fluid, and then activating the ejector to generate and direct acoustic radiation so as to have a focal point within the first fluid and near the surface thereof, thereby ejecting a fluid droplet toward a first designated site on the substrate surface. Then, the ejector is repositioned so as to be in acoustically coupled relationship with a second fluid-containing reservoir and activated again as above to eject a droplet of the second fluid toward a second designated site on the substrate surface, wherein the first and second designated sites may or may not be the same. If desired, the method may be repeated with a plurality of fluid reservoirs each containing a fluid, with each reservoir generally although not necessarily containing a different fluid. Also, the fluids in each reservoir may or may not have different acoustic properties. The acoustic ejector is thus repeatedly repositioned so as to eject a droplet from each reservoir toward a different designated site on a substrate surface. In such a way, the method is readily adapted for use in generating an array of molecular moieties on a substrate surface, in the form of combinatorial library.

In another aspect of the invention, method is provided for screening and characterizing the combinatorial libraries prepared as above.

Yet another aspect of the invention provides high density arrays of the enumerated materials that are substantially uniform in terms of composition and/or molecular structure in directions substantially parallel to the plane of the substrate surface within the area of combinatorial deposition or synthesis. That is, the arrays provided by the instant invention do not possess the edge effects that result from optical and alignment effects of photolithographic masking, nor are they subject to imperfect spotting alignment from ink-jet nozzle directed deposition of reagents at the desired densities.

### BRIEF DESCRIPTION OF THE DRAWINGS

FIGS. 1A and 1B, collectively referred to as FIG. 1, schematically illustrate in simplified cross-sectional view an embodiment of a device useful in conjunction with the method of the invention, the device comprising first and second reservoirs, an acoustic ejector, and an ejector positioning means. FIG. 1A shows the acoustic ejector acoustically coupled to the first reservoir and having been activated in order to eject a droplet of fluid from within the first reservoir toward a designated site on a substrate surface. FIG. 1B shows the acoustic ejector acoustically coupled to a second reservoir.

FIGS. 2A, 2B and 2C, collectively referred to as FIG. 2, illustrate in schematic view a variation of the device shown in FIG. 1 wherein the reservoirs comprise individual wells in a reservoir well plate and the substrate comprises a smaller well plate with a corresponding number of wells. FIG. 2A is a schematic top plan view of the two well plates, i.e., the reservoir well plate and the substrate well plate. FIG. 2B illustrates in cross-sectional view a device comprising the reservoir well plate of FIG. 2A acoustically coupled to an acoustic ejector, wherein a droplet is ejected from a first well of the reservoir well plate into a first well of the substrate well plate. FIG. 2C illustrates in cross-sectional view the device illustrated in FIG. 2B, wherein the acoustic ejector is acoustically coupled to a second well of the reservoir well plate and further wherein the device is aligned to enable the acoustic ejector to eject a droplet from the second well of the reservoir well plate to a second well of the substrate well plate.

FIGS. 3A, 3B, 3C and 3D, collectively referred to as FIG. 3, schematically illustrate in simplified cross-sectional view an embodiment of the inventive method in which a dimer is synthesized in situ on a substrate using the device of FIG. 1. FIG. 3A illustrates the ejection of a droplet of surface modification fluid onto a designated site of a substrate surface. FIG. 3B illustrates the ejection of a droplet of a first fluid containing a first molecular moiety adapted for attachment to the modified surface of the substrate. FIG. 3C illustrates the ejection of a droplet of second fluid containing a second molecular moiety adapted for attachment to the first molecule. FIG. 3D illustrates the substrate and the dimer synthesized in situ by the process illustrated in FIGS. 3A, 3B and 3C.

FIGS. 4A, 4B and 4C, collectively referred to as FIG. 4, depict different conventionally sized reservoir and drop protein crystallization setups. FIG. 4A depicts a standing drop container without the cover slip in place. FIG. 4B depicts a fully assembled standing drop container with a filled fluid reservoir and a standing drop that is covered by a cover slip and sealed. FIG. 4C depicts a fully assembled hanging drop protein crystallization container with a single experimental protein crystallization drop hanging above the fluid reservoir.

### DETAILED DESCRIPTION OF THE INVENTION

Definitions and Overview

Before describing the present invention in detail, it is to be understood that this invention is not limited to specific fluids, biomolecules or device structures, as such may vary. It is also to be understood that the terminology used herein is for the purpose of describing particular embodiments only, and is not intended to be limiting.

It must be noted that, as used in this specification and the appended claims, the singular forms “a,” “an” and “the” include plural referents unless the context clearly dictates otherwise. Thus, for example, reference to “a reservoir” includes a plurality of reservoirs, reference to a fluid” includes a plurality of fluids, reference to “a biomolecule”includes a combination of biomolecules, “a moiety” can refer to a plurality of moieties, and the like.

In describing and claiming the present invention, the following terminology will be used in accordance with the definitions set out below.

The terms “acoustic coupling” and “acoustically coupled” used herein refer to a state wherein an object is placed in direct or indirect contact with another object so as to allow acoustic radiation to be transferred between the objects without substantial loss of acoustic energy. When two items are indirectly acoustically coupled, an “acoustic coupling medium” is needed to provide an intermediary through which acoustic radiation may be transmitted. Thus, an ejector may be acoustically coupled to a fluid, e.g., by immersing the ejector in the fluid or by interposing an acoustic coupling medium between the ejector and the fluid to transfer acoustic radiation generated by the ejector through the acoustic coupling medium and into the fluid.

The term “adsorb” as used herein refers to the noncovalent retention of a molecule by a substrate surface. That is, adsorption occurs as a result of noncovalent interaction between a substrate surface and adsorbing moieties present on the molecule that is adsorbed. Adsorption may occur through hydrogen bonding, van der Waal's forces, polar attraction or electrostatic forces (i.e., through ionic bonding). Examples of adsorbing moieties include, but are not limited to, amine groups, carboxylic acid moieties, hydroxyl groups, nitroso groups, sulfones and the like. Often the substrate may be functionalized with adsorbent moieties to interact in a certain manner, as when the surface is functionalized with amino groups to render it positively charged in a pH neutral aqueous environment. Likewise, adsorbate moieties may be added in some cases to effect adsorption, as when a basic protein is fused with an acidic peptide sequence to render adsorbate moieties that can interact electrostatically with a positively charged adsorbent moiety.

The term “attached,” as in, for example, a substrate surface having a moiety “attached” thereto, includes covalent binding, adsorption, and physical immobilization. The terms “binding” and “bound” are identical in meaning to the term “attached.”The term “array” used herein refers to a two-dimensional arrangement of features such as an arrangement of reservoirs (e.g., wells in a well plate) or an arrangement of different materials including ionic, metallic or covalent crystalline, including molecular crystalline, composite or ceramic, glassine, amorphous, fluidic or molecular materials on a substrate surface (as in an oligonucleotide or peptidic array). Different materials in the context of molecular materials includes chemical isomers, including constitutional, geometric and stereoisomers, and in the context of polymeric molecules constitutional isomers having different monomer sequences. Arrays are generally comprised of regular, ordered features, as in, for example, a rectilinear grid, parallel stripes, spirals, and the like, but non-ordered arrays may be advantageously used as well. An array is distinguished from the more general term pattern in that patterns do not necessarily contain regular and ordered features. The arrays or patterns formed using the devices and methods of the invention have no optical significance to the unaided human eye. For example, the invention does not involve ink printing on paper or other substrates in order to form letters, numbers, bar codes, figures, or other inscriptions that have optical significance to the unaided human eye. In addition, arrays and patterns formed by the deposition of ejected droplets on a surface as provided herein are preferably substantially invisible to the unaided human eye. Arrays typically but do not necessarily comprise at least about 4 to about 10,000,000 features, generally in the range of about 4 to about 1,000,000 features.

The terms “biomolecule” and “biological molecule” are used interchangeably herein to refer to any organic molecule, whether naturally occurring, recombinantly produced, or chemically synthesized in whole or in part, that is, was or can be a part of a living organism, or synthetic analogs of molecules occurring in living organisms including nucleic acid analogs having peptide backbones and purine and pyrimidine sequence, carbamate backbones having side chain sequence resembling peptide sequences, and analogs of biological molecules such as epinephrine, GABA, endorphins, interleukins and steroids. The term encompasses, for example, nucleotides, amino acids and monosaccharides, as well as oligomeric and polymeric species such as oligonucleotides and polynucleotides, peptidic molecules such as oligopeptides, polypeptides and proteins, saccharides such as disaccharides, oligosaccharides, polysaccharides, mucopolysaccharides or peptidoglycans (peptido-polysaccharides) and the like. The term also encompasses synthetic GABA analogs such as benzodiazepines, synthetic epinephrine analogs such as isoproterenol and albuterol, synthetic glucocorticoids such as prednisone and betamethasone, and synthetic combinations of naturally occurring biomolecules with synthetic biomolecules, such as theophylline covalently linked to betamethasone.

The term “biomaterial” refers to any material that is biocompatible, i.e., compatible with a biological system comprised of biological molecules as defined above.

The terms “library” and “combinatorial library” are used interchangeably herein to mean a plurality of chemical or biological moieties present on the surface of a substrate, wherein each moiety is different from each other moiety. The moieties may be, e.g., peptidic molecules and/or oligonucleotides.

The term “moiety” refers to any particular composition of matter, e.g., a molecular fragment, an intact molecule (including a monomeric molecule, an oligomeric molecule, and a polymer), or a mixture of materials (for example, an alloy or a laminate).

It will be appreciated that, as used herein, the terms “nucleoside” and “nucleotide” refer to nucleosides and nucleotides containing not only the conventional purine and pyrimidine bases, i.e., adenine (A), thymine (T), cytosine (C), guanine (G) and uracil (U), but also protected forms thereof, e.g., wherein the base is protected with a protecting group such as acetyl, difluoroacetyl, trifluoroacetyl, isobutyryl or benzoyl, and purine and pyrimidine analogs. Suitable analogs will be known to those skilled in the art and are described in the pertinent texts and literature. Common analogs include, but are not limited to, 1-methyladenine, 2-methyladenine, N⁶-methyladenine, N⁶-isopentyladenine, 2-methylthio-N⁶-isopentyladenine, N,N-dimethyladenine, 8-bromoadenine, 2-thiocytosine, 3-methylcytosine, 5-methylcytosine, 5-ethylcytosine, 4-acetylcytosine, 1-methylguanine, 2-methylguanine, 7-methylguanine, 2,2-dimethylguanine, 8-bromoguanine, 8-chloroguanine, 8-aminoguanine, 8-methylguanine, 8-thioguanine, 5-fluorouracil, 5-bromouracil, 5-chlorouracil, 5-iodouracil, 5-ethyluracil, 5-propyluracil, 5-methoxyuracil, 5-hydroxymethyluracil, 5-(carboxyhydroxymethyl)uracil, 5-(methylaminomethyl)uracil, 5-(carboxymethylaminomethyl)-uracil, 2-thiouracil, 5-methyl-2-thiouracil, 5-(2-bromovinyl)uracil, uracil-5-oxyacetic acid, uracil-5-oxyacetic acid methyl ester, pseudouracil, 1-methylpseudouracil, queosine, inosine, 1-methylinosine, hypoxanthine, xanthine, 2-aminopurine, 6-hydroxyaminopurine, 6-thiopurine and 2,6-diaminopurine. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “oligonucleotide” shall be generic to polydeoxy-nucleotides (containing 2-deoxy-D-ribose), to polyribonucleotides (containing D-ribose), to any other type of polynucleotide that is an N-glycoside of a purine or pyrimidine base, and to other polymers containing nonnucleotidic backbones (for example PNAs), providing that the polymers contain nucleobases in a configuration that allows for base pairing and base stacking, such as is found in DNA and RNA. Thus, these terms include known types of oligonucleotide modifications, for example, substitution of one or more of the naturally occurring nucleotides with an analog, intemucleotide modifications such as, for example, those with uncharged linkages (e.g., methyl phosphonates, phospho-triesters, phosphoramidates, carbamates, etc.), with negatively charged linkages (e.g., phosphorothioates, phosphorodithioates, etc.), and with positively charged linkages (e.g., aminoalklyphosphoramidates, aminoalkylphosphotriesters), those containing pendant moieties, such as, for example, proteins (including nucleases, toxins, antibodies, signal peptides, poly-L-lysine, etc.), those with intercalators (e.g., acridine, psoralen, etc.), those containing chelators (e.g., metals, radioactive metals, boron, oxidative metals, etc.). There is no intended distinction in length between the term “polynucleotide” and “oligonucleotide,” and these terms will be used interchangeably. These terms refer only to the primary structure of the molecule. As used herein the symbols for nucleotides and polynucleotides are according to the IUPAC-IUB Commission of Biochemical Nomenclature recommendations (Biochemistry 9:4022, 1970).

“Peptidic” molecules refer to peptides, peptide fragments, and proteins, i.e., oligomers or polymers wherein the constituent monomers are alpha amino acids linked through amide bonds. The amino acids of the peptidic molecules herein include the twenty conventional amino acids, stereoisomers (e.g., D-amino acids) of the conventional amino acids, unnatural amino acids such as α,α-disubstituted amino acids, N-alkyl amino acids, lactic acid, and other unconventional amino acids. Examples of unconventional amino acids include, but are not limited to, β-alanine, naphthylalanine, 3-pyridylalanine, 4-hydroxyproline, 0-phosphoserine, N-acetylserine, N-formylmethionine, 3-methylhistidine, 5-hydroxylysine, and nor-leucine.

The term “fluid” as used herein refers to matter that is nonsolid or at least partially gaseous and/or liquid. A fluid may contain a solid that is minimally, partially or fully solvated, dispersed or suspended. Examples of fluids include, without limitation, aqueous liquids (including water per se and salt water) and nonaqueous liquids such as organic solvents and the like. As used herein, the term “fluid” is not synonymous with the term “ink” in that an ink must contain a colorant and may not be gaseous and/or liquid.

The term “acoustic focusing means” as used herein refers to a means for causing acoustic waves to converge at a focal point by either a device separate from the acoustic energy source that acts like an optical lens, or by the spatial arrangement of acoustic energy sources to effect convergence of acoustic energy at a focal point by constructive and destructive interference. A focusing means may be as simple as a solid member having a curved surface, or it may include complex structures such as those found in Fresnel lenses, which employ diffraction in order to direct acoustic radiation.

Suitable focusing means also include phased array methods as known in the art and described, for example, in U.S. Pat. No. 5,798,779 to Nakayasu et al. and Amemiya et al. (1997) Proceedings of the 1997 IS&TNIP13 International Conference on Digital Printing Technologies Proceedings, at pp. 698-702.

The term “reservoir” as used herein refers a receptacle or chamber for holding or containing a fluid. Thus, a fluid in a reservoir necessarily has a free surface, i.e., a surface that allows a droplet to be ejected therefrom.

The term “substrate” as used herein refers to any material having a surface onto which one or more fluids may be deposited. The substrate may be constructed in any of a number of forms such as wafers, slides, well plates, membranes, for example. In addition, the substrate may be porous or nonporous as may be required for any particular fluid deposition. Suitable substrate materials include, but are not limited to, supports that are typically used for solid phase chemical synthesis, e.g., polymeric materials (e.g., polystyrene, polyvinyl acetate, polyvinyl chloride, polyvinyl pyrrolidone, polyacrylonitrile, polyacrylamide, polymethyl methacrylate, polytetrafluoroethylene, polyethylene, polypropylene, polyvinylidene fluoride, polycarbonate, divinylbenzene styrene-based polymers), agarose (e.g., Sepharose®, dextran (e.g., Sephadex®, cellulosic polymers and other polysaccharides, silica and silica-based materials, glass (particularly controlled pore glass, or “CPG”) and functionalized glasses, ceramics, and such substrates treated with surface coatings, e.g., with microporous polymers (particularly cellulosic polymers such as nitrocellulose and spun synthetic polymers such as spun polyethylene), metallic compounds (particularly microporous aluminum), or the like. While the foregoing support materials are representative of conventionally used substrates, it is to be understood that the substrate may in fact comprise any biological, nonbiological, organic and/or inorganic material, and may be in any of a variety of physical forms, e.g., particles, strands, precipitates, gels, sheets, tubing, spheres, containers, capillaries, pads, slices, films, plates, slides, and the like, and may further have any desired shape, such as a disc, square, sphere, circle, etc. The substrate surface may or may not be flat, e.g., the surface may contain raised or depressed regions. A substrate may additionally contain or be derivatized to contain reactive functionality that covalently links a compound to the surface thereof. These are widely known and include, for example, silicon dioxide supports containing reactive Si—OH groups, polyacrylamide supports, polystyrene supports, polyethyleneglycol supports, and the like.

The term “surface modification” as used herein refers to the chemical and/or physical alteration of a surface by an additive or subtractive process to change one or more chemical and/or physical properties of a substrate surface or a selected site or region of a substrate surface. For example, surface modification may involve (1) changing the wetting properties of a surface, (2) functionalizing a surface, i.e., providing, modifying or substituting surface functional groups, (3) defunctionalizing a surface, i.e., removing surface functional groups, (4) otherwise altering the chemical composition of a surface, e.g., through etching, (5) increasing or decreasing surface roughness, (6) providing a coating on a surface, e.g., a coating that exhibits wetting properties that are different from the wetting properties of the surface, and/or (7) depositing particulates on a surface.

In one embodiment, then, the invention pertains to a device for acoustically ejecting a plurality of droplets toward designated sites on a substrate surface. The device comprises a plurality of reservoirs, each adapted to contain a fluid; an ejector comprising an acoustic radiation generator for generating acoustic radiation and a focusing means for focusing acoustic radiation at a focal point within and near the fluid surface in each of the reservoirs; and a means for means positioning the ejector in acoustic coupling relationship to each of the reservoirs. Preferably, none of the fluids is an ink.

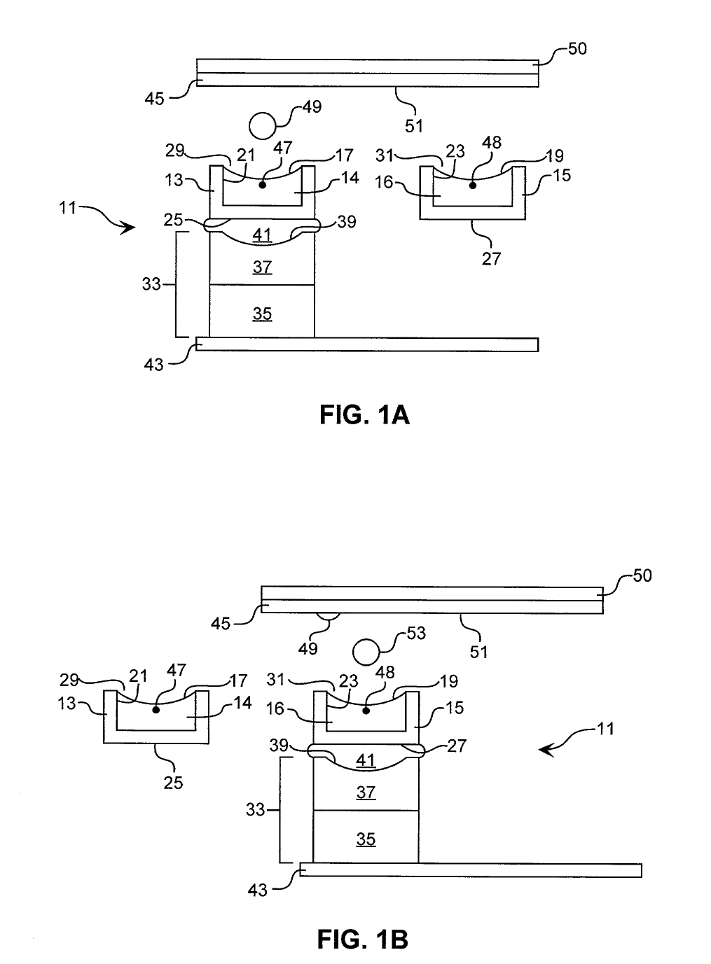

FIG. 1 illustrates an embodiment of the employed device in simplified cross-sectional view. As with all figures referenced herein, in which like parts are referenced by like numerals, FIG. 1 is not to scale, and certain dimensions may be exaggerated for clarity of presentation. The device 11 includes a plurality of reservoirs, i.e., at least two reservoirs, with a first reservoir indicated at 13 and a second reservoir indicated at 15, each adapted to contain a fluid having a fluid surface, e.g., a first fluid 14 and a second fluid 16 having fluid surfaces respectively indicated at 17 and 19. Fluids 14 and 16 may be the same or different, and may also have acoustic or fluidic properties that are the same or different. As shown, the reservoirs are of substantially identical construction so as to be substantially acoustically indistinguishable, but identical construction is not a requirement. The reservoirs are shown as separate removable components but may, if desired, be fixed within a plate or other substrate. For example, the plurality of reservoirs may comprise individual wells in a well plate, optimally although not necessarily arranged in an array. Each of the reservoirs 13 and 15 is preferably axially symmetric as shown, having vertical walls 21 and 23 extending upward from circular reservoir bases 25 and 27 and terminating at openings 29 and 31, respectively, although other reservoir shapes may be used. The material and thickness of each reservoir base should be such that acoustic radiation may be transmitted therethrough and into the fluid contained within the reservoirs.

The device also includes an acoustic ejector 33 comprised of an acoustic radiation generator 35 for generating acoustic radiation and a focusing means 37 for focusing the acoustic radiation at a focal point within the fluid from which a droplet is to be ejected, near the fluid surface. As shown in FIG. 1, the focusing means 37 may comprise a single solid piece having a concave surface 39 for focusing acoustic radiation, but the focusing means may be constructed in other ways as discussed below. The acoustic ejector 33 is thus adapted to generate and focus acoustic radiation so as to eject a droplet of fluid from each of the fluid surfaces 17 and 19 when acoustically coupled to reservoirs 13 and 15 and thus to fluids 14 and 16, respectively. The acoustic radiation generator 35 and the focusing means 37 may function as a single unit controlled by a single controller, or they may be independently controlled, depending on the desired performance of the device. Typically, single ejector designs are preferred over multiple ejector designs because accuracy of droplet placement and consistency in droplet size and velocity are more easily achieved with a single ejector.

As will be appreciated by those skilled in the art, any of a variety of focusing means may be employed in conjunction with the present invention. For example, one or more curved surfaces may be used to direct acoustic radiation to a focal point near a fluid surface. One such technique is described in U.S. Pat. No. 4,308,547 to Lovelady et al. Focusing means with a curved surface have been incorporated into the construction of commercially available acoustic transducers such as those manufactured by Panametrics Inc. (Waltham, Mass.). In addition, Fresnel lenses are known in the art for directing acoustic energy at a predetermined focal distance from an object plane. See, e.g., U.S. Pat. No. 5,041,849 to Quate et al. Fresnel lenses may have a radial phase profile that diffracts a substantial portion of acoustic energy into a predetermined diffraction order at diffraction angles that vary radially with respect to the lens. The diffraction angles should be selected to focus the acoustic energy within the diffraction order on a desired object plane.

There are also a number of ways to acoustically couple the ejector 33 to each individual reservoir and thus to the fluid therein. One such approach is through direct contact as is described, for example, in U.S. Pat. No. 4,308,547 to Lovelady et al., wherein a focusing means constructed from a hemispherical crystal having segmented electrodes is submerged in a liquid to be ejected. The aforementioned patent further discloses that the focusing means may be positioned at or below the surface of the liquid. However, this approach for acoustically coupling the focusing means to a fluid is undesirable when the ejector is used to eject different fluids in a plurality of containers or reservoirs, as repeated cleaning of the focusing means would be required in order to avoid cross-contamination. The cleaning process would necessarily lengthen the transition time between each droplet ejection event. In addition, in such a method, fluid would adhere to the ejector as it is removed from each container, wasting material that may be costly or rare.

Thus, a preferred approach would be to acoustically couple the ejector to the reservoirs and reservoir fluids without contacting any portion of the ejector, e.g., the focusing means, with any of the fluids to be ejected. To this end, the present invention provides an ejector positioning means for positioning the ejector in controlled and repeatable acoustic coupling with each of the fluids in the reservoirs to eject droplets therefrom without submerging the ejector therein. This typically involves direct or indirect contact between the ejector and the external surface of each reservoir. When direct contact is used in order to acoustically couple the ejector to each reservoir, it is preferred that the direct contact is wholly conformal to ensure efficient acoustic energy transfer. That is, the ejector and the reservoir should have corresponding surfaces adapted for mating contact. Thus, if acoustic coupling is achieved between the ejector and reservoir through the focusing means, it is desirable for the reservoir to have an outside surface that corresponds to the surface profile of the focusing means. Without conformal contact, efficiency and accuracy of acoustic energy transfer may be compromised. In addition, since many focusing means have a curved surface, the direct contact approach may necessitate the use of reservoirs having a specially formed inverse surface.

Optimally, acoustic coupling is achieved between the ejector and each of the reservoirs through indirect contact, as illustrated in FIG. 1A. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing means 37 and each reservoir. In addition, it is important to ensure that the fluid medium is substantially free of material having different acoustic properties than the fluid medium itself. As shown, the first reservoir 13 is acoustically coupled to the acoustic focusing means 37 such that an acoustic wave is generated by the acoustic radiation generator and directed by the focusing means 37 into the acoustic coupling medium 41, which then transmits the acoustic radiation into the reservoir 13.

In operation, reservoirs 13 and 15 of the device are each filled with first and second fluids 14 and 16, respectively, as shown in FIG. 1. The acoustic ejector 33 is positionable by means of ejector positioning means 43, shown below reservoir 13, in order to achieve acoustic coupling between the ejector and the reservoir through acoustic coupling medium 41. Substrate 45 is positioned above and in proximity to the first reservoir 13 such that one surface of the substrate, shown in FIG. 1 as underside surface 51, faces the reservoir and is substantially parallel to the surface 17 of the fluid 14 therein. Once the ejector, the reservoir and the substrate are in proper alignment, the acoustic radiation generator 35 is activated to produce acoustic radiation that is directed by the focusing means 37 to a focal point 47 near the fluid surface 17 of the first reservoir. As a result, droplet 49 is ejected from the fluid surface 17 onto a designated site on the underside surface 51 of the substrate. The ejected droplet may be retained on the substrate surface by solidifying thereon after contact; in such an embodiment, it is necessary to maintain the substrate at a low temperature, i.e., a temperature that results in droplet solidification after contact. Alternatively, or in addition, a molecular moiety within the droplet attaches to the substrate surface after contract, through adsorption, physical immobilization, or covalent binding.

Then, as shown in FIG. 1B, a substrate positioning means 50 repositions the substrate 45 over reservoir 15 in order to receive a droplet therefrom at a second designated site. FIG. 1B also shows that the ejector 33 has been repositioned by the ejector positioning means 43 below reservoir 15 and in acoustically coupled relationship thereto by virtue of acoustic coupling medium 41. Once properly aligned as shown in FIG. 1B, the acoustic radiation generator 35 of ejector 33 is activated to produce acoustic radiation that is then directed by focusing means 37 to a focal point within fluid 16 near the fluid surface 19, thereby ejecting droplet 53 onto the substrate. It should be evident that such operation is illustrative of how the employed device may be used to eject a plurality of fluids from reservoirs in order to form a pattern, e.g., an array, on the substrate surface 51. It should be similarly evident that the device may be adapted to eject a plurality of droplets from one or more reservoirs onto the same site of the substrate surface.

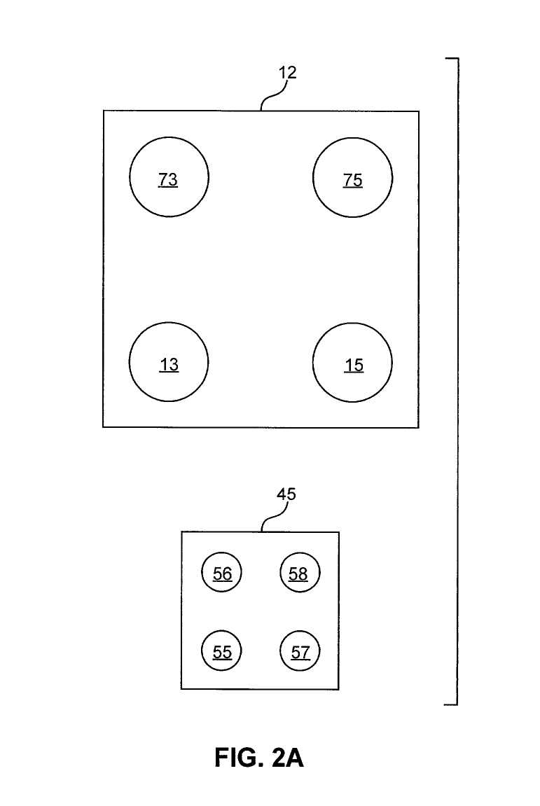

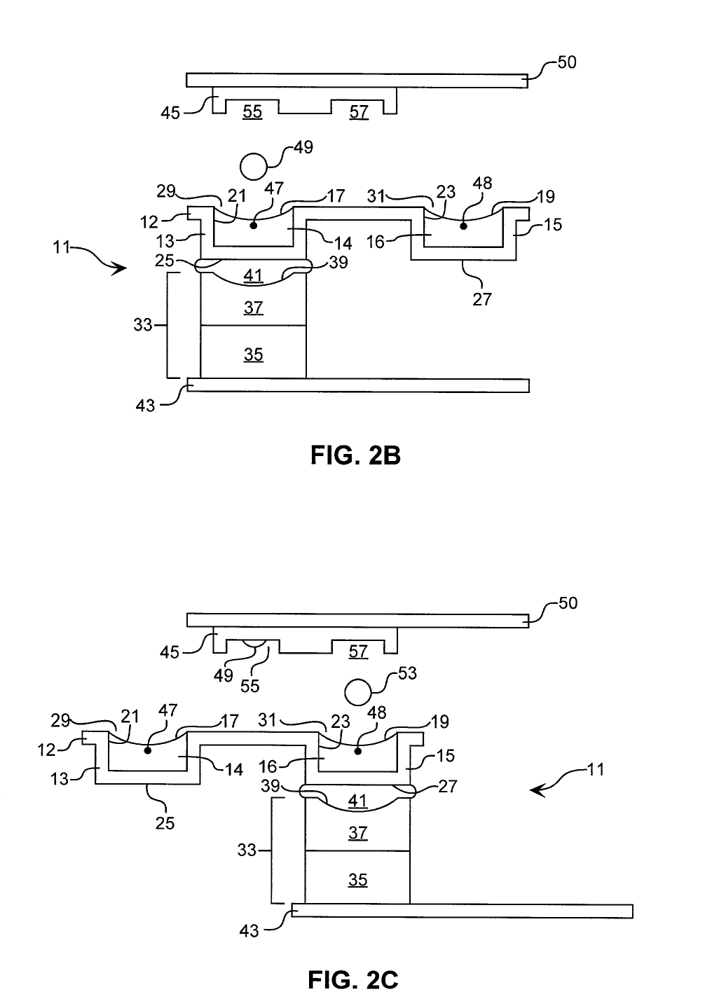

In another embodiment, the device is constructed so as to allow transfer of fluids between well plates, in which case the substrate comprises a substrate well plate, and the fluid-containing reservoirs are individual wells in a reservoir well plate. FIG. 2 illustrates such a device, wherein four individual wells 13, 15, 73 and 75 in reservoir well plate 12 serve as fluid reservoirs for containing a fluid to be ejected, and the substrate comprises a smaller well plate 45 of four individual wells indicated at 55, 56, 57 and 58. FIG. 2A illustrates the reservoir well plate and the substrate well plate in top plan view. As shown, each of the well plates contains four wells arranged in a two-by-two array. FIG. 2B illustrates the employed device wherein the reservoir well plate and the substrate well plate are shown in cross-sectional view along wells 13, 15 and 55, 57, respectively. As in FIG. 1, reservoir wells 13 and 15 respectively contain fluids 14 and 16 having fluid surfaces respectively indicated at 17 and 19. The materials and design of the wells of the reservoir well plate are similar to those of the reservoirs illustrated in FIG. 1. For example, the reservoir wells shown in FIG. 2B are of substantially identical construction so as to be substantially acoustically indistinguishable. In this embodiment as well, the bases of the reservoirs are of a material and thickness so as to allow efficient transmission of acoustic radiation therethrough into the fluid contained within the reservoirs.

The device of FIG. 2 also includes an acoustic ejector 33 having a construction similar to that of the ejector illustrated in FIG. 1, i.e., the ejector is comprised of an acoustic generating means 35 and a focusing means 37. FIG. 2B shows the ejector acoustically coupled to a reservoir well through indirect contact; that is, an acoustic coupling medium 41 is placed between the ejector 33 and the reservoir well plate 12, i.e., between the curved surface 39 of the acoustic focusing means 37 and the base 25 of the first reservoir well 13. As shown, the first reservoir well 13 is acoustically coupled to the acoustic focusing means 37 such that acoustic radiation generated in a generally upward direction is directed by the focusing mean 37 into the acoustic coupling medium 41, which then transmits the acoustic radiation into the reservoir well 13.

In operation, each of the reservoir wells is preferably filled with a different fluid. As shown, reservoir wells 13 and 15 of the device are each filled with a first fluid 14 and a second fluid 16, as in FIG. 1, to form fluid surfaces 17 and 19, respectively. FIG. 2A shows that the ejector 33 is positioned below reservoir well 13 by an ejector positioning means 43 in order to achieve acoustic coupling therewith through acoustic coupling medium 41. The first substrate well 55 of substrate well plate 45 is positioned above the first reservoir well 13 in order to receive a droplet ejected from the first reservoir well. Once the ejector, the reservoir and the substrate are in proper alignment, the acoustic radiation generator is activated to produce an acoustic wave that is focused by the focusing means to direct the acoustic wave to a focal point 47 near fluid surface 17. As a result, droplet 49 is ejected from fluid surface 17 into the first substrate well 55 of the substrate well plate 45. The droplet is retained in the substrate well plate by solidifying thereon after contact, by virtue of the low temperature at which the substrate well plate is maintained. That is, the substrate well plate is preferably associated with a cooling means (not shown) to maintain the substrate surface at a temperature that results in droplet solidification after contact.

Then, as shown in FIG. 2C, the substrate well plate 45 is repositioned by a substrate positioning means 50 such that substrate well 57 is located directly over reservoir well 15 in order to receive a droplet therefrom. FIG. 2C also shows that the ejector 33 has been repositioned by the ejector positioning means below reservoir well 15 to acoustically couple the ejector and the reservoir through acoustic coupling medium 41. Since the substrate well plate and the reservoir well plate are differently sized, there is only correspondence, not identity, between the movement of the ejector positioning means and the movement of the substrate well plate. Once properly aligned as shown in FIG. 2C, the acoustic radiation generator 35 of ejector 33 is activated to produce an acoustic wave that is then directed by focusing means 37 to a focal point near the fluid surface 19 from which droplet 53 is ejected onto the second well of the substrate well plate. It should be evident that such operation is illustrative of how the employed device may be used to transfer a plurality of fluids from one well plate to another of a different size. One of ordinary skill in the art will recognize that this type of transfer may be carried out even when both the ejector and substrate are in continuous motion. It should be further evident that a variety of combinations of reservoirs, well plates and/or substrates may be used in using the employed device to engage in fluid transfer. It should be still further evident that any reservoir may be filled with a fluid through acoustic ejection prior to deploying the reservoir for further fluid transfer, e.g., for array deposition. Additionally, the fluid in the reservoir may be synthesized in the reservoir, wherein the synthesis involves use of acoustic ejection fluid transfer in at least one synthesis step.

As discussed above, either individual, e.g., removable, reservoirs or well plates may be used to contain fluids that are to be ejected, wherein the reservoirs or the wells of the well plate are preferably substantially acoustically indistinguishable from one another. Also, unless it is intended that the ejector is to be submerged in the fluid to be ejected, the reservoirs or well plates must have acoustic transmission properties sufficient to allow acoustic radiation from the ejector to be conveyed to the surfaces of the fluids to be ejected. Typically, this involves providing reservoir or well bases that are sufficiently thin to allow acoustic radiation to travel therethrough without unacceptable dissipation. In addition, the material used in the construction of reservoirs must be compatible with the fluids contained therein. Thus, if it is intended that the reservoirs or wells contain an organic solvent such as acetonitrile, polymers that dissolve or swell in acetonitrile would be unsuitable for use in forming the reservoirs or well plates. For water-based fluids, a number of materials are suitable for the construction of reservoirs and include, but are not limited to, ceramics such as silicon oxide and aluminum oxide, metals such as stainless steel and platinum, and polymers such as polyester and polytetrafluoroethylene. Many well plates suitable for use with the employed device are commercially available and may contain, for example, 96, 384 or 1536 wells per well plate. Manufactures of suitable well plates for use in the employed device include Coming Inc. (Coming, N.Y.) and Greiner America, Inc. (Lake Mary, Fla.). However, the availability of such commercially available well plates does not preclude manufacture and use of custom-made well plates containing at least about 10,000 wells, or as many as 100,000 wells or more. For array forming applications, it is expected that about 100,000 to about 4,000,000 reservoirs may be employed. In addition, to reduce the amount of movement and time needed to align the ejector with each reservoir or reservoir well, it is preferable that the center of each reservoir is located not more than about 1 centimeter, preferably not more than about 1 millimeter and optimally not more than about 0.5 millimeter from any other reservoir center.

Moreover, the device may be adapted to eject fluids of virtually any type and amount desired. The fluid may be aqueous and/or nonaqueous. Examples of fluids include, include aqueous fluids including water per se and water solvated ionic and non-ionic solutions, organic solvents, and lipidic liquids, suspensions of immiscible fluids and suspensions or slurries of solids in liquids. Because the invention is readily adapted for use with high temperatures, fluids such as liquid metals, ceramic materials, and glasses may be used; see, e.g., co-pending patent application U.S. Ser. No. 09/669/194 (“Method and Apparatus for Generating Droplets of Immiscible Fluids”), inventors Ellson and Mutz, filed on Sep. 25, 2000, and assigned to Picoliter, Inc. (Cupertino, California). U.S. Pat. Nos. 5,520,715 and 5,722,479 to Oeftering describe the use of acoustic ejection for liquid metal for forming structures using a single reservoir and adding fluid to maintain focus. U.S. Pat. No. 6,007,183 to Horine is another patent that pertains to the use of acoustic energy to eject droplets of liquid metal. The capability of producing fine droplets of such materials is in sharp contrast to piezoelectric technology, insofar as piezoelectric systems perform suboptimally at elevated temperatures. Furthermore, because of the precision that is possible using the inventive technology, the device may be used to eject droplets from a reservoir adapted to contain no more than about 100 nanoliters of fluid, preferably no more than 10 nanoliters of fluid. In certain cases, the ejector may be adapted to eject a droplet from a reservoir adapted to contain about 1 to about 100 nanoliters of fluid. This is particularly useful when the fluid to be ejected contains rare or expensive biomolecules, wherein it may be desirable to eject droplets having a volume of about up to 1 picoliter.

From the above, it is evident that various components of the device may require individual control or synchronization to form an array on a substrate. For example, the ejector positioning means may be adapted to eject droplets from each reservoir in a predetermined sequence associated with an array to be prepared on a substrate surface. Similarly, the substrate positioning means for positioning the substrate surface with respect to the ejector may be adapted to position the substrate surface to receive droplets in a pattern or array thereon. Either or both positioning means, i.e., the ejector positioning means and the substrate positioning means, may be constructed from, e.g., linear motors, levers, pulleys, gears, a combination thereof, or other electromechanical or mechanical means known to one of ordinary skill in the art. It is preferable to ensure that there is a correspondence between the movement of the substrate, the movement of the ejector and the activation of the ejector to ensure proper pattern formation.

Moreover, the device may include other components that enhance performance. For example, as alluded to above, the device may further comprise cooling means for lowering the temperature of the substrate surface to ensure, for example, that the ejected droplets adhere to the substrate. The cooling means may be adapted to maintain the substrate surface at a temperature that allows fluid to partially or preferably substantially solidify after the fluid comes into contact therewith. In the case of aqueous fluids, the cooling means should have the capacity to maintain the substrate surface at about 0° C. In addition, repeated application of acoustic energy to a reservoir of fluid may result in heating of the fluid. Heating can of course result in unwanted changes in fluid properties such as viscosity, surface tension and density. Thus, the device may further comprise means for maintaining fluid in the reservoirs at a constant temperature. Design and construction of such temperature maintaining means are known to one of ordinary skill in the art and may comprise, e.g., components such a heating element, a cooling element, or a combination thereof. For many biomolecular deposition applications, it is generally desired that the fluid containing the biomolecule is kept at a constant temperature without deviating more than about 1° C. or 2° C. therefrom. In addition, for a biomolecular fluid that is particularly heat sensitive, it is preferred that the fluid be kept at a temperature that does not exceed about 10° C. above the melting point of the fluid, preferably at a temperature that does not exceed about 5° C. above the melting point of the fluid. Thus, for example, when the biomolecule-containing fluid is aqueous, it may be optimal to keep the fluid at about 4° C. during ejection.

Alternatively for some applications, especially those involving acoustic deposition of molten metals or other materials, a heating element may be provided for maintaining the substrate at a temperature below the melting point of the molten material, but above ambient temperature so that control of the rapidity of cooling may be effected. The rapidity of cooling may thus be controlled, to permit experimentation regarding the properties of combinatorial compositions such as molten deposited alloys cooled at different temperatures. For example, it is known that metastable materials are generally more likely to be formed with rapid cooling, and other strongly irreversible conditions. The approach of generating materials by different cooling or quenching rates my be termed combinatorial quenching, and could be effected by changing the substrate temperature between acoustic ejections of the molten material. A more convenient method of evaluating combinatorial compositions solidified from the molten state at different rates is by generating multiple arrays having the same pattern of nominal compositions ejected acoustically in the molten state onto substrates maintained at different temperatures.

For example, an iron carbon composition array could be ejected onto an appropriate substrate such as aluminum oxide, a ceramic, monocrystalline Si or monocrystalline Si upon which crystalline tetrahedral carbon (diamond) has been grown by routine methods. Arrays having the same pattern of nominal compositions may be spotted under identical conditions except that the substrate is maintained at a different temperature for each, and the resulting material properties may be compared for the differently quenched compositions.

In another embodiment, the invention involves modification of a substrate surface prior to acoustic ejection of fluids thereon. Surface modification may involve functionalization or defunctionalization, smoothing or roughening, changing surface conductivity, coating, degradation, passivation or otherwise altering the surface's chemical composition or physical properties. A preferred surface modification method involves altering the wetting properties of the surface, for example to facilitate confinement of a droplet ejected on the surface within a designated area or enhancement of the kinetics for the surface attachment of molecular moieties contained in the ejected droplet. A preferred method for altering the wetting properties of the substrate surface involves deposition of droplets of a suitable surface modification fluid at each designated site of the substrate surface prior to acoustic ejection of fluids to form an array thereon. In this way, the “spread” of the acoustically ejected droplets may be optimized and consistency in spot size (i.e., diameter, height and overall shape) ensured. One way to implement the method involves acoustically coupling the ejector to a modifier reservoir containing a surface modification fluid and then activating the ejector, as described in detail above, to produce and eject a droplet of surface modification fluid toward a designated site on the substrate surface. The method is repeated as desired to deposit surface modification fluid at additional designated sites. This method is useful in a number of applications including, but not limited to, spotting oligomers to form an array on a substrate surface or synthesizing array oligomers in situ. As noted above, other physical properties of the surface that may be modified include thermal properties and electrical conductivity.

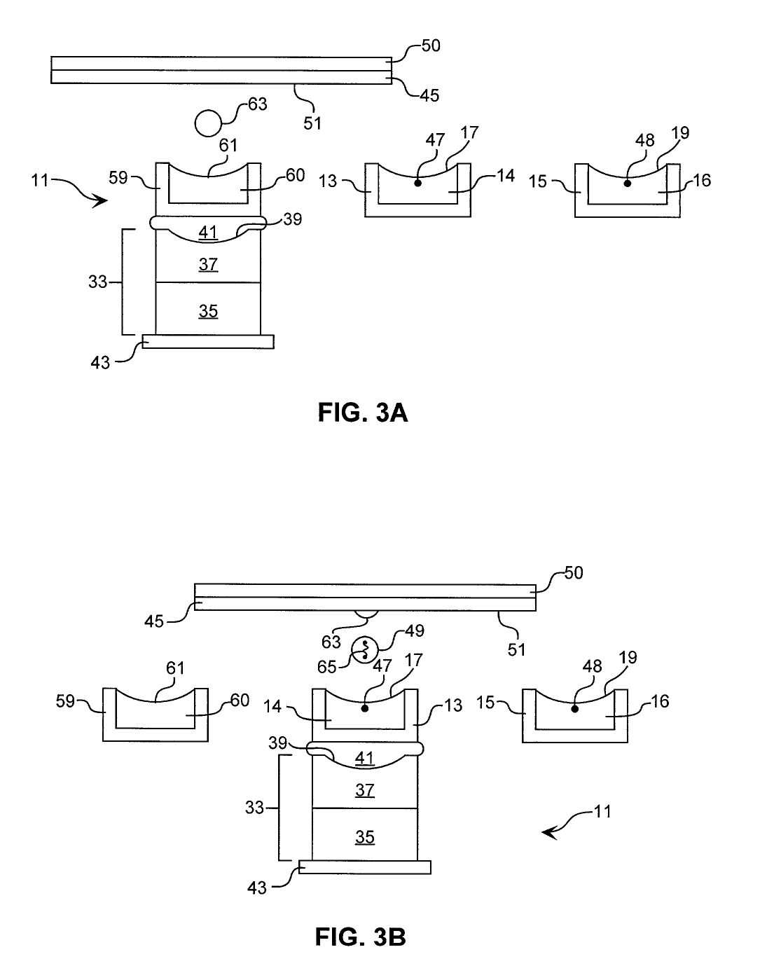

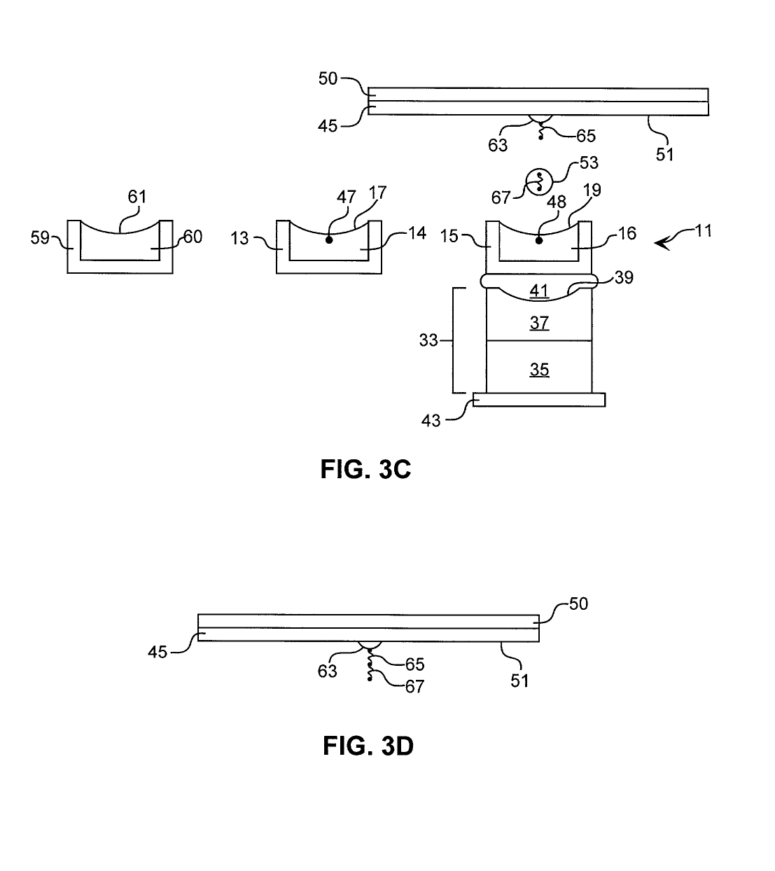

FIG. 3 schematically illustrates in simplified cross-sectional view a specific embodiment of the aforementioned method in which a dimer is synthesized on a substrate using a device similar to that illustrated in FIG. 1, but including a modifier reservoir 59 containing a surface modification fluid 60 having a fluid surface 61. FIG. 3A illustrates the ejection of a droplet 63 of surface modification fluid 60 selected to alter the wetting properties of a designated site on surface 51 of the substrate 45 where the dimer is to be synthesized. The ejector 33 is positioned by the ejector positioning means 43 below modifier reservoir 59 in order to achieve acoustic coupling therewith through acoustic coupling medium 41. Substrate 45 is positioned above the modifier reservoir 19 at a location that enables acoustic deposition of a droplet of surface modification fluid 60 at a designated site. Once the ejector 33, the modifier reservoir 59 and the substrate 45 are in proper alignment, the acoustic radiation generator 35 is activated to produce acoustic radiation that is directed by the focusing means 37 in a manner that enables ejection of droplet 63 of the surface modification fluid 60 from the fluid surface 61 onto a designated site on the underside surface 51 of the substrate. Once the droplet 63 contacts the substrate surface 51, the droplet modifies an area of the substrate surface to result in an increase or decrease in the surface energy of the area with respect to deposited fluids.

Then, as shown in FIG. 3B, the substrate 45 is repositioned by the substrate positioning means 50 such that the region of the substrate surface modified by droplet 63 is located directly over reservoir 13. FIG. 3B also shows that the ejector 33 is positioned by the ejector positioning means below reservoir 13 to acoustically couple the ejector and the reservoir through acoustic coupling medium 41. Once properly aligned, the ejector 33 is again activated so as to eject droplet 49 onto substrate. Droplet 49 contains a first monomeric moiety 65, preferably a biomolecule such as a protected nucleoside or amino acid, which after contact with the substrate surface attaches thereto by covalent bonding or adsorption.

Then, as shown in FIG. 3C, the substrate 45 is again repositioned by the substrate positioning means 50 such that the site having the first monomeric moiety 65 attached thereto is located directly over reservoir 15 in order to receive a droplet therefrom. FIG. 3B also shows that the ejector 33 is positioned by the ejector positioning means below reservoir 15 to acoustically couple the ejector and the reservoir through acoustic coupling medium 41. Once properly aligned, the ejector 33 is again activated so as to eject droplet 53 is ejected onto substrate. Droplet 53 contains a second monomeric moiety 67, adapted for attachment to the first monomeric moiety 65, typically involving formation of a covalent bond so as to generate a dimer as illustrated in FIG. 3D. The aforementioned steps may be repeated to generate an oligomer, e.g., an oligonucleotide, of a desired length.

The chemistry employed in synthesizing substrate-bound oligonucleotides in this way will generally involve now-conventional techniques known to those skilled in the art of nucleic acid chemistry and/or described in the pertinent literature and texts. See, for example, DNA Microarrays: A Practical Approach, M. Schena, Ed. (Oxford University Press, 1999). That is, the individual coupling reactions are conducted under standard conditions used for the synthesis of oligonucleotides and conventionally employed with automated oligonucleotide synthesizers. Such methodology is described, for example, in D. M. Matteuci et al. (1980) Tet. Lett. 521:719, U.S. Pat. No. 4,500,707 to Caruthers et al., and U.S. Pat. Nos. 5,436,327 and 5,700,637 to Southern et al.

Alternatively, an oligomer may be synthesized prior to attachment to the substrate surface and then “spotted” onto a particular locus on the surface using the methodology of the invention as described in detail above. Again, the oligomer may be an oligonucleotide, an oligopeptide, or any other biomolecular (or nonbiomolecular) oligomer moiety. Preparation of substrate-bound peptidic molecules, e.g., in the formation of peptide arrays and protein arrays, is described in co-pending patent application U.S. Ser. No. 09/669,997 (“Focused Acoustic Energy in the Preparation of Peptidic Arrays”), inventors Mutz and Ellson, filed Sep. 25, 2000 and assigned to Picoliter, Inc. (Cupertino, Calif.). Preparation of substrate-bound oligonucleotides, particularly arrays of oligonucleotides wherein at least one of the oligonucleotides contains partially nonhybridizing segments, is described in co-pending patent application U.S. Ser. No. 09/669,267 (“Arrays of Oligonucleotides Containing Nonhybridizing Segments”), inventor Ellson, also filed on Sep. 25, 2000 and assigned to Picoliter, Inc. (Cupertino, Calif.).

The present invention enables preparation of molecular arrays, particularly biomolecular arrays, having densities substantially higher than possible using current array preparation techniques such as photolithographic processes, piezoelectric techniques (e.g., using inkjet printing technology), and microspotting. The array densities that may be achieved using the devices and methods of the invention are at least about 1,000,000 biomolecules per square centimeter of substrate surface, preferably at least about 1,500,000 per square centimeter of substrate surface. The biomolecular moieties may be, e.g., peptidic molecules and/or oligonucleotides.

It should be evident, then, that many variations of the invention are possible. For example, each of the ejected droplets may be deposited as an isolated and “final”feature, e.g., in spotting oligonucleotides, as mentioned above. Alternatively, or in addition, a plurality of ejected droplets may be deposited on the same location of a substrate surface in order to synthesize a biomolecular array in situ, as described above. For array fabrication, it is expected that various washing steps may be used between droplet ejection steps. Such wash steps may involve, e.g., submerging the entire substrate surface on which features have been deposited in a washing fluid. In a modification of this process, the substrate surface may be deposited on a fluid containing a reagent that chemically alters all features at substantially the same time, e.g., to activate and/or deprotect biomolecular features already deposited on the substrate surface to provide sites on which additional coupling reactions may occur.

The device of the invention enables ejection of droplets at a rate of at least about 1,000,000 droplets per minute from the same reservoir, and at a rate of at least about 50,000 drops per minute from different reservoirs. In addition, current positioning technology allows for the ejector positioning means to move from one reservoir to another quickly and in a controlled manner, thereby allowing fast and controlled ejection of different fluids. That is, current commercially available technology allows the ejector to be moved from one reservoir to another, with repeatable and controlled acoustic coupling at each reservoir, in less than about 0.1 second for high performance positioning means and in less than about 1 second for ordinary positioning means. A custom designed system will allow the ejector to be moved from one reservoir to another with repeatable and controlled acoustic coupling in less than about 0.001 second. In order to provide a custom designed system, it is important to keep in mind that there are two basic kinds of motion: pulse and continuous. Pulse motion involves the discrete steps of moving an ejector into position, emitting acoustic energy, and moving the ejector to the next position; again, using a high performance positioning means with such a method allows repeatable and controlled acoustic coupling at each reservoir in less than 0.1 second. A continuous motion design, on the other hand, moves the ejector and the reservoirs continuously, although not at the same speed, and provides for ejection during movement. Since the pulse width is very short, this type of process enables over 10 Hz reservoir transitions, and even over 1000 Hz reservoir transitions.

In order to ensure the accuracy of fluid ejection, it is important to determine the location and the orientation of the fluid surface from which a droplet is to be ejected with respect to the ejector. Otherwise, ejected droplets may be improperly sized or travel in an improper trajectory. Thus, another embodiment of the invention relates to a method for determining the height of a fluid surface in a reservoir between ejection events. The method involves acoustically coupling a fluid-containing reservoir to an acoustic radiation generator and activating the generator to produce a detection acoustic wave that travels to the fluid surface and is reflected thereby as a reflected acoustic wave. Parameters of the reflected acoustic radiation are then analyzed in order to assess the spatial relationship between the acoustic radiation generator and the fluid surface. Such an analysis will involve the determination of the distance between the acoustic radiation generator and the fluid surface and/or the orientation of the fluid surface in relationship to the acoustic radiation generator.

More particularly, the acoustic radiation generator may activated so as to generate low energy acoustic radiation that is insufficiently energetic to eject a droplet from the fluid surface. This is typically done by using an extremely short pulse (on the order of tens of nanoseconds) relative to that normally required for droplet ejection (on the order of microseconds). By determining the time it takes for the acoustic radiation to be reflected by the fluid surface back to the acoustic radiation generator and then correlating that time with the speed of sound in the fluid, the distance-and thus the fluid height—may be calculated. Of course, care must be taken in order to ensure that acoustic radiation reflected by the interface between the reservoir base and the fluid is discounted. It will be appreciated by those of ordinary skill in the art of acoustic microscopy that such a method employs conventional or modified sonar techniques.

Once the analysis has been performed, an ejection acoustic wave having a focal point near the fluid surface is generated in order to eject at least one droplet of the fluid, wherein the optimum intensity and directionality of the ejection acoustic wave is determined using the aforementioned analysis optionally in combination with additional data. The “optimum” intensity and directionality are generally selected to produce droplets of consistent size and velocity. For example, the desired intensity and directionality of the ejection acoustic wave may be determined by using not only the spatial relationship assessed as above, but also geometric data associated with the reservoir, fluid property data associated with the fluid to be ejected, and/or by using historical droplet ejection data associated with the ejection sequence. In addition, the data may show the need to reposition the ejector so as to reposition the acoustic radiation generator with respect to the fluid surface, in order to ensure that the focal point of the ejection acoustic wave is near the fluid surface, where desired. For example, if analysis reveals that the acoustic radiation generator is positioned such that the ejection acoustic wave cannot be focused near the fluid surface, the acoustic radiation generator is repositioned using vertical, horizontal and/or rotational movement to allow appropriate focusing of the ejection acoustic wave.

In general, screening for the properties of the array constituents will be performed in a manner appropriate to the combinatorial array. Screening for biological properties such as ligand binding or hybridization may be generally performed in the manner described in U.S. Pat. Nos. 5,744,305 and 5,445,934 to Fodor et al. 5,143,854 and 5,405,783 to Pirrung et al., and 5,700,637 and 6,054,270 to Southern et al.

Screening for material properties may be effected by measuring physical and chemical properties, including by way of example rather than limitation, measuring the chemical, mechanical, optical, thermal, electrical or electronic, by routine methods easily adaptable to microarrays. For example, conductivity and resistivity may be measured by applying a potential difference to a material and measuring current using an appropriately sized electrical probe manipulated under the microscope. Alternatively multiple probe arrays that are suitable for measuring a property at all or multiple array sites may be manufactured by common semiconductor fabrication techniques. For example, a resistivity measurement device could be fashioned as an integrated device made of silicon comprising multiple prongs capable of making electrical contact simultaneously with a large number of electrically isolated sites, and having on board electronics making it capable of measuring conductivity/resistivity simultaneously for the number of sites so contacted.

In addition to bulk material characteristics or properties, surface specific properties may be measured by surface specific physical techniques and physical techniques that are adapted to surface characterization. Macroscopic surface phenomena including adsorption, catalysis, surface reactions including oxidation, hardness, lubrication and friction, may be examined on a molecular scale using such characterization techniques. Various physical surface characterization techniques include without limitation diffractive techniques, spectroscopic techniques, microscopic surface imaging techniques, surface ionization mass spectroscopic techniques, thermal desorption techniques and ellipsometry. It should be appreciated that these classifications are arbitrary made for purposes of explication, and some overlap may exist.

Diffractive techniques include X-ray diffraction (XRD, extreme glancing angle for surface), high, medium and low energy electron diffraction (HEED, MEED, LEED), reflection HEED (RHEED), spin-polarized LEED (SPLEED, especially useful in characterizing surface magnetism and magnetic ordering) low energy positron diffraction (LEPD), normal photoelectron diffraction (NPD), atomic or He diffraction (AD) and adaptation of neutron diffraction for surface sensitivity. Angle resolved X-ray photoelectron diffraction (ARXPD) measures angular phtoemission from X-ray photoelectron excitation and is therefore more akin to a spectroscopic technique.

Spectroscopic techniques utilizing electron excitation include Auger electron spectroscopy (AES) which detects 2° electrons ejected by decay of atoms to ground state after core hole electronic excitation and related techniques, including Auger electron appearance potential spectroscopy (AEAPS), angle resolved AES (ARAES), electron appearance potential fine structure spectroscopy (EAPFS), disappearance potential spectroscopy (DAPS). Additional spectroscopic techniques employing electron beam excitation include conversion electron Mossbauer spectroscopy (CEM), electron-stimulated ion angular distribution (ESIAD), electron energy loss spectroscopy (EELS) and high resolution EELS (HREELS), and related techniques including electron energy near edge structured (ELNES), surface electron energy fine structure (SEELFS). An additional electron excitation based spectroscopic technique that measures modulation of the absorption cross section with energy 100-500 eV above the excitation threshold, often by measuring fluorescence as the core holes decay is extended X-ray energy loss fine structure (EXELFS), NPD APD. Inverse photoemission of electrons (IP) gives information on conduction bands and unoccupied orbitals.

Photon excitation-based spectroscopies that do not employ classical particles are exemplified by ultraviolet photoemission spectroscopy (UPS), X-ray photoemission spectroscopy (XPS, formerly known as ESCA, electron spectroscopy for chemical analysis). XPS related techniques include: photon-stimulated ion angular distribution (PSD) analogous to ESDIAD, appearance potential XPS (APXPS) in which the EAPFS cross section is monitored by fluorescence from decay of X-ray photoemitted core holes, various angle resolved photoemission techniques (ARPES) including, angle-resolved photoemission fine structure (ARPEFS), angle-resolved UV photoemission spectroscopy (ARUPS), angle-resolved XPS (ARXPS), ARXPD, near-edge X-ray absorption fine structure that uses energies approximately 30 eV above the excitation threshold to measure both primary photoemitted electrons and Auger electrons emitted by core hole decay (NEXAFS), extended X-ray absorption fine structure (EXAFS), surface EXAFS (SEXAFS) which measure primary photoemitted electrons (PE-SEXAFS) and Auger electrons emitted by core hole decay (Auger-SEXAFS) and ions emitted by photoelectrons (PSD-SEXAFS). Angle resolved X-ray photoemission spectroscopy (ARXPS) measures angular distribution of photoemitted electrons.

Infrared absorption spectroscopies that provide molecular structure information on adsorbate, adsorbed molecules, include infrared reflection absorption spectroscopy (IRAS). Deconvolution of broad band IRAS using a Doppler shifted source and Fourier analysis is termed Fourier transform IR (FTIR). These techniques are especially important in determining identity and conformation of adsorbed atoms and molecules for predicting potential catalytic properties, e.g. for identifying which composition in an array should be further tested for catalytic properties. Most catalytic mechanisms proceed from adsorption, including physi- and chemi-sorption or both (Somorjai, Introduction to Surface Chemistry and Catalysis (1994) John Wiley & Sons).

Scattering based techniques include Rutherford back scattering (RBS), ion scattering spectroscopy (ISS), high energy ion scattering spectroscopy (HEBIS) mid-energy ion scattering spectroscopy MEIS low energy ion scattering spectroscopy (LEIS).

Microscopic techniques include scanning tunneling microscopy (STM) and applied force microscopy (AFM), which can detect adsorbed molecules. For example, STM has been used to demonstrate resident adsorbate as well as other surface contours, for example the liquid crystal molecule 5-nonyl-2-nonoxylphenylpyrimidine adsorbed on a graphite surface Foster et al (1988) Nature 338:137). AFM detects a deflection in a cantilever caused by surface contact, and includes scanning force microscopy (SFM) and friction force microscopy (FFM); force based macroscopic techniques can be used to study non-conductive surfaces, as they do not require electron tunneling from the bulk Mass spectroscopic (MS) techniques include SIMS and MALDI-MS, which can be used to obtain information on ionized macromolecules including biomacromolecules either formed on the substrate combinatorially or adsorbing to a surface of a combinatorial material. U.S. Pat. No. 5,959,297 describes scanning mass spectrometer having an ionization chamber and a collector that outputs an electrical signal responsive to the quantity of gas ions contacting the collector surface and methods for screening arrayed libraries of different materials that have been exposed in parallel to a gas reactant. MS techniques are also combinable with molecular beam (MB) techniques, especially molecular beam reactive scattering (MBRS), to permit detection of adsorption, and residence time at the adsorbate site, reactions, including surface catalysis of reactions of adsorbed molecules, and the angular distribution of adsorbate, and any product of reaction ejected from the surface (Atkins, Physical Chemistry, 6^{th} Ed. (1998) W. H. Freeman & Co., N.Y.). MS probing of microarrayed sites exposed to reactants by acoustic delivery can be combined with micro-desorptive MB techniques, or any of the techniques described herein which sample a surface area having sufficiently small dimensions. For example, micro-FTIR can be performed to adequate resolution with a sample diameter of 5 μm. A list of techniques and their associated sample diameter follows: XPS—10 μm; MALDI-MS -10 μm; SIMS—1 μm (surface imaging), 30 μm (depth profiling); AES—0.1 μm (100 nm); FE-AES—<15 nm; AFM/STM—1.5-5 nm; SEM 4.5 nm; FE-SEM—1.5 nm; RBS—2 mm; MB-MS—0. 1-0.3 mm. It will be appreciated that the array can be designed for the characterization technique, for example in non-biomacromolecular arrays where tested samples are not as rare and techniques involving larger sampling areas, such as SIMS depth profiling are desired sites having dimensions on the order of 100 μm may be used, corresponding to a density of about 10,000 sites/cm². Measurements of such properties as conductivity are further facilitated by larger features.

The thermal pattern of an array may be captured by an infrared camera to reveal hot spots such as catalytic regions, reacting regions and regions of adsorption in an array of materials. For example, a parallel screening method based on reaction heat absorbed from a surface catalytic reaction has been reported (Moates et al. (1996) Ind. Eng. Chem. Res. 35:4801-03). In the surface catalyzed oxidation of hydrogen over a metallic surface, IR radiation images of an array of potential catalysts reveal the active catalysts. The hot spots in the image, corresponding to array sites having catalytic activity, can be resolved by an infrared camera. Despite deviations in the heat capacity and surface thermal conductivity between materials creating the possibility that array sites having similar catalytic activity may rise in temperature to different extents, the presence or absence of detectable heating is a semiquantitative indication of the enthalpic release sufficient for screening to identify materials having some catalytic activity. Analogously for adsorption, even if the heat of adsorption for a given molecule can depend on the adsorption site and different materials can have different adsorption sites for the same molecule, heating of the array site is adequate for screening material having surfaces that adsorb a given molecule for various purposes including potential catalysis of reactions involving that molecule. The spontaneous reaction, as by surface rearrangement, oxidation or other process may also be detectable by detection of surface heating. As surfaces are inherently metastable and the relative metastability of the surface often determines the usefulness of a material as determining the useful life of a manufacture from the material, determining the surface reactivity under various conditions is important. Physical, chemical, biological and/or biomaterials/biocompatibility measurement of the kinetics of surface rearrangement generally and specific mechanistic included processes versus temperature will yield valuable information on free energy of activation of various processes. Infrared imaging also may be useful for such determinations, but because many if not most spontaneous surface phenomena are likely to be entropic phenomena, reliance must not be placed solely upon semiquantitative thermodynamic measurements.

Biomaterial properties may also be characterized or screened. In some cases arrays may be implanted wholesale into laboratory animals, and fibrosis, inflammatory changes, promotion of protein aggregation and the like can be compared for the naked substrate and various nearby combinatorial sites, although ultimately individual materials should be implanted separately. In vitro approaches to biocompatibility include measuring adsorption of various proteins and mixtures thereof over time at the different sites. Surfaces that (1) exhibit low levels of (2) saturable adsorption for (3) the fewest different proteins and (4) do not denature the adsorbate proteins are most likely to be biocompatible. For example, polyethylene glycol (PEG) modified Si surfaces, in which the amount of adsorbate over time saturates at relatively low levels, were shown to be more biocompatible than unmodified surface, which continues to accumulate adsorbate over all observed time periods (Zhang et al (1998) Biomaterials 19(10):953-60). Zhang et al. study adsorption of albumin, fibrinogen, and IgG to Si surfaces having self assembled PEG by ellipsometry to evaluate the non-fouling and non-immunogenic properties of the surfaces; additionally, adhesion and proliferation of human fibroblast and Hela cells onto the modified surfaces were investigated to examine their tissue biocompatibility. Adsorption experiments on polymer functionalized surfaces suggest entropic effect, evidenced by conformationally more labile polymer having greater anti-adsorption effect (Cordova et al. (1997) Anal. Chem. 69(7):1370-9) that may effect saturation by preventing denaturation and layering non-specific aggregation.

| Analytical | | Signal | Elements | Organic | Detection | Depth | Image | Lateral Res. |
|---|---|---|---|---|---|---|---|---|
| Technique | Typical Use | Detected | Detected | Data | Limits | Resolution | or Map | Probe |
| AES | Surface analysis | Auger e⁻ from | Li—U | — | 0.1-1 | <2 nm | Y | 100 nm |
| | & high res. depth | near-surface | | | atom % | | | |
| | profiling | atoms | | | | | | |
| FE AES | Surface analysis, | Auger e⁻ from | Li—U | — | 0.1-1 | 2-6 nm | Y | <15 nm |
| | micro-analysis & | near-surface | | | atom % | | | |
| | micro-area depth | atoms | | | | | | |
| | profiling | | | | | | | |
| AFM STM | Surface imaging | Atomic scale | — | — | — | 0.01 nm | Y | 1.5-5 nm |
| | with near atomic | surface | | | | | | |
| | resolution | contour | | | | | | |
| micro-FTIR | ID: plastics, | IR absorption | — | groups | 0.1-100 | — | N | 5 μm |
| | polymers, | | | or | ppm | | | |
| | organic films, | | | moieties | | | | |
| | fibers & liquids | | | | | | | |
| TXRF | Metal presence | Fluorescent X- | S—U | — | 1 × 10⁹-1 × 10¹² | — | Y | 10 mm |
| | on surface | rays | | | atoms/cm² | | | |
| XPS ESCA | Surface analysis. | photo-e⁻ | Li—U | — | 0.1-1 | 1-10 nm | Y | 10 μm- |
| | organic & | | | | atom % | | | 2 mm |
| | inorganic | | | | | | | |
| | molecules | | | | | | | |
| HFS | Quantitative H in | scattered H | H, D | — | 0.1 atom % | 50 nm | N | 2 mm × |
| | thin film | atoms | | | | | | 10 mm |
| RBS | Quantitative thin | back-scattered | Li—U | — | 1-10 (Z < 20); | 2-20 nm | Y | 2 mm |
| | film composition | He atoms | | | 0.01-1 | | | |
| | & thickness | | | | (20 < Z < 70), | | | |
| | | | | | 0.001-0.01 | | | |
| | | | | | (Z > 70), | | | |
| | | | | | (atom %) | | | |
| SEM EDS | Imaging & | 2° & back- | B—U | — | 0.1-1 | 1-5 μM | Y | 4.5 nm |
| | elemental micro- | scattered e⁻ & | | | atom % | (EDS) | | (SEM); |
| | analysis | X-rays | | | | | | 1 μM |
| | | | | | | | | (EDS) |
| FE SEM | High res. | 2° & back- | — | — | — | — | Y | 1.5 nm |
| | imaging of | scattered e⁻ | | | | | | |
| | polished surface | | | | | | | |
| FE SEM (in | Ultra-high res. | 2° & back- | — | — | — | — | Y | 0.7 nm |
| lens) | imaging w. | scattered e⁻ | | | | | | |
| | contrast medium | | | | | | | |
| SIMS | Dopant & | 2° ions | H—U | — | 1 × 10¹²- | 5-30 nm | Y | 1 μm |
| | impurity depth | | | | 1 × 10¹⁶ | | | (imaging); |
| | profiling, surface | | | | atoms/cm³ (ppb- | | | 30 μm |
| | micro-analysis | | | | ppm) | | | (depth |
| | | | | | | | | profiling) |
| Quad SIMS | Dopant & | 2° ions | H—U | — | 1 × 10¹⁴- | <5 nm | Y | <5 μM |
| | impurity depth | | | | 1 × 10¹⁷ | | | (imaging); |
| | profiling, surface | | | | atoms/cm³ | | | 30 μM |
| | micro-analysis | | | | | | | (depth |
| | | | | | | | | profiling) |
| TOF SIMS | Surface micro- | 2° ions, atoms | H—U | Molecular | <1 ppma, | 1 mono- | Y | 0.10 μM |
| | analysis. | & molecules | | ions | 1 × 10⁸ | layer | | |
| | organics, plastics | | | to mass | atoms/cm² | | | |
| | & polymers | | | 1 × 10⁴ | | | | |
| MALDI | Protein, peptide, | Large | — | Molecular | femtomole- | — | N | 10 μM |
| | & polymer MW | molecular ions | | ions | picomole | | | |
| | distr | | | to mass | | | | |
| | | | | 1.5 × 10⁵ | | | | |

In general, with respect to the screening of arrayed materials for various properties, those surface physical characterization techniques capable of generating a map of the surface microstructures of arrayed materials are of use in identifying various potential properties of the surface, especially physical properties of the surface pertinent to the material properties, including surface roughness and grain orientation, and functionalization, including, for example, silanol formation and electron cloud orientation in crystalline silicon surfaces, and potential chemical and physical adsorption (chemi-, physi-sorption) sites for various molecules, information that may be useful of itself and in predicting potential for catalytic activity.

The ordinarily skilled in combinatorial chemistry will appreciate that the methods of the instant invention are applicable to all manner of crystallizations. Organic, inorganic and elemental compounds may be crystallized by the combinatorial experimental methods of acoustic droplet deposition. Such crystallization may occur from aqueous or other solution, including a solution comprising a molten metal solvent and a solute comprising any element or compound capable of withstanding the temperature and other physical conditions of, and not reacting with, the solvent. Such crystallizations may be by spontaneous nucleation or with nucleation by addition of seed crystals. Seed crystals can be added to the combinatorial droplet preparations suspended in fluid droplets deposited by acoustic deposition. The methods of the invention can thus readily be applied by one of ordinary skill to determining conditions ideal for crystallizing anything from diamonds to glucose crystals. The structure of such materials is relatively easily obtained by routine methods. The instant invention will readily be appreciated to be applicable to determining conditions which favor processes that compete with crystallization, such as non-specific aggregations to form amotphous aggregates, and micro-precipitation. Additionally, the small volume combinatorial experimental methods of the instant invention may also be employed to determine conditions that favor one type of crystal over another, for example microcrystals over larger less numerous crystals, and higher versus lower purity crystals and crystals having a higher occurrence of defects such as lattice vacancies and the like over more perfect crystals.

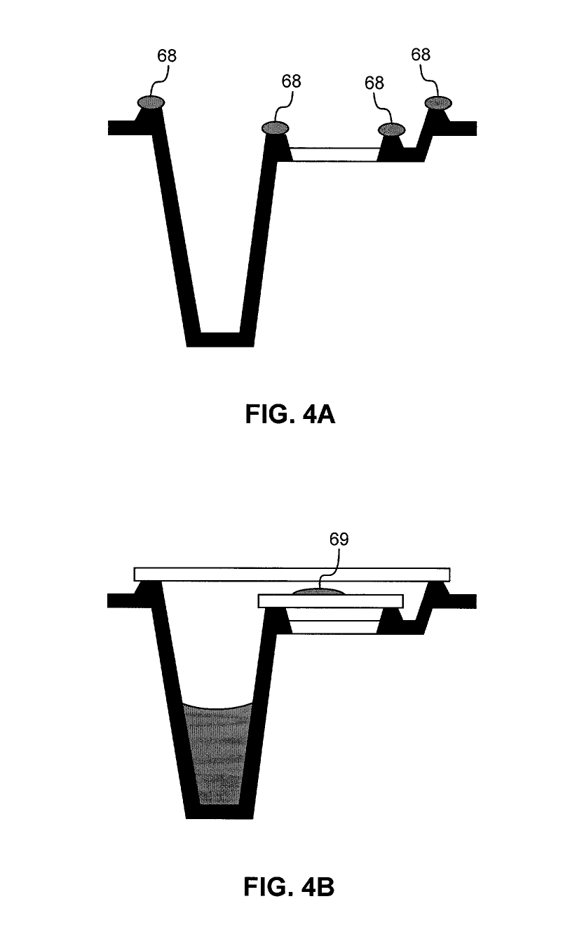

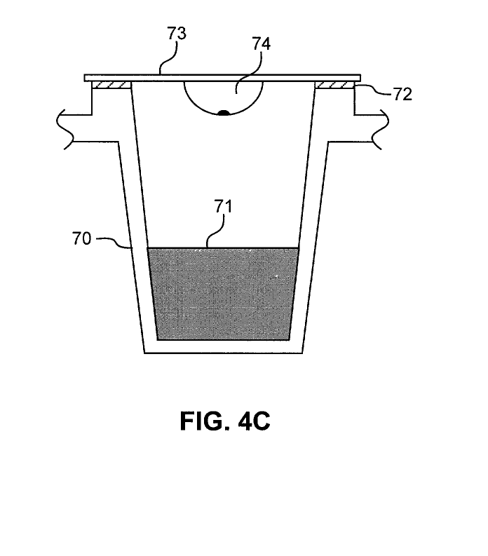

Acoustic drop ejection (ADE) also provides a method for increasing the number of crystallization conditions assayed for a given quantity of a macromolecule such as a protein or nucleic acid. Current high-throughput methods are able to screen nanodroplets (volumes as small as 40 nL). The hundred fold reduction of experimental crystallization volume to 40 nL from to 4 mL volumes conserves protein supplies, allowing the screening of about 480 different crystallization conditions per protein per hour and reduces the time required for crystallization from several days to several hours. (Stevens (2000) Curr. Opin. Struct. Biol. 10:558). The use of smaller volumes decreases diffusion time, thus increasing rapidity of both nucleation and crystal formation, and can also accelerate equilibria leading to crystal formation due to faster rates of vapor diffusion in the commonly used standing drop (FIG. 4A, FIG. 4B) and hanging drop (FIG. 4B) techniques. In these methods, the drop 69 (FIG. 4B) and 74 (FIG. 4C) is placed in a small container sealed to the outside atmosphere and in the presence of a reservoir, 70 (FIG. 4C), containing a solvent solution, 71 (FIG. 4C), that resembles the composition of the solvating liquid of the biomacromolecule or moiety in the experimental droplet without containing the biomacromolecule or other moiety of interest for crystallization. A gasket or seal is employed to seal off the container from the atmosphere, 68 (FIG. 4A), 72 (FIG. 4C). Often the gasket material is a grease such as high vacuum grease.

Usually the solvent solution contained in the reservoir is slightly hypertonic relative to the fluid in the experimental droplet, permitting solvent diffusion out of the droplet in a thermodynamically reversible manner that favors orderly crystal growth. The artisan of ordinary skill will immediately appreciate that a slightly hypotonic reservoir solution may be sometimes desirable. For example it is known that protein nucleation often requires a concentration of the protein of interest for crystallization, while th best quality crystals for crystallographic structure determination are typically grown at lower than saturated concentrations (McRee, Practical Protein Crystallography, 2^{nd} Ed. Academic Press, 1999). Thus the reservoir solution might contain a less hypertonic or perhaps even slightly hypotonic solution after nucleation has occurred to redissolve some of the crystal and regrow it more slowly.

Multiple drop experiments are performed using standard sized crystallization setups of the type depicted in FIG. 4. Acoustic ejection can form an array of hanging droplets, each with a volume of picoliters, at densities of 1,000/cm², 10,000/cm² or greater, converting the standard scale hanging drop experiment into several thousand experiments. This permits duplication as well as combinatorial experimentation with small amounts of biomacromolecule. The hanging drops can be generated without the need for inverting the coverslip after depositing the fluid on it. Further, dilution can be obtained by acoustically ejecting reservoir fluid onto overlying hanging droplets without breaking the gasket seal. Often the initial preparation of the experiment requires reservoir fluid to be deposited onto a droplet containing the protein, and this must be done rapidly to prevent overdessication from the atmosphere. ADE therefore permits the dilution to be performed after sealing the gasket. Standard size sitting droplet containers can also be adapted for use with dense arrays of picovolume experiments on each coverslip. Clearly current advances in microfabrication techniques permit individual microwell arrays for hanging or sitting picodroplet experiments. The atomically smooth surfaces obtainable by microfabrication of monocrystalline Si and the like reduce the amount of sealing required, and may obviate the need for a separate gasket, but patterned polymer, including photolabile polymers routinely used in the microelectronics industry can be employed as gaskets for microfabricated well arrays for crystallization experiments. Individual droplets or multiple droplets comprising crystallization experiments may be placed in the individual micro-wells.

With rapid detection the solvent reservoir may be manipulated quickly. Fluid in standard sized reservoirs for crystallization experiments (for example the round coverslip used in the conventionally sized hanging drop container depicted in FIG. 4C is 18-22 mm in diameter), may be manipulated by conventional methods such as micropipetting or by acoustic deposition into, and ejection from, the reservoir. If the reservoirs are significantly smaller, for example in a microfabricated array for individual picoliter order volume hanging droplets, the micro-wells can conveniently and effectively be titrated to the desired composition by acoustic deposition and ejection, thus obviating the need to provide microfluidic channels and the like. Microfluidic channels increase the complexity of the microfabrication, and are incapable of accurately and precisely delivering or removing as small volumes to the reservoirs as may be effected by acoustic deposition/ejection.

By using ADE to dispense volumes ranging from 0.1 picoliter to several nL, and thereby scale down th volume of the experiments to the order of picoliters, the ability to form diffraction quality crystals in minutes as opposed to several hours becomes a reasonable expectation. Moreover, if the use of 4 nL volumes allows the screening of 480 conditions, the use of 40 pL volumes should allow the screening of at least 480,000 combinatorial conditions for a given supply of protein, or alternatively of the 480 conditions each repeated 1000 fold to capture stochastic nucleation events. Using volumes of about 40 pL will typically allow crystallization within several minutes.

The capability to accurately dispense volumes of such small magnitude immediately permits myriad combinatorial approaches. Stevens, (2000) supra, notes the importance of improvements in conventional microfluidics in the down-scaling of protein crystallization experiments, observing that the solvent reservoir becomes unnecessary for some crystallizations for the reported down-scaling from 4 mL to 40 nL. But there exists a significant possibility that downsizing to 40 pL may require a slightly hypotonic or isotonic reservoir to slow down the diffusion. Crystallographers often employ an oil based coating on droplets to slow down diffusion out of the droplets (microbatch technique), and the vapor diffusion control method avoids applying oil to the experimental droplet, but caps the reservoir with an oil coating. These methods may be employed in down-scaled experiments by ADE as will be described in more detail below.

Another oil based method that could be adapted to a combinatorial picovolume experimental crystallization array by employing an array of wells has been described by Lorber et al., (1996) Journal of Crystal Growth 168:214-15, termed the floating drop method. The standard size floating drop technique employs two immiscible silicone oils having different densities in a well plate, allowing the crystallization experiment to float at the interface. Poly-3,3,3-trifluoropropylmethylsiloxan (FMS) is dense and viscous, being highly branched, while polydimethylsiloxan (DMS) is less dense and runny, being unbranched. The dispensation of FMS into conventional 96 well plates is hindered by the high viscosity, but acoustic deposition is nozzleless making manipulation of the FMS easier for the scaled down technique. In the conventional method the DMS is deposited on top of the FMS, followed by the experimental fluid. For the scaled down version, micro-wells having dimensions of about 65 μ wide and deep and a capacity of about 250 pL are ideal. 100 pL of DMS is acoustically deposited in each well (open end down), and although runny, will be held in place by surface tension. The crystallization solutions are then deposited as a droplet with volume of about 2 pL to 20 pL. If the total experimental fluid volume is towards the upper limit in volume, 20 pL, success with multiple droplet depositions is expected, as individually deposited aqueous droplets will coalesce. This is followed by deposition of 100 pL of FMS below of the DMS in each well, the sticky FMS sealing the experiment. Note that a slight difference exists in that the vapor diffusion occurs through the FMS rather than the DMS as in the standard floating experiment. This will typically be advantageous, as slower vapor diffusion usually produces superior crystals. Alternatively the top of each well can be fashioned to communicate with the surrounding gas by relatively new sacrificial layer microfabrication methods described above. Or the array might be inverted while at a slightly higher temperature than the ultimate experimental temperature, but this may require larger dimension wells, depending on the behavior of the FMS. Fluid reservoirs for solvent may also be provided by microfabrication.

Relatively dense arrays of small volume droplets may be employed without any solvent reservoir. Such array crystallizations may or may not require an oil coating to produce diffraction grade crystals capable of being solved for high resolution structures. Such arrays should also be isolated from the atmosphere, and if enclosed in a sufficiently small volume, the droplets that do not crystallize will serve as diffusion “sinks” for excess solvent in crystallizing droplets (wherein the tonicity will be appreciated to be decreasing because of solute depletion by the crystallization process). Reservoirs may be easily microfabricated for droplet arrays, for example microchannels can surround a given number of arrayed droplets so that no droplet is greater than a desired distance from a fluid reservoir. More complicated microfabrication protocols may be employed to produce microwell reservoir droplet sites.

Acoustic technology can also be used to monitor the emergence and progression of protein crystallization, by scanning acoustically for initiation, and periodically at locales of detection, of crystallization. Optical screening of crystal growth, requiring a microscope, is presently used with an image acquisition system. However, optical screening is often not adequate in discriminating between protein crystals and buffer crystals because it does not contain information about the interior composition of the crystals. Buffer crystals are more tightly packed than proteins and have lower water content. Protein crystals have much higher water content and are therefore less dense than a buffer crystal. Also, relatively weak interactions render the conformation of proteins and other biomacromolecules. The large difference in interaction energy of biomacromolecules from the covalent, metallic or ionic bonds that define the interaction energy wells of non-biomacromolecular crystals requires that the mechanical properties of the materials be different. Acoustic waves are mechanical waves and their behavior is affected by the mechanical properties of the medium through which they propagate. Thus acoustic waves are able to discern non-biomacromolecular from macromolecular crystals. Applying acoustic pulses and measuring acoustic signal to a solution of crystals may consequently be employed to distinguish buffer crystals and protein crystals. Moreover, acoustic or sonic imaging methods, for example acoustic microscopy, are exquisitely sensitive to size of any crystals imaged. Therefore, acoustic pulse technology can be used to assess the size, and more importantly, the composition of a growing crystal without the need for cumbersome diffractometry experiments. Acoustic pulse technology can also be employed to study the kinetics of crystal nucleation and growth. Often buffer salts crystallize more rapidly than proteins making the ability of acoustic detection means to discern these different crystals practically useful.

Unique aspects of biomacromolecule crystallography include cold storage of crystals and mounting difficulties arising therefrom. Focused acoustic may be used to manipulate crystals under liquid nitrogen more conveniently by bumping them to the surface and ejecting them with the focused acoustic energy. Crystals may be ejected directly into closed ended capillaries or microcapillaries for mounting for the diffraction and data collection. Smaller microcrystals obtained from scaled down experiments obtainable by employing acoustic “picofluidic” manipulation of reagent-containing droplets may be mounted by acoustic deposition into microfabricated crystal mounts. Seeding by acoustic deposition of finely crushed small crystals can be effected by ADE deposition of crystal fragments suspended in appropriate fluid, often the mother liquor from which the seed crystals were crystallized. Acoustic droplet ejection based seeding is not uniquely applicable to biomacromolecule crystal growing techniques, but conserves precious expressed or even purified biomacromolecules. If crystals obtained from small volume experiments are not sufficiently large to yield high resolution structures from the diffraction data, but are of sufficient quality, the experiment can be scaled up to volumes of the order of nanoliters, such as 40 nL, and the original crystal can be used to seed the scaled up experiment. Crystals obtained that are of insufficient quality can be recrystallized in small volume experiments, redissolved as further purified protein for de novo crystallization attempts, and/or used in picoliter to hundred picoliter order of magnitude volume scale, or scaled up experiments.

The crystallization of biopolymers and biomacromolecules particularly, most particularly those biomacromolecules having conformational structure, include, by way of example, proteins and various classes of RNAs. The definition of conformational structure is accepted as levels of structure higher than primary structure or monomer sequence, including secondary, tertiary, quaternary and quinquinary structure (relationship between secondary, tertiary and/or quaternary structures of two biopolymeric-macromolecules). Conformation is widely appreciated to be, in summary, exquisitely complex and dependent upon the precise conditions of the crystallization (Creighton, Proteins, 2nd Ed., W. H. Freeman, 1993). Analogy can be drawn to the folding of proteins, also exquisitely sensitive to conditions (Creighton, Proteins, supra).

Crystallization of proteins and other biomacromolecules, including biomacromolecules having secondary, tertiary, quaternary, and/or quinquinary is typically difficult and time consuming (Creighton, Proteins, supra; McRee, Practical Protein Crystallography, supra). for several reasons. General crystallization factors, include solution concentration and energetic considerations, including solute and crystal stabilizing and destabilizing manipulations, that affect chemical potential, kinetics of nucleation and propagation of crystal growth, and the need to get the moiety of interest into solution to obtain crystallized materials. These considerations lead to important conclusions about small molecules compared to macromolecules that are relevant to the instant invention. The diffusion coefficient of a molecule in solution may be approximated by analogy to that from kinetic theory of gases C_{diff}=(⅓)*λ*s, where s is particle speed and λ is mean free path. Neglecting viscosity which reduces mean s more at a temperature with increased collision cross section, particle mean free path λ is inversely proportional to cross sectional area (A), thus: λ∝(M)^{-0.6666}, M denoting mass of the molecule because mass is proportional to volume and cross sectional area is proportional to the cube root of volume squared Thus larger molecules diffuse in solution more slowly (see generally Atkins, Physical Chemistry, W. H. Freeman, 1998).

This affects kinetics of nucleation, a stochastic process believed to require an improbable or entropically disfavored ordering of a critically sufficient number of particles without the full stabilization of a three dimensional bulk lattice. The kinetics of crystal formation are affected by the diffusion coefficient to the extent that the process is diffusion controlled. Typical crystallization conditions are believed to be rapid at the crystal liquid interface, depleting the crystallizing moiety rapidly, and causing diffusion to play a role in the time scale for crystal formation. Consequently small molecules are more likely to nucleate and crystals of small molecules will grow faster than large molecules. The stochastic nature of nucleation engenders the conclusion that multiple trials with identical nucleation permissive conditions will yield some nucleation events, thus a large number of duplicative experiments are justified. But biomacromolecules are difficult to isolate purify and express or synthesize, making the amounts available for crystallization experiments scarce relative to the number of different combinatorial experiments available and the large number of duplicative experiments required to exhaustively explore the vast combinatorial-stochastic realm of never crystallographically structured proteins. Already structured proteins may also be probed for different crystals of conformation molecules or different unit cell or higher quality crystals. Protein crystallographers have observed that with multiple trials some are successful for (McRee, Practical Protein Crystallography, supra). The high degree of asymmetry of biomacromolecules having higher levels of structure than primary structure makes stochastic nucleation less likely because of the complexity of the unit cells, making the formation of a first unit cell and subsequently aligned unit cells more improbable than for a more symmetric molecule. These kinetic considerations for nucleation and crystal growth neglect two important considerations of biomacromolecule crystallization that are relatively insignificant for smaller, less complexly structured molecules. Specifically non-specific aggregation of native or partly unfolded protein molecules is favored kinetically and in some cases thermodynamically for entropic considerations, and is a non-productive side reaction for protein crystal growing purposes. Additionally, a polypeptide may not be adequately structured, either because it is non-native, or because a native conformation is highly disordered, as is seen with PrP^{C} solution NMR structures (Liu et al. (1999) Biochemistry 38(17):5362-77, but Zuegg et al., (2000) Glycobiology 10(10):959-74, have shown by molecular dynamics that the glycophospho-inositol anchor renders the whole protein more structured, suggesting that crystallization of a micelle-GPI-PrPC co-crystal may be possible).

Conformation and/or folding, and aggregation my exist as relatively minor problems for crystallizing less complex molecules. The existence of multiple cell compartments and biomacromolecules proteins which may reside partly in one compartment, partly in another and partly in a phospholipid bilayer membrane is a unique complication affecting biomacromolecule crystallization. For such macromolecules the physical and chemical conditions required for one domain to be in a native structured conformation may be different for a second and third domain. Further membrane proteins having hydrophobic helical transmembrane domains and other lipid resident surfaces may aggregate through non-specific hydrophobic interactions upon assuming the membrane resident native structure. Some such proteins, for example bacteriorhodopsin have been crystallized using salt precipitation after solubilization and stabilization of the hydrophobic surface by octyl glucoside by Michel et al., (1980) Proc. Natl. Acad. Sci. U S A 77(3):1283-5, a feat earning the successful crystallographer the Nobel Prize. A technique termed two dimensional electron crystallography (2DEC) images membrane proteins that form two dimensional crystals or ordered arrays. Although 2DEC does not suffer from the phase problem of X-ray crystallography, structures are to much lower resolution. The current prevalence of 2DEC for obtaining membrane protein structural information evidences the difficulties in obtaining crystallographic quality three dimensional crystals.

One of skill in the art will immediately apprehend that in addition to offering a scale down of protein crystallization experiments to increase rapidity and number of experiments possible with the limited amounts of proteins that can be expressed for crystallization experiments by modem techniques, acoustic ejection of immiscible fluids may provide improved methods for creating two and especially three dimensional crystals of membrane proteins. For example micelles containing anchored proteins may be deposited by acoustic ejection in pico-sites having small fluid volumes. Phospholipid bilayer liposomes having different conditions inside and outside the liposome and having a membrane protein traversing the bilayer with a portion inside and portion outside the liposome. Or two dimensional crystals of membrane proteins anchored or embedded in a bilayer can be ejected onto substrate surface and stacked in arrangements permitting inter-protein interactions (for example with an externally anchored protein external facing external) to attempt construction of appropriate three dimensional crystals for crystallographic structuring.

Proteins and other higher ordered structure biomacromolecules, including nucleic acids, exemplified by transfer RNA and ribozymes such as hammerhead ribozyme, are more difficult to structure image to crystallographic resolution by solution or other NMR techniques than by crystallographic methods. NMR methods are therefore reserved for those proteins refractory to crystallization, including Heat Shock Protein class proteins (HSPs), including steroid and retinoid receptors and Prion Potein (PrP).

Protein conformations or conformers, even of pathologic conformations such as the scrapie associated conformer of PrP (PrP^{Sc}) are best viewed as native conformations along with the so called cellular conformer PrPC. The mere pathophysiologic effect of a does not render a misfolded protein non-native, and increases practical and scientific value of a crystal structure therefor. A crystal structure for a fully denatured polypeptide or other biopolymer, has little value, except perhaps in studying the basic interactions between monomeric units in certain biopolymer sequences, assuming the unlikely event of crystallization.

Biomacromolecule folding and conformation, including that of nucleic acids such as tRNA, ribozymes and other structured nucleic acids and nucleic acid/protein complexes such as ribosomes and spliceosomes are exquisitely sensitive to presence of ligand and physical and chemical conditions. Their crystallization is in turn exquisitely sensitive to both the presence of numerous copies of the same ordered, crystallizable structure and physical and chemical conditions of crystallization. In addition to folding and conformation, biomacromolecules having partly denatured domains or that contain native regions essentially devoid of structure, and native membrane proteins, are also prone to non-specific aggregation from the solutions typically employed to crystallize proteins. Thus conditions affect both the number of crystallizable structures available, by affecting both non-specific aggregation, and the folding and conformation of polypeptides and the chemical and physical conditions directly affect crystallization. Thus protein crystallization is exponentially sensitive to conditions, being indirectly and directly affected thereby.

The preceding identifies and delineates three basic mechanisms by which a physical or chemical condition, such as a chemical agent, can affect the crystallization process or increase the likelihood of forming crystals and consequently of forming diffraction grade crystals, crystals of sufficient quality to yield diffraction patterns capable of being solved for high resolution crystal structures. First the physical or chemical condition can promote crystal formation directly by affecting the thermodynamics or kinetics of crystal formation from a specific structure or conformer. Second the physical or chemical condition can stabilize a conformation or promote naturation to yield a crystallizable structure. Third an agent or other physical or chemical condition can prevent non-specific aggregation of the polypeptide, thereby promoting folding into a structured conformation and crystallization by reducing non-productive side reactions for both folding and crystallization.

Sometimes a physical or chemical condition can serve multiple roles to increase the likelihood of obtaining crystallographic quality crystals, for example an ionic compound used to increase ionic strength to “salt out” the crystals by stabilization of the crystalline state relative to the destabilized solute polypeptide may comprise an ion such as Zn²⁺ that serves as a ligand stabilizing the polypeptide into a conformation having more structure. Urea, a chaotropic agent may be used to prevent aggregation and also be a ligand. Other ligands that are not surfactants or chaotropic agents may still reduce aggregation by reducing stochastic unfolding events. Or a surfactant may be used to reduce aggregation of proteins having exposed hydrophobic surface and also stabilize the native conformation of the protein. Indeed for non-ionic or zwitterionic surfactants, or ionic surfactants in the presence of a divalent ion having opposite charge to the surfactant ion, the promotion of crystallization or direct stabilization of the crystal function can be performed in addition to both the reduction of aggregation and stabilization of a native conformation in aqueous solutions.

Often a chemical or physical condition can play competing roles of increasing and decreasing likelihood of crystallization. For example, both high and low temperatures are appreciated by protein crystallographers to reduce non-specific aggregation, but those skilled in the art of protein chemistry in general will immediately appreciate that both high and low temperatures can increase denaturation, thereby tending to both increase aggregation to the extent stochastic unfolding is increased, and destabilizing native conformations.

Zinc finger DNA binding proteins have been crystallized and structured crystallographically to a high level of resolution in the presence of Zn²⁺ and appropriate sequence double stranded DNA, the crystals comprising protein/DNA co-crystals with the protein bound by the specific cognate DNA bound by the protein of interest (Klug et al.(1995) FASEB J. 9(8):597-604). As described by Klug et al. (1995) supra, the requirement of Zn²⁺ for DNA binding was first discovered fortuitously in an unusually abundant Xenopus transcription factor having a 30-residue, repeated sequence motif, when chelating agents removing Zn²⁺ and other divalent cations (EDTA) was observed to abolish DNA binding ability. Ultimately the hypothesis that the repeated sequence motif, which came to be called the zinc finger motif is conformed by a central zinc ion to form an independent minidomain and that adjacent zinc fingers are combined as modules to make up a DNA-binding domain was proven and the DNA sequences to which the Xenopus transcription factor bound were identified permitting crystallization of DNA complexed protein and solution of the crystallographic structure.

In addition to having different conformations that can be thought of as native conformations or structures stabilized by ligand binding interactions or solvent chemical or physical conditions, some of which are more and less disordered, the more disordered being difficult to crystallize, protein domains may be fully or partially denatured, even in the presence of a stabilizing ligand, by solvent conditions such as pH, chemical agents such as surfactants, and guanidine and urea, and physical conditions such as temperature. In proteins having catalytic activity, substrate is a ligand which stabilizes bound conformers, although substrate bound conformation is not the only native conformation. A denatured or non-native conformation of one or more of the protein's domains, including all degrees of partial denaturation is encompassed by the term non-native, albeit that the further the deviation of the structure from a native state of the protein is a more denatured protein. Partially denatured proteins or polypeptides will have at least one partially denatured domain and range to proteins having all domains fully denatured except for one partly denatured domain. In the context of an enzyme, the delineation between native and non-native structure may be practically established by inactivity in the presence of substrate. Other proteins including structural proteins may be difficult to classify as partly denatured or a native conformation that is disordered. As a practical matter the extremity of chemical conditions such as pH or guanidine concentration or physical conditions including temperature can be evaluated, as can be other information regarding the protein's structure in attempting to make a heuristic determination of whether the polypeptide is a native disordered protein or a denatured one. The preceding approach is complicated by cellular compartmentalization in eukaryotes, making conditions in some compartments, such as the low pH or acid conditions of the lysozyme, extreme relative to, for example, the neutral pH of the cytoplasm. The preceding illustrates that only the most extreme conditions, such as 6M guanidine, are presumptive of a non-native state. Further the existence of membrane proteins and proteins from thermophilic organisms which resist heat denaturation at temperatures which would irreversibly denature most proteins further complicates the distinction of non-native and native.

Because loss of function such as enzymatic activity in the presence of denaturing conditions is not always measurable, and because any polypeptide that does not have an ordered and hence crystallizable structure may become more ordered, all but the completely denatured and wholly disordered protein sequences devoid of any structure other than primary sequence should be treated as potentially crystallizable depending upon conditions and presence of one or more ligands. Ligand contemplates small inorganic or organic molecules, organic and inorganic ions, biopolymers, including oligo- and poly-peptides, oligo- and poly-nucleotides, peptidoglycans or mucopolysaccharides. Examples of inorganic ion ligands include divalent cations such as Mg²⁺ and Ca₂₊. Known examples of organic molecule ligands include steroids and retinoids, which complex to a protein of the Heat Shock Protein (HSP) class stabilizing a conformation capable of entering the nucleus and binding a specific recognized DNA sequence to regulate the expression of gene products and thus alter cellular physiologic settings.

Salts and other agents commonly present in solutions for biomacromolecule crystallizations in amounts considered insufficient to be termed precipitating agents include Calcium Chloride dihydrate, tri-Sodium Citrate dihydrate, Magnesium Sulfate hexahydrate, Ammonium Acetate, Ammonium Sulfate, Lithium Sulfate monohydrate, Magnesium Acetate tetrahydrate, Sodium Acetate trihydrate, mono-Potassium dihydrogen phosphate, Zinc Acetate dihydrate, Calcium Acetate hydrate Lithium Sulfate monohydrate, Sodium Chloride, Hexadecyltrimethylammonium Bromide, Cobaltous Chloride hexahydrate, Cadmium Chloride dihydrate, Potassium Sodium Tartrate tetrahydrate, Ferric Chloride hexahydrate, mono-Sodium dihydrogen phosphate, Cesium Chloride, Zinc Sulfate heptahydrate, Cadmium Sulfate hydrate, Nickel(II) Chloride hexahydrate, mono Ammonium dihydrogen Phosphate and dioxane. The concentrations commonly used are readily ascertainable. Often these agents are used as precipitants at much higher concentrations. Acoustic deposition permits dilution at the droplet, or addition of a precipitant concentration to a droplet to yield a trace level, simplifying combinatorial manipulations.

Buffers commonly used for biomacromolecule crystallizations include, in appropriate concentrations that will be evident or readily obtained by one of ordinary skill, Sodium Acetate trihydrate (pH 4.6), Tris Hydrochloride (pH 8.5), HEPES (pH 7.5), TRIS (pH 8.5), HEPES-Na (pH 7.5), Sodium Cacodylate (pH 6.5), tri-Sodium Citrate dihydrate (pH 5.6), Sodium Acetate trihydrate (pH 4.6), Imidazole (pH 6.5).

Precipitating agents commonly used for biomacromolecule crystallizations include, in various concentrations and combinations that will be evident or readily obtained by one of ordinary skill, 2-Methyl-2,4-pentanediol (MPD), Potassium Sodium Tartrate tetrahydrate, mono-Ammonium dihydrogen Phosphate, Ammonium Sulfate, Ammonium Formate, Sodium acetate, tri-Sodium Citrate dihydrate (pH 6.5), 2-Methyl-2,4-pentanediol, Polyethylene Glycol 400, Polyethylene Glycol 1000, Polyethylene Glycol 1500, Polyethylene Glycol 4000, Polyethylene Glycol 6000, Polyethylene Glycol 8000, Polyethylene Glycol 10,000, Polyethylene Glycol 20,000, Polyethylene Glycol Monomethyl Ether 2000, Polyethylene Glycol Monomethyl Ether 5000, Polyethylene Glycol Monomethyl Ether 550, Ethylene Imine Polymer, tert-Butanol, Jeffamine—600®, Sodium Acetate trihydrate, iso-Propanol, Ethanol, Imidazole (pH 7.0), 1,6 Hexanediol, Ethylene Glycol, anhydrous Glycerol, mono-Ammonium dihydrogen Phosphate, Lithium Sulfate monohydrate, 2-Methyl-2,4-pentanediol, Sodium Chloride, Sodium Formate, mono-Sodium dihydrogen phosphate, tri-Sodium Citrate dihydrate, Magnesium Formate, Magnesium Chloride hexahydrate, mono-Ammonium dihydrogen Phosphate and Dioxane. For the buffers pH is that of a 1.0 M stock (0.5 M for MES) prior to dilution with other reagent components, and typical concentration is 0.1 M. The pH may be adjusted with HCl or NaOH, as is common.

Surfactants include anionic, cationic, zwitterionic and non-ionic. Examples of surfactants include sodium dodecyl sulfate, sodium lauryl sulfate, glycerol and octyl glucoside. Non-ionic surfactants such as glycerol and octyl glucoside are typically used to stabilize exposed hydrophobic surface and solubilize proteins against precipitation. Chaotropic agents often used in protein chemistry include urea and guanidine.

Examples of combinations and concentrations of precipitants include: (i) 20% v/v iso-Propanol and 20% w/v Polyethylene Glycol 4000; (ii) 10% v/v iso-Propanol and 20% w/v Polyethylene Glycol 4000; (iii) 2% v/v Polyethylene Glycol 400 and 2.0 M Ammonium Sulfate; (iv) 10% w/v Polyethylene Glycol 8000, 8% v/v Ethylene Glycol; (v) 10% w/v Polyethylene Glycol 6000, 5% v/v MPD; (vi) 2% w/v Polyethylene Glycol 8000; (vii) 15% w/v Polyethylene Glycol 8000.

The ability to perform diluting and non-diluting addition of fluids for both the biomacromolecule, the crystallization reagents and known or putative ligands and the like will be readily evident. For example addition of water will dilute all moieties present in the droplet or reservoir in which experimental crystallization is being performed. Addition of the biomacromolecule in plain water, the biomacromolecule concentration for the added fluid being the same as the droplet biomacromolecule concentration will dilute all constituents of the droplet solution except the biomacromolecule. As mentioned above, because nucleation often requires higher protein or other biomacromolecule concentrations than are optimal for forming diffraction grade crystals, the in situ detection of nascent crystals offered by the instant invention may permit obtaining crystallographic grade crystals in the first generation experiment, which is often a screening experiment.

Screening is often done in an array format as described by Stura et al. Using common precipitants in a wide range of concentrations and pH values (1994) Acta Crystallogr. D50:448-55. A dilution method can often be used to reduce the number of array sites in a solubility screening array. McRee, Practical Protein Crystallography, supra, describes a dilution technique beginning with precipitated protein and diluting by adding water, potentially permitting microcrystals formed along with precipitate to nucleate larger crystals that grow from dissolving precipitant. Acoustic ejection of minute volumes permits slow dilution and may permit the initial solubility screening step to become a first generation crystallization experiment that yields crystallographic quality crystals.

There are many scattering and absorption mechanisms for acoustic waves that propagate through a suspension of particles in a fluid medium. These include thermal transport losses, viscous drag, acoustic scattering and acoustic loss within the particles themselves. These absorption mechanisms are well described in Allegra et al. (1972) Journal of the Acoustical Society of America, 51(5):1545-64, (1972). For the acoustic frequency ranges of present interest, the dominant loss mechanism is expected to be acoustic scattering. Thus, as a coherent acoustic wave propagates through a particle suspension in a fluid, the wave is scattered from the particles, and that scattered energy is measured as a loss by a coherent receiving transducer. The particles may be for example protein crystals, or salt crystals in a protein crystallization experiment. It will be shown below that the acoustic scattering is expected to be much more sensitive to the presence of the protein crystals, and hence is an promising method of measuring protein crystal concentration, even in the presence of other background particles such as salt crystals.

The acoustic attenuation coefficient ″ in a fluid suspension, due to scattering, is described by the well-known relation:

″=(½a), k⁴a⁴ (⅓[1−E/E′]²+[(D′−D)/(2D′+D)]²) (1)

where , denotes the volume fraction of particulate matter in the suspension, k is the acoustic wavenumber in the fluid (k=2B/8=2Bf/c, where 8 is the acoustic wavelength in the fluid, f is the acoustic frequency, and c the acoustic compressional velocity in the fluid), a is the radius of the particle, E and E′ are respectively the bulk moduli of the fluid and particle, and D and D′ the mass density of the fluid and particle, respectively. Note that the acoustic attenuation coefficient varies as k⁴ a⁴, which will be discussed in more detail later. Eq. (1) is valid for values of (ka)<0.5, and for reasonably dilute solutions, where multiple scattering events are negligible. For particles a few microns in size, this condition corresponds to an acoustic wavelength of λ˜10 μm in the fluid. With a typical fluid velocity of 1500 m/s, this in turn corresponds to an acoustic frequency of 150 MHz. Thus, the above relation may be expected to be valid for acoustic frequencies<150MHz, for particles several microns in size.

We now show that the acoustic scattering is expected to be much stronger for protein crystals than for salt-type crystals. The bulk modulus E′ and density D′ for a protein crystal are taken to be 4.5e07 N/m², and 0.6e03 kg/m³, respectively. The bulk modulus E′ and density D′ for a salt crystal are taken to be 1.e 11 N/m², and 2.2e03 kg/m³, respectively. The bulk modulus E and density D for a water-like fluid are taken to be 2.3e09 N/m², and 1e03 kg/m³, respectively. Inserting these values into Eq. (1), we obtain the following acoustic attenuation coefficients in the fluid:

Protein in water: ″=420, k⁴ a³ [m⁻¹]

Salt in water: ″=0.2, k⁴ a³ [m⁻¹]

It is clear therefore that the attenuation coefficient is about 2000 times larger for the protein suspension than for the suspension of salt crystals. Thus, for comparable volume concentrations, the acoustic attenuation will be dominated by scattering from the protein crystals. Note that this large difference in the scattering behaviour between the protein and salt crystals is due primarily to the difference in the bulk moduli of the two materials.

It may be noted in passing that the acoustic velocity in the protein crystals is (E′/D′)^{.5}=275 m/s, while the acoustic velocity in the salt is 6700 m/s. For dilute solutions, the acoustic velocity of the suspension will be altered from that of the pure fluid by an amount proportional to the volume concentration of the particles multiplied by the acoustic velocity of the particles. Thus, it would be expected that the presence of protein crystals would reduce the overall acoustic velocity of a fluid-protein suspension, while the velocity of a salt-fluid suspension would be increased by the presence of salt crystals. Hence acoustic velocity information, which would inherently be available from an attenuation measurement, would also provide information concerning the presence of protein and salt crystals.

Eq. (1) is valid for values of (ka)<0.5. For larger values of ka, the attenuation coefficient becomes less strongly dependent on the value of (ka), and for (ka)>>1, the attenuation coefficient is independent of acoustic frequency. Thus, there is a notable structure in the dependence of the attenuation coefficient ″ on (ka), which occurs at around (ka)˜1. It may be possible to use this structure to determine the size of the protein crystals in a suspension, for example by sweeping the acoustic frequency over a range of values corresponding to values of (ka) below and near unity. The attenuation measured over this frequency range would then have a characteristic dependence (for example, proportional to f⁴ at lower frequencies, and becoming less dependent on f as (ka) approached unity). Such an acoustic frequency sweep could be made within one tone burst pulse, commonly termed a chirped toneburst, and the received acoustic signal could then yield information concerning both the presence and size of the protein crystals in a fluid suspension. It is particularly useful that the condition ka˜1 occurs in water for acoustic frequencies of order˜100 MHz, for particles of micron dimension.

Acoustic detection is an especially important aspect of the instant invention pertaining to biomacromolecule crystallization using small volume acoustic deposition, because the acoustic transducer is employed in manipulating the solutions of biomacromolecules and reagents for crystallization. Thus acoustic in situ detection of a combinatorial array prepared by acoustic ejection of experimental crystallization conditions is feasible with the mere addition of acoustic sensors or data gathering means. Acoustic sensors need not be bulky. Furthermore data sampling can be almost instantaneously after ejection, facilitating, for example dilution experiments as dissolution of precipitate and growth of crystals can be readily effected immediately after each dilution step and then periodically thereafter, and the decision whether to dilute further may be made more quickly avoiding possible overdilution because unaided or traditional optical methods are unable to detect the initial subtle shift from precipitate to microcrystals. Otherwise such dilutions should probably be left for some time to determine whether crystals are growing at the expense of precipitate.

The advances in X-ray sources that permit crystal structure determination for increasingly small crystals permit in situ diffraction experiments in crystals in the small volume experimental format, including the dense array format. Instead of recording sufficient data to solve the structure, such experiments can be designed to scan the sites having small volume crystallization condition experiments where biomacromolecule crystals have formed, as determined by acoustic methods, and determine whether the diffraction quality would yield high resolution crystallographic structures if enough points could be taken, which still depends upon a minimum crystal size, which is also acoustically ascertainable. An integrated system employing acoustic fluid droplet manipulation, in situ acoustic detection of biomacromolecule crystals, and in situ assessment of crystal quality is feasible. Scanning diffractiometry can also be utilized for in situ determination of crystal quality. In some cases after determination of crystal quality, dilution methods may be employed to attempt in situ re-crystallization to form higher quality or larger crystals. Methods that control vapor diffusion may be employed to slow crystal growth, including the microbatch methods which cover the experimental droplet with oil and the vapor diffusion control method of capping the reservoir with oil. These methods have been described above and some are described in more detail in the examples that follow.

One of ordinary skill will appreciate that other aspects of protein crystal production are encompassed by the invention although not described in detail. For example, protein crystals having heavy metal substituents, termed isomorphous replacement, are generated by trial and error with precious crystals, and acoustic deposition permits combinatorial experimentation with heavy metal solutions and crystalline fragments. A convenient way to test for heavy metal replacement would be to employ arrays of metals and alloys described herein. Determining ligands may also be accomplished by array methods facilitated by acoustic deposition, including metal as well as biomolecular arrays. (Insulin was only crystallizable when stored in a galvanized bucket, and the requirement of divalent zinc cation as a structuring ligand was later established). Mounting in capillary tubes and manipulation of crystals stored under liquid nitrogen is also facilitated as is experimentation with cryoprotectants used for cold storage protection of proteins, but sometimes reducing crystal quality. Determining conditions favoring non-specific aggregation combinatorially is also facilitated by acoustic deposition methods. Because of the reduced time scale for picovolume experiments, a wider variety of temperatures may be employed for crystallization experiments with less concern for acceleration of thermal or microbial degradation depending upon the temperature. Sodium azide NaN₃ is often employed to inhibit microbe growth and has been shown to reduce crystal quality, and a decrease in time required to complete experiments (to less than the typical generation time of microbes) engenders the expectation that its us can be decrease. Finally the likelihood exists that acoustic energy may be employed to non-destructively crush small crystals for seed.

It is to be understood that while the invention has been described in conjunction with the preferred specific embodiments thereof, the foregoing description is intended to illustrate and not limit the scope of the invention. Other aspects, advantages and modifications will be apparent to those skilled in the art to which the invention pertains.

All patents, patent applications, journal articles and other references cited herein are incorporated by reference in their entireties.

The following examples are put forth so as to provide those of ordinary skill in the art with a complete disclosure and description of how to implement the invention, and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. and pressure is at or near atmospheric.

### EXAMPLE 1

Microporous glass, preferably controlled pore size glass (CPG), is sintered onto the surface of a glass plate by routine methods such as heating to form a glass plate having a single patch of microporous glass sintered onto its surface at a depth sufficient to make the sintered surface permeable both to the downward flow and to the lateral wicking of fluids, a depth for CPG of greater than about 10 μm is adequate.

The CPG is applied to the glass surface at a thickness of about 20 μm and the glass with powdered CPG resident thereon is heated at 750° C. for about 20 minutes then cooled. Commercially available microscope slides (BDH Super Premium 76×26×1 mm) are used as supports. Depending on the specific glass substrate and CPG material used the sintering temperature and time may be adjusted to obtain a permeable and porous layer that is adequately attached to the glass beneath while substantially maintaining the permeability to fluids and thickness of the microporous glass layer. The slides heated for 20 minutes with a 1 cm square patch of microporous glass applied at a pre-heating thickness of about 20 μm yield a sintered layer of substantially the same depth as pre-heating, namely 20 μm.

The microporous glass layer is derivatized with a long aliphatic linker that can withstand conditions required to deprotect the aromatic heterocyclic bases, i.e. 30% NH₃ at 55° C. for 10 hours. The linker, which bears a hydroxyl moiety, the starting point for the sequential formation of the oligonucleotide from nucleotide precursors, is synthesized in two steps. First, the sintered microporous glass layer is treated with a 25% solution of 3-glycidoxypropyltriethoxysilane in xylene containing several drops of Hunig's base as a catalyst in a staining jar fitted with a drying tube, for 20 hours at 90° C. The slides are then washed with MeOH, Et₂O and air dried. Neat hexaethylene glycol and a trace amount of concentrated H₂SO₄ acid are then added and the mixture is kept at 80° C. for 20 hours. The slides are washed with MeOH, Et₂O, air dried and stored desiccated at −20° C. until use. (Preparative technique generally described in British Patent Application 8822228.6 filed Sep. 21, 1988.) Focused acoustic ejection of about 0.24 picoliter (pL) of anhydrous acetonitrile (the primary coupling solvent) containing a fluorescent marker onto the microporous substrate is then shown to obtain a circular patch of about 5.6 μm diameter on the permeable sintered microporous glass substrate. The amount of acoustic energy applied at the fluid surface may be adjusted to ensure an appropriate diameter of chemical synthesis for the desired site density. 5.6 μm diameter circular patches are suitable for preparing an array having a site density of 10⁶ sites/cm² with the circular synthetic patches spaced 10 μm apart center to center, and the synthetic patches therefore spaced edge to edge at least 4 μm apart at the region of closest proximity. All subsequent spatially directed acoustically ejected volumes in this example are of about 0.24 pL; it will be readily appreciated that the ejection volumes can be adjusted for solutions other than pure acetonitrile by adjusting the acoustic energy as necessary for delivery of an appropriately sized droplet after spreading on the substrate (here about a 5 μm radius).

The oligonucleotide synthesis cycle is performed using a coupling solution prepared by mixing equal volumes of 0.5 M tetrazole in anhydrous acetonitrile with a 0.2 M solution of the required β-cyanoethylphosphoramidite, e.g. A-β-cyanoethyl-phosphoramidite, C-β-cyanoethylphosphoramidite, G-β-cyanoethylphosphoramidite, T(or U)-β-cyanoethylphosphoramidite. Coupling time is three minutes. Oxidation with a 0.1M solution of I₂ in THF/pyridine/H₂O yields a stable phosphotriester bond. Detritylation of the 5′ end with 3% trichloroacetic acid (TCA) in dichloromethane allows further extension of the oligonucleotide chain. No capping step is required because the excess of phosphoramidites used over reactive sites on the substrate is large enough to drive coupling to completion. After coupling the slide the subsequent chemical reactions (oxidation with 12, and detritylation by TCA) are performed by dipping the slide into staining jars. Alternatively the focused acoustic delivery of I₂ in THF/pyridine/H₂O and/or 3% TCA in dichloromethane to effect the oxidation and tritylation steps only at selected sites may be performed if sufficient time transpires to permit evaporation of substantially all the solvent from the previous step so that the synthetic patch edges do not move outwards and closer to the neighboring synthetic patches, and further to provide an anhydrous environment for subsequent coupling steps if I₂ in THF/pyridine/H₂O is delivered within the reaction chamber.

After the synthesis is complete, the oligonucleotide is deprotected in 30% NH₃ for 10 hours at 55° C. Because the coupling reagents are moisture-sensitive, and the coupling step must be performed under anhydrous conditions in a sealed chamber or container. This may be accomplished by performing the acoustic spotting in a chamber of desiccated gas obtained by evacuating a chamber that contains the acoustic ejection device and synthetic substrate and replacing the evacuated atmospheric gas with desiccated N₂ by routine methods; washing steps may be performed in the chamber or by removing the slide and washing it in an appropriate environment, for example, by a staining jar fitted with a drying tube. Because washing and other steps such as detritylation may be more conveniently carried out outside the chamber, the synthesis may also be performed in a controlled humidity room that contains the controlled atmosphere chamber in which the spotting is done, with the other steps carried out in the room outside the chamber. Alternatively, a controlled humidity room may be used for spotting with other steps carried out in less controlled environment by use of, for example, a staining jar fitted with a drying tube.

### EXAMPLE 2

Combinatorial solid phase synthesis of all possible four amino acid oligopeptide sequences that can be made from the 20 naturally occurring amino acids (20⁴ or =1.6×10⁵ amino acid sequences in all) in a quadruplicate array format is demonstrated. The four identical copies of the combinatorial array are contained in a 1 cm ×1 cm area nominally divided into four quadrants, each quadrant containing 2.5×10⁵10 μm ×10 μm synthetic sites arrayed in 500 rows and 500 columns. Only 400 rows and columns are used in each quadrant; the first and last 50 rows and columns are not used for synthesis, and function to space the four identical arrays from each other and the edges of the area, although alternative arrangement of the four identical arrays can obtain greater distance between arrays by moving each array closer to the corners of the square area. In addition to systematically generating the combinatorial sequences, deposition of the monomers employs a systematic method of ensuring that similar amino acid sequences are less likely to be spatially close. Although many such methods exist, with some requiring sophisticated computation, and can take into account side chain similarities in addition to identity, e.g. hydrophobic Val, Leu, Ile the scheme used relies on a basic sequential list of amino acids which is phase shifted as the row number increases. For example the 20 natural amino acids can be listed sequentially based on the alphabetic order of their single letter abbreviations, in which case: Ala (A) is “1”; Cys (C) is “2”; Asp (D) is 3; . . . Val (V) is “19”; and Trp (W) is “20”.

For the first monomer deposited, in the first row in a given quadrant in which a peptide is synthesized, which is the 51^{st} nominal row in that quadrant, beginning with the first synthetic column (51^{st} nominal column) amino acids (as activated for the synthesis described in more detail below) are deposited as the basic sequential list from 1 to 20 in alphabetical order of the one letter abbreviations. Beginning with the second synthetic row (52^{nd} nominal row), the order is shifted by one position starting at “2” and returning to “1” after “20” (2, 3, 4, 5 . . . 19, 20, 1); thus for the quadruplicate spaced array arrangement being made, in the ₅₂nd nominal row (second synthetic row) of a given quadrant, the first amino acid deposited in the 51^{st} and 431^{st} nominal column of the 52^{nd} nominal row is “2” or Cys, and the amino acids deposited in the 68^{th} and 448^{th}, 69^{th} and 449^{th}, and 70^{th} and 450^{th} nominal columns of this row are 19, 20 and I respectively (V, W, A).

Additional monomers are added in the quadrants as follows, although numerous alternatives exist. For the second monomer in the first synthetic row (51^{st} nominal row) the monomer deposition order for the second monomer is the same as for the first monomer in the first 20 synthetic columns (nominal 51-70) of this row, and the order is shifted by one for each successive group of 20 synthetic columns, thus the order is 2, 3 . . . 19, 20, 1 for nominal columns 71-90 (hereinafter denoted [71-90]-{2, 3. . . 19, 20,1}) and according to this notation: [91-10]-{3,4 . . . 20, 1, 2}; [111-130]-{4, 5 . . . 1, 2 , 3}. . . [431-450]-{20, 1 . . . 17, 18, 19}. For the second and third monomers in the second synthetic row (52^{nd} nominal row) the monomer deposition order is shifted by one relative to the order for the underlying monomer in the first 20 synthetic columns (nominal 51-70) of this row, and the order is shifted by one for each successive group of 20 synthetic columns, thus for the second monomer the order is 3, 4. . . 20, 1, 2 for nominal columns 51-70 and: [71-90]-{4, 5 . . . 1, 2, 3[91-110]-{5,6 . . . 2, 3, 4;}[111-130]-6, 7 . . . 3, 4, 5}. . . [431-450]-{2, 3 . . . 19, 20, 1). Note that for the second monomer of the second synthetic row, the shift relative to the order of the first monomer in the first monomer in the first 20 columns of the first row ({1, 2 . . . 18, 19, 20}), is 2 because one is the shift between subsequent monomers (1^{st}→2^{nd}; 2^{nd}→3^{rd}) and the first monomer of the second synthetic row is shifted by one relative to the first monomer of the first synthetic row. For the second and third monomers in the third synthetic row (53^{rd} nominal row) the monomer deposition order is shifted by two relative to the order for the underlying monomer in the first 20 synthetic columns (nominal 51-70) of this row, and the order is shifted by one for each successive group of 20 synthetic columns, thus the order for the second monomer is 5 . . . 20, 1, 2, 3, 4 for nominal columns 51-70 and: [71-90]-{6 . . . 1, 2, 3, 4,5 }, [91-110]-{7,. . . 2, 3, 4, 5, 6[111-130]-{8,. . . 4, 5, 6 6, 7 . . . [431-450]-{4, . . . 19, 20, 1, 2,3 3}. For the second monomer in the Nth synthetic row (nominal row =50+N) the monomer deposition order for the second monomer is shifted by (N−1) relative to the order for the first monomer in the first 20 synthetic columns (nominal 51-70) of this row, and the order is shifted by one for each successive group of 20 synthetic columns, thus (for (k*N+a)>20, (k*N+a) is shifted as beginning with N+a −20*I, where I is the integer dividend of the quotient of (k*N+a) and 20, representing number of cycles with each integral multiple of 20 representing unshifted) the order for the second monomer is (2*N −1), 2*N . . . (2*N −3), (2*N −2) for nominal columns 51-70 and: [71−90]-{(2*N . . . (2*N−2), (2*N−1)}, [91-110]-}(2*N+1), (2*N+2) . . . (2*N−1), (2*N}, [111-130]-{(2*N+2), (2*N+3) . . . 2*N, (2*N+1)}. . . [→1-450]-{(2*N−2), (2*N−1) . . . (2*N −4), (2*N −3)}. Thus for the second monomer in the 400^{th} synthetic row (450^{th} nominal row) the monomer deposition order for the second monomer begins with 19 (799-780) is circularly shifted by 18 relative to the order for the first monomer in the first 20 synthetic columns (nominal 51-70) of the first row, and the order is shifted by one for each successive group of 20 synthetic columns, thus the order is 19, 20 . . . (17), (18) for nominal columns 51-70 and: [71-90]-{20, 1 . . . 17, 18, 19}, [91-110]-{1, 2 . . . 18, 19, 20}, [111-130]-{2, 3 . . . 19, 20, 1}. . . [431-450]-{20, 1 . . . 17, 18, 19}. Note that for the second monomer of the Nth synthetic row, the shift relative to the order of the first monomer in the in the first 20 synthetic columns of the first row ({1, 2 . . . 18, 19, 20}), is 2*(N−1) because (N−1) is the shift between subsequent monomers (1^{st}→2^{nd}; 2^{nd}→3^{rd}) and the first monomer of a synthetic row N is shifted by (N−1) relative to the first monomer of the first synthetic row.

The synthetic chemical steps are modified from known solid phase synthetic techniques (as described, for example, in Geysen et al., International Patent Application PCT/AU84/00039, now WO 84/83564) that are adapted from the pioneering solid phase peptide synthesis of Merrifield et al. ((1965) Nature 207:(996):522-23; (1965) Science 150(693)178-85; (1966) Anal. Chem. 38(13):1905-14; (1967) Recent. Prog. Horm. Res. 23:451-82). The conventional methods of solid phase peptide synthesis as taught in these seminal papers are described in detail in Ericksen, B. W. and Merrifield, R. B. (1973) The Proteins 2:255-57 Academic Press, New York, and Meinhofer, J. (1976) The Proteins 2:45-267 Academic Press, New York. Briefly, all these methods add amino acid monomers protected by tert-butoxycarbonyl (t-butoxycarbonyl, t-Boc) at their amino groups, including their alpha amino groups (N^{α}) to a nascent peptide that is attached to the substrate at the carboxy-terminal (C-terminal). The carbonyl moiety of the N^{α}-t-Boc amino acid to be added to the peptide is activated to convert the hydroxyl group of the carboxylic moiety into an effective leaving group, resembling an acid anhydride in reactivity, using dicyclohexylcarbodiimide (DCC) to permit nucleophilic displacement by the terminal N of the nascent peptide to form a peptide bond that adds the monomer to the forming peptide. The newly added monomer has an N-terminus protected from further reaction by t-Boc, which is removed with trifluoroacetic acid (TFA), rendering the terminal amino group protonated, followed by deprotonation of the terminal amino group with triethylamine (TEA) to yield the reactive free amino group suitable for addition of another monomer.

The substrate employed is polyethylene, although the classic substrate for solid phase peptide synthesis, divinylbenzene cross-linked polystyrene chloromethylated by Friedel-Crafts reaction of the polystyrene resin on approximately one in four aromatic rings, could also be employed. Preparation of the polyethylene substrate, described in Geysen et al., International Patent Application PCT/AU84/00039, now WO 84/83564, involves γ-ray irradiation (1 mrad dose) of polyethylene immersed in aqueous acrylic acid (6% v/v) to yield reactive polyethylene polyacrylic acid (PPA), according to the method of Muller-Schulte et al. (1982) Polymer Bulletin 7:77-81. N^{α}-t-Boc-Lysine methyl ester is then coupled to the PPA by the Lysine e-amino side chain. After deprotection of the N^{α} by removal of the t-Boc with TFA followed by TEA, DCC/N^{α}-t-Boc-Alanine is added to couple t-Boc-Ala to the N^{α} of the Lys, thereby forming a peptide like N^{α}-t-Boc-Ala-Lys-ε-N-PPA linker to which the DCC activated N^{α}-t-Boc-amino acid monomers can be sequentially added to form the desired polymers upon deprotection of the N^{α} group of the N^{α}-t-Boc-Ala.

The polyethylene substrate can be commercially available smooth polyethylene sheet material, of various thicknesses. Polyethylene beads may be adhered to a surface in a manner which allows them to be separated from the surface by use of low molecular weight (MW) polyethylene as an adhesive. Appropriately sized polyethylene beads, activated, e.g. by γ-irradiation in the presence of acrylic acid to form PPA, may be applied to a smooth polyethylene surface or a glass, or other surface coated with low MW polyethylene, or the adhesion step can be performed prior to activation.

For an array format, and to increase the effective surface area for polymer formation and enhance adhesion of acoustically ejected reagent droplets to the synthetic substrate, polyethylene fiber sheet material, approximate thickness 25 μm, available commercially and prepared by conventional methods is heat or fusion bonded according to routine methods to a smooth polyethylene backing approximately 0.15 cm thick to form a polyethylene fiber coated rough permeable substrate. The fiber coated sheet s cut into strips having the approximate dimensions of a commercial slide, and γ-irradiated (1 mrad) in 6% v/v aqueous acrylic acid to form the PPA activated substrate. The substrate must be adequately dried because the t-Boc protected and DCC activated reagents are water sensitive, and water contamination of acids applied to the synthetic sites, such as TFA application can hydrolyze the peptide bond. Thus anhydrous synthetic conditions are required throughout. Conventional drying of the substrate is effected with warm dry air at atmospheric or subatmospheric pressure by routine methods, specifically, the slides are washed with MeOH, Et₂O, air dried and stored desiccated at −20° C. until use.

The sequential combinatorial addition of monomers is performed as described above with all sites spotted with the appropriate DCC/N^{α}-t-Boc-amino acid. The appropriate volume for acoustic ejection is as above. This yields a quasi-parallel synthesis because the spotting of different sites is not simultaneous, but the can be modified to synthesize the desired peptides only at some sites and synthesize at other sites later. The actual synthesis requires anhydrous organic solvent washing steps to remove unreacted activated amino acids or TFA or TEA, for a total of 11 steps per monomer addition. Thus a completely sequential synthesis would increase the number of steps performed for synthesizing an array drastically, but, for example synthesizing only at every other site in a first synthetic round and then synthesizing in a second session would improve array quality and only double the number of steps. To ensure that peptides are only formed at the chosen sites, the N^{α}-t-Boc-Ala-Lys-ε-N-PPA linker can be selectively deprotected to expose the N^{α} of Ala only at chosen sites, by selective acoustic energy directed ejection of TFA onto the desired sites, followed by washing and selective application of TEA, followed by washing to effect, for example, selective deprotection of every other site.

The basic quasi-parallel combinatorial synthesis of all tetra-peptides that can be made from the naturally occurring amino acids may be performed in 44 steps excluding substrate preparation. As no selective linker deprotection is required, the substrate is immersed in TFA in a staining jar fitted with a drying tube, then washed, and inmmersed in TEA, and washed again, all under anhydrous conditions. The synthesis must be carried so that ejection of the fluid droplets occurs in a controlled atmosphere which is at minimum dry, and inert to the reagents used. This is may be obtained by performing the acoustic spotting in a chamber of desiccated gas obtained by evacuating a chamber that contains the acoustic ejection device and synthetic substrate and replacing the evacuated atmospheric gas with desiccated N₂ by routine methods; washing steps may be performed in the chamber or by removing the slide and washing it in an appropriate environment, for example, by a staining jar fitted with a drying tube. Because washing and other steps such as detritylation may be more conveniently carried out outside the chamber, the synthesis may also be performed in a controlled humidity room that contains the controlled atmosphere chamber in which the spotting is done, with the other steps carried out in the room outside the chamber. Alternatively, a controlled humidity room may be used for spotting with other steps carried out in less controlled environment by use of, for example, a staining jar fitted with a drying tube.

Use of pre-synthesized short oligopeptides can also be used in lieu of amino acid monomers. Since focused acoustic ejection enables the rapid transition from the ejection of one fluid to another, many oligopeptides can be provided in small volumes on a single substrate (such as a microtiter plate) to enable faster assembly of amino acid chains. For example, all possible peptide dimers may be synthesized and stored in a well plate of over 400 wells. Construction of the tetramers can than be accomplished by deposition of only two dimers per site and a single linking step. Extending this further, a well plate with at least 8000 wells can be used to construct peptides with trimers.

### EXAMPLE 3

Combinatorial methods of the preceding Examples 1 and 2 can be adapted to form combinatorial arrays of polysaccharides according to the instant invention. In oligosaccharides, the monosaccharide groups are normally linked via oxy-ether linkages. Polysaccharide ether linkages are difficult to construct chemically because linking methods are specific for each sugar employed. The ether oxygen linking group is also susceptible to hydrolysis by non-enzymatic chemical hydrolysis. Thus, there are no known methods of automated syntheses for ether linked carbohydrates, and conventional methods of making combinatorial arrays are not sufficiently flexible to permit combinatorial arrays of polysaccharides. The flexibility of acoustic spotting can be adapted to form oxy-ether linkage based combinatorial arrays by analogy to the alternative method of selective deblocking that may be employed for making the arrays of Examples 1 and 2. That is, the specific chemical methods for forming the linkage between any pair of sugars may be conveniently selected so that a different solution is ejected for adding a glucose to a specific terminal sugar of the forming polysaccharide, such as fructose, than is ejected for adding glucose to a different terminal sugar, such as ribose, without increasing the number of steps involved as would be the case with photolithographic synthesis, and might be the case with parallel printing of multiple reagents through conventional multi nozzle ink-jet type printers. The resulting polysaccharides remain susceptible to hydrolysis.

Polysaccharides may be synthesized in solution rather than the solid phase, as can the biomolecules made in the preceding examples, and the acoustic ejection of droplets can effect the solution syntheses of arrayed polysaccharides at high density on a substrate without any attachment during polymer formation by selective application of deblocking reagents to different sites. In situ solid phase synthesis is more readily adaptable to automation of even oxy-ether linkage based polysaccharides because at least the deblocking steps may be done simultaneously for all sites, although the susceptibility of the different linkages to hydrolysis may affect overall yield for different monomer sequences differently. Recently, methods of replacing the oxy-ether with a thio-ether linkage (U.S. Pat. Nos. 5,780,603 and 5,965,719) and with an amide linkage with the N atom linked to the anomeric C of the sugar (U.S. Pat. No. 5,756,712) have been introduced. The solid phase synthetic methods of the thioether linkage methods may be directly adapted to form high density combinatorial arrays in an analogous manner as techniques for the Merrifield peptide synthesis. Similarly, the amide linkage based polysaccharides may be adapted for solid phase high density array formation by employing, for example the thioether based substrate linkage taught in U.S. Pat. Nos. 5,780,603 and 5,965,719, or an amide linkage to an appropriate moiety functionalized surface by analogy to the linkage of U.S. Pat. No. 5,756,712.

Only the thio-ether based substrate linkage will be exemplified in detail, and this linkage will be used to make thioether (amide based oligosaccharides may be made analogously by reference to U.S. Pat. No. 5,756,712 with a thio-ether, or other, substrate linkage) based combinatorial array of oligosaccharides. The classic substrate for solid phase peptide synthesis, divinylbenzene cross-linked polystyrene chloromethylated by Friedel-Crafts reaction of the polystyrene resin on approximately one in four aromatic rings is employed, although a polyethylene substrate may be substituted.

Spun polystyrene sheet made by conventional methods or obtained commercially is heat or fusion bonded to a polystyrene backing to yield a porous permeable layer of spun polystyrene of approximately 25 μm thickness. The appropriate extent of cross linking and chloro-methylation is effected by conventional chemical synthetic methods as required. The thickness of the permeable layer will be appreciated to affect the dimensions of the area of actual chemical synthesis, as more vertical wicking room will result in less lateral spread of the acoustically deposited reagents. It also will be appreciated that the extent of crosslinking may be adjusted to control the degree of swelling, and softening upon application of organic solvents, and that the fibrous nature of the porous, permeable layer of spun polystyrene provides relatively more synthetic surface per nominal surface area of the substrate than provided by beads, thus less swelling is required to expand synthetic area to polymer sites inside the fibers. The substrate is aminated by conventional chemical synthetic methods, washed and stored desiccated at −20° C. until use.

The linking of a sugar to this substrate is first effected. Succinic anhydride (1.2 equivalents) is added to a solution of 1,2:3,4-di-O-isopropylidene-D-galactopyranose (1 equivalent) in pyridine at room temperature. The reaction is stirred overnight then concentrated in vacuo to yield 1,2:3,4-di-O-isopropylidene-6-O-(3-carboxy)propan-oyl -D-galactopyranose. 80% aqueous acetic acid is added to the residue to remove the isopropylidene groups. When this reaction is complete, the reaction mixture is concentrated in vacuo. Excess 1:1 acetic anhydride/pyridine is then added to the residue to form 1,2,3,4-O-acetyl-6-O-(3-carboxy)propanoyl-D-galactopyranose, to which excess thiolacetic acid in dry dichloromethane under argon at 0° C. and BF₃ etherate is then added. The cold-bath is removed after 10 minutes. After 24 h the mixture is diluted with dichloromethane, washed with saturated sodium bicarbonate, dried over sodium sulfate, and concentrated to yield 1-S-acetyl-2,3,4-tri-O-acetyl-6-O-(3-carboxy)propanoyl-1-thio-α-D-galactopyranose. The aminated polystyrene (Merrifield resin) substrate is contacted with the 1-S-acetyl-2,3,4-tri-O-acetyl-6-O-(3-carboxy)propanoyl-1-thio-α-D-galctopyranose and a carbodiimide coupling reagent to afford the O,S-protected galactopyranose coupled to the substrate through the 6-O-(3-carboxy)propanoyl group.

The preceding substrate is used for combinatorial synthesis of thio-ether linked polysaccharides based on thiogalactose derivatives. Nine copies of the combinatorial array of all possible trimers of four monomeric 1-thiogalactose derivatives (4³=64 in all) are synthesized on a total substrate surface area of 1 cm² divided into square synthetic sites 333 μm×333 μm, corresponding to a site density of 1000 sites/cm². This arrangement permits a 3 site or 999 μm spacing between each copy of the array in each axis of the array plane. A 25 pL droplet of fluorescent solvent deposited on the described porous permeable spun polystyrene on polystyrene substrate yields a spot of about 56 μm diameter, and a 100 pL droplet yields a spot of about 112 μm diameter (cylindrical shaped spot wicked into depth of porous substrate with about ½ of porous layer occupied by solid polystyrene and little swelling thereof).

Step A—Synthesis of 1-Dithioethyl-2,3,4,6-tetra-0-acetyl-galactopyranoside:1-Thio-2,3,4,6-tetra-O-acetyl-galactopyranoside (500 mg, 1.37 mmol) and diethyl-N-ethyl-sulfenylhydrazodicarboxylate (360 mg, 2.0 mmol) (prepared by known methods as described by Mukaiyama et al. (1968) Tetrahedron Letters 56:5907-8) are dissolved in dichloromethane (14 mL) and stirred at room temperature. After 10 min, the solution is concentrated and column chromatography (SiO₂, hexane/ethylacetate 2:1) yields 1-dithioethyl-2,3,4,6-tetra-O-acetyl-galactopyranoside (580 mg, quant) as a white solid (R_{f} 0.27 in hexanes/ethyl acetate (2:1)).¹H-NMR (360 MHZ, CHCl₃): .δ1.30 (dd, 3H, J=7.4 Hz, CH₃), 1.96, 2.02, 2.03, 2.13 (4 s, 12H, 4CH₃CO), 2.79 (ddd, 2H, J=7.4 Hz, J=7.4 Hz, J=1.3 Hz, CH₂), 3.94 (ddd, 1H, J₄, 5=1.0 Hz, J₅, 6a=6.6 Hz, J₅, 6b=7.6 Hz, 5-H), 4.10 ddd, 2H, 61-H, 6b-H), 4.51 (d, 1H, J₁, 2=10.0 Hz, 1-H), 5.05 (dd, 1H, J₂, 3=10.0 Hz, J₃, 4=3.3 Hz, 3-H)), 5.38 (dd, 1H, J₁, 2=10.0 Hz, J₃, 3=10.0 Hz, 2-H), 5.40 (dd, 1H, J₃,4=3.3 Hz, J₄, 5=1.0 Hz, 4-H); m/z calculated for C₁₆ H₂₄ O₉ S₂ (M+Na) 447.1, found 447.0.

Step B—Synthesis of 1-Dithioethyl-β-D-galactopyranoside:1-Dithioethyl-2,3,4,6-tetra-O-acetyl-galactopyranoside from Step A (500 mg, 1.18 mmol) is dissolved in dry methanol (10 mL) and treated with methanolic sodium methoxide (1 M, 150 μL). After 2 h, the solution is neutralized with Amberlite 1R-120 (H⁺) resin, filtered and concentrated to give 1-dithioethyl-6-β-D-galactopyranoside as a white solid (300 mg, quant).

Step C—Coupling of 1-Dithioethyl-β-D-galactopyranoside to the Substrate: 1-Dithioethyl-6-β-D-galactopyranoside (200 mg, 780 μmol) is dissolved in dry pyridine (8 mL), and DMAP (5 mg) is added to the mixture, which is maintained at 60° C. throughout.

Of the total (9×64-576) sites used to form the 9 duplicate arrays, and in each duplicate array of 64 sites of actual synthesis, ¼ (16 per array, 144 total) of the array sites are patterned with the 1-Dithioethyl-6-β-D-galactopyranoside/DMAP. in dry pyridine. This solution is acoustically ejected onto the substrate at the desired locations. Dry controlled atmospheric conditions, namely a dry inert gas environment, are also used for this oligosaccharide synthesis. The appropriate volume deposited at each site is determined by test deposition at some of the array sites, taking into consideration that the synthetic area should be wholly contained in the synthetic site, and too much dead space is preferably avoided. About 10 to 100 pL droplet volumes are found to be appropriate, and 100 pL is spotted onto the sites where the first monomer is desired to be 1-Dithioethyl-6-β-D-galactopyranoside. The substrate is as described, spun polystyrene resin on a polystyrene backing (trityl chloride-resin, loading 0.95 mmol/g of active chlorine, polymer matrix: copolystyrene-1% DVB) is heated for 24 h at 60° C. The resin is filtered off, and washed successively with methanol, tetrahydrofuran, dichloro-methane and diethyl ether (10 mL each) to afford 1-Dithioethyl-6-β-D-galactopyranoside covalently linked to the trityl resin through the hydroxyl group in the 6-position at the desired sites.

Step D—Patterning Additional 1-Dithioethyl-6-pyranosides: It will be readily appreciated that this step can be practiced with other 1-Dithioethyl-6-pyranosides as desired to be linked to the substrate. ¼ of the sites of each of the duplicate arrays are spotted with a solution for linking 1-Dithioethyl-6-β-D-glucopyranoside in about the same volume as deposited in Step C, ¼ are spotted to yield the 1-Dithioethyl-6-β-D-mannopyranoside, and the remaining ¼ are spotted to yield the 1-Dithioethyl-6-β-D-allopyranoside.

Step E—Generation of the Free Thiol on the Substrate: The substrate sites from Step C spotted with dry tetrahydrofuran (THF) in the area of 1-dithioethyl-6-pyranoside deposition (about 4 pL per pL deposited in Step C). Dry methanol (about ¾ pL per pL deposited in Step C), dithiothreitol (about 185 picograms) and triethylamine (about ½ pL per pL deposited in Step ) are deposited at desired synthetic areas of the combinatorial sites by acoustic deposition and the sites are allowed to react under the specified controlled atmosphere conditions for about 10 minutes to an hour at room temperature. The entire substrate is washed by immersion in an adequate volume, successively, of methanol, tetrahydrofuran, dichloromethane and diethyl ether. Micro-FTIR (of substrate deposition sites): 2565 cm⁻¹ (SH stretch). Alternatively, if selective generation of the free thiol is not desired, the substrate may be treated on the whole of the surface as follows: 8 ml dry THF is applied to the surface of the substrate which is placed in a shallow container just large enough to contain the substrate, 1.2 ml dry ethanol, 256 mg dithioreitol, and 0.8 ml triethylamine are added to the THF and the container is shaken for about 10 hours at room temperature under the described conditions.

Step F—Michael Addition Reaction: The substrate from Step E is again placed in the shallow container of Step E and swollen in dry N,N-dimethylformamide (4 mL) and then cyclohept-2-en-1-one (280 μl, 252 μmol) is added and the container is shaken at room temperature. After 2 hours, the liquid is removed and the substrate is washed successively with methanol, tetrahydrofuran, dichloromethane and diethyl ether (40 mL each). Alternatively if selective Michael addition is desired, the desired sites may be selectively spotted in the area of synthesis: N,N-dimethylformamide (about 2.5 pL per pL deposited in Step C); cyclohept-2-en-1-one (about 0.2 pL, 0.2 picomole per pL deposited in Step C). The selectively spotted sites are allowed to react under the specified controlled atmosphere conditions for about 10 minutes to an hour at room temperature prior to the specified washing steps.

Step G—Reductive Amination with an Amino Acid: The substrate from Step F is again placed in the shallow container of preceding steps and swollen in dichloromethane (4 mL). Glycine tert-butyl ester hydrochloride (150 mg, 1,788 μmol), sodium sulfate (400 mg), sodium triacetoxyborohydride (252 mg, 1188 μmol) and acetic acid (40 μL) are added at room temperature under argon atmosphere and the container shaken for 24 hours. The liquid is removed and the substrate is washed successively with washed successively with water, methanol, tetrahydrofuran and dichloromethane.

Additional monomers may be added by repetition of the preceding steps with the desired 1-Dithioethyl-6-pyranosides. It will be readily appreciated that this step can be practiced with 1-Dithioethyl-6-β-D-galactopyranoside/DMAP and the other 1-Dithioethyl-6-pyranoside/DMAP desired for linking to the substrate. The desired sites of each of the duplicate arrays are selectively spotted with the appropriate 1-Dithioethyl-6-pyranoside/DMAP solution for linking in about the same volume as deposited in Step C (1-Dithioethyl-6-β-D-mannopyranoside/DMAP, 1-Dithioethyl-6-β-D-allopyranoside/ DMAP, and 1-Dithioethyl-6-β-D-glucopyranoside/DMAP).

### EXAMPLE 4

Combinatorial arrays of alloys can readily be prepared using the methodology of the invention. Molten metals are acoustically ejected onto array sites on a substrate. No monomer sequence exists for metals, but the composition of the alloys may be altered by deposition of more of a given metal at a certain site without problems associated with polymer elongation; the problem with deposition of more metal droplets of the same volume to form different compositions is that array density must be decreased to accommodate the most voluminous composition made, as the size of droplets is not conveniently adjusted over wide ranges of droplet volume. An additional reason to reduce array density in alloy formation is that with alloys it is often desirable to form a material that has a bulk and surface, rather than a film which has a surface but not a bulk and therefore the properties of the thin-layer “surface” are not the same as the surface of the bulk material (see generally Somorjai, Surface Chemistry and Catalysis, supra).

As may be readily appreciated, an infinite number of compositions of any two metals exist. Composition in terms of combinatorial synthesis of arrays of alloys by acoustic ejection of fluid is complicated by the volumetric acoustic ejection being different for different molten metals having different densities and interatomic interactions, but the different stoichiometric compositions generated correspond to different combinations of metal and number of droplets deposited are reproducible, e.g. an alloy of 5 droplets of Sn ejected at an energy, E₁ and five droplets of Cu ejected at E₁ or E₂ will have the same compositions when duplicated under the same conditions, and the stoichiometric composition of alloys of interest can always be determined by SIMS. To promote uniform alloy formation it is desirable to spot all the droplets of molten metal to be deposited onto a site in rapid succession rather than waiting for a droplet to solidify before depositing another, although such combinatorial “stacks” are also of potential interest. As it is most convenient not to change acoustic energy between deposition of droplets, the same energy is most conveniently used for ejecting different metals, and the stoichiometric and other, including surface properties of the material so generated may be determined later and reproduced by exact duplication of the synthetic process. The molten metals must be at an appropriate temperature (T) above its melting point to ensure that the droplet is still molten when it reaches the substrate. In addition to an inert gas environment, which may be appreciated to be important if making alloys rather than stacks of oxidized metal salts is desired, to prevent oxidation of the metals especially at the surface of the droplets, a gas with low heat capacity is preferable to high heat capacity gases. In addition, the temperature of the substrate and the distance between the substrate and the fluid meniscus may be adjusted to ensure molten material reaching the substrate and remaining molten for sufficient time to permit alloying with subsequently deposited droplets. Furthermore, after a given alloy composition is made at a given array site, both the ejection energy and the meniscus to substrate distance may require adjustment in light of the foregoing considerations, as is readily appreciated.

A convenient systematic combinatorial approach involves selecting a number of molten compositions for ejection and a total number of droplets deposited at each site. Array density of 10⁵ sites/cm² is convenient as each site is conveniently a 100 μm square, an area which can be easily appreciated to accommodate 10, approximately picoliter (pL) sized, droplets, because 10 pL spread uniformly over the area of the site would be only 1 μm, deep, and gravity prevents such complete spreading and low surface angle.

For 4 different molten metallic compositions available for ejection and 10 droplets, it may easily be demonstrated that 342 possible compositions exist, and likewise for 15 droplets, 820 possible compositions exist in terms of droplet number. The number of compositions may be obtained by calculating the number of different compositions of one, two three, four up to the number of the molted ejected metals separately, and adding the sum. For d droplet compositions with m ejected metals (although the molten ejection vessel contents need not be a pure metal, and may themselves be an alloy):

^{d}Qₘ=_{n=1→m}Σ(S(m)ₙ)*(Z(m,d)ₙ)

^{d}Qₘ is defined as # metal compositions for d-# droplets, m-# of molten compositions available to be ejected; S(m)ₙ is the # of unique sets having n members of the m available molten compositions; Z(n, d)ₙ is # of d droplet combinations of n used of the m available for deposition, corresponding to S(m)ₙ. Further:

Z(m,d)ₙ=_{i=1→C(n, d)}ΣO(n,d)ᵢ

CS(n, d),ᵢ denotes ith set of coefficients for n components that add to d droplets, with C(n, d), representing the total number of coefficient sets satisfying this requirement; O(n, d)ᵢ is the number of possible orderings of the ith set of n coefficients for d droplets corresponding to CS(n, d),ᵢ.

For example, for d=10, m=4, let the 4 vessels contain, respectively, Sn, In, Cd and Zn.

1 metal compositions (n =1):

Z(4, 10)₁=_{i=1→C(1,10)}ΣO(1, 10)₁=1*1, because the only possible coefficient is 10, and it can be ordered in only one way. The corresponding S(4)₁ is 4, as 4 unique sets of 1 metal can be chosen for ejection.

2 metal compositions (n =2):

The corresponding S(4)₂ is 6, as [4!/2!]/2! unique sets of 2 metals can be chosen for ejection. The C(2, 10) unique sets of 2 non-negative, nonzero coefficients that add to 10, such as (9, 1) and the corresponding O(2,1 0), are [denoted by the notation {CS(2,10)₁:O(2,10)1, CS(2,10)₂, :O(2,10)₂ . . . CS(2, 10)_{C(n, d)}:O(2, 10)_{C(n, d)}}]: {(9, 1):2, (8, 2):2, (7, 3):2, (6, 4):2, (5, 5):1};→Z(4, 10)₂=_{i=1→C(}2,10)ΣO(2, 10)₁, =2+2+2+2+1=9.

3 metal compositions:

The corresponding S(4)₃ is 4 ([4!/1!]/3!), 4 unique sets of 3 metals can be chosen for ejection. The C(3, 10) unique sets of 3 non-negative, nonzero coefficients that add to 10 are: {(8, 1, 1):3, (7, 2, 1):6, (6, 3, 1):6, (6, 2, 2):3, (5, 4, 1):6, (5, 3, 2):6, (4, 4, 2):3, (4, 3, 3):3};→Z(4, 10)₃=_{i=1→C(}3, 10)ΣO(3, 10)i3+6+6+3+6+6+3+3+.

4 metal compositions:

The corresponding S(4)₄ is 1 (4!/4!), as 1 unique sets of 4 metals can be chosen for ejection. The C(4, 10) unique sets of 4 non-negative, nonzero coefficients that add to 10 are: {(7, 1, 1, 1):4, (6, 2, 1, 1):12, (5, 3, 1, 1):12, (5, 2, 2, 1):12, (4, 4, 1, 1):6, (4, 3, 2, 1):24, (4, 4, 2, 2):6, (3, 3, 3, 1):4, (3, 3, 2, 2):6};→Z(4, 10)₄=_{i=1—C(4, 10})ΣO(4, 10)i=4+12+12+12+6+24+6+4+6=86.

From the preceding:

¹⁰Q₄=_{n=1→4}Σ(S(4)ₙ)*(Z(4,10)ₙ)=4*1+6*9+4*36+1*86=288.

An appropriate substrate for the alloy array of acoustically deposited molten metallic compositions is made of sintered alumina by conventional methods or obtained commercially. An array of Sn (mp=281.8° C.), In (mp=156.6° C.), Cd (mp=320.9° C.) and Zn (mp=419.6° C.) components (e.g. pure ejected molten metal compositions) is formed by acoustic deposition of 15 droplets/array site on a sintered alumina substrate. Thickness of the substrate is about 0.25 cm, to withstand the heat. The site density is chosen to allow all possible droplet compositions that can be made from four metals with 15 droplets, 820 possible compositions including, for example (in droplets): 14(Sn), 1*(In); 12Sn, 1In, 1Cd, 1Zn; 1Sn, 12In, 1Cd, 1Zn. These compositions and the 901 remaining compositions may be obtained as above demonstrated for 10 droplet compositions of four components. The chosen density is 1000 sites/cm2, corresponding to a nominal site size of 333×333 μm, and permitting the complete collection of compositions to be made on a 1 cm² area. Duplicate copies of the array are made on a commercial microscope slide sized strip of substrate, separated by ½ cm to permit the convenient separation of the two identical arrays.

The acoustic energy is adjusted to yield an average droplet volume of about 1 pL, and 15 droplet ejection that does not exceed the 333×333 μm square area provided for the site, under the desired conditions, including atmosphere pressure and composition, length of droplet flight, substrate temperature. After the average droplet size is adjusted to about one pL, 15 droplets of each metal are acoustically ejected onto a site and the ejection energy is adjusted downwards if any of these pure sites exceed the margins of the site. Enough sites exist for all 820 possible compositions to be ejected onto each 1 cm square array after using up to 96 of the available 1000, sites for calibration, but the single ejected component sites so created may function as the single composition sites if sufficiently the localized region within which the alloy resides similar to the other sites in dimension, as dimensions affect cooling and a substantially different geometry would not be precisely the same material.

Although the actual volumes ejected of the different molten components may be adjusted to be equal by using a different acoustic energy of ejection, more rapid ejection is possible if the ejection energy is held constant. It is readily apprehended that if too wide a discrepancy exists between the droplet volumes ejected for each component, that the overall geometry of the cooling composition could vary widely depending on its makeup, but this is not the case for the metals being deposited here, because both their densities and factors determining interatomic interactions in the molten state, such as polarizability, are sufficiently similar. In all cases the conditions for the formation of the alloy at a given site are always reproducible, and the actual composition and other physical properties of the composition may be ascertained by physical methods including all described surface physical characterization methods.

Because of the toxicity of Cd, the acoustic deposition of the molten metals is carried out in a separate atmospherically controlled low humidity chamber under Ar gas to reduce undesired reactions and cooling. Higher heat capacity inert gases and more reactive gases, such as O₂, and O₂/hydrocarbons may be used for experiments under different conditions, but may require adjustment of the distance between the fluid meniscus and substrate or the temperature of the molten reagent to be ejected or both to ensure that the droplet reaches the substrate in a molten state.

After calibration the first duplicate array is spotted by acoustic ejection as described onto a substrate maintained at a temperature of 125° C. Each of the 820 possible 15 droplet compositions is made by sequentially depositing fifteen droplets at each site, the 15 droplets deposited according to the different coefficient arrangements described above. The metals are maintained at a known temperature that is sufficiently greater than the mp of the metal that the ejected droplet arrives at the substrate surface molten under the conditions, including distance of flight and pressure, temperature and heat capacity of the atmosphere. The droplets are deposited at each site lowest melting metal first in order of increasing melting temperature with the highest melting temperature metal deposited last, e.g., In, Sn, Cd, Zn, so that successive droplets of higher melting temperature metal will melt any solidified material. The procedure is repeated at different substrate temperatures at 5 degree intervals until arrays formed with substrate temperature ranging from 40° C. to 425° C. are formed.

### EXAMPLE 5

Microbatch Crystallization Experiment

An experiment is conducted using a matrix of 15360 separate crystallization conditions to attempt to crystallize a small amount of a protein isolated and purified from rat brain tissue. The protein's sequence is known, but attempts to express the protein in E. coli have failed due to aggregation of unfolded protein. Heuristic sequence homology analysis and computational modeling indicate that the protein may be in the HSP class. Spectroscopic techniques reveal a significant amount of secondary structure. Native PAGE and SDS PAGE confirm the isolate to be a single polypeptide of high purity and having a significant degree of native conformational structure under non-denaturing conditions. Ligand screening by conventional methods does not reveal any ligands.

The protein concentration is in the range of 1.5 to 200 mg/ml. The total small fluid volume is 40 picoliters (pL) for each separate crystallization trial and requires approximately 7.5×10⁻³ mg of protein for the entire trial (for average small volume protein concentration of about 14 mg/ml). For convenience, the drops are ejected upward onto the underside of a silanized glass plate. Several solutions will be combined into the final 40 pL drop to create 15360 unique experiments. It will be readily apprehended that these experiments may be performed in duplicate, triplicate or other redundant modes as desired. Different buffering reagents employed include sodium acetate, sodium citrate, 2[N-Morpholino]ethanesulfonic acid (MES), N-[2-Hydroxyethyl]piperazine-N′-[2-ethanesulfonic acid] (HEPES), TRIS (tri[Hydroxymethyl]amino-methane, and sodium borate. Polymers include polyethylene glycol (PEG) 6000, PEG 8000, PEG 10,000, PEG 20,000, PEG Monomethyl ether (PEG MME) 550, PEG MME 2000, PEG MME 5000, Jeffamine M-600 and Jeffamine ED-2001. Salts and metal salts employed include Ferric chloride, ammonium sulfate, cesium chloride, zinc sulfate heptahydarate, and nickel (II) chloride. Organic additives tested for ability to increase the likelihood of forming crystallographic quality crystals include dioxane, imidazole, 1,6 hexane diol, tert-Butanol, anhydrous glycerol, ethanol, and ethylene glycol. Instead of employing a pure combinatorial approach (see preceding examples), a heuristic combinatorial approach is employed using known crystallization conditions for sequence homology related proteins is obtained from the Biological Molecule Crystallization Database (NIST/CARB BMCD). The data obtained permits narrowing the combinatorial experiments to 15360 by appropriate choice of reagents. The BMCD data indicates that a macromolecular structuring ligand is unlikely, the closest homologous crystallized proteins not requiring a ligand to form diffraction quality crystals, and the known structures reveal no complexing biomolecule ligand.

The reagent formulations or crystallization mixtures, are dispensed in a combinatorial fashion, as described in the preceding examples, to create as many as 3840 different buffer compositions. These buffer compositions are contained in separate containers, namely well plate wells. Three 1536 well plates will provide adequate storage for 3840 separate solutions. Solution volumes of 5 mL total per well will provide more volume than is required for all the different crystallization trial experiments. In addition, crystallization trials will take place at both 25° C. and 4° C. and at protein concentrations of 50 mg/ml and 5 mg/ml. Therefore, a total of ten, 1536 well plates will be used to contain 15360 separate crystallization trials. 20 pL of protein solution will be combined with 20 pL of premade buffer solution to create the final drop formulations or trial drops.

To prevent rapid vapor diffusion of the trial 40 pL drops, a microbatch technique is adapted to the picoliter volume scale attainable by focused acoustic ejection, rendering a “picobatch” technique. The technique employs oils to vary the rate of vapor diffusion. In a standard hanging or sitting drop vapor diffusion set up paraffin oil overlies the experimental drop (Chayen et al. (1990) J. Appl. Cryst. 23:297). The modified microbatch technique employs a mixture of paraffin and silicon oils (D'Arcy et al. (1996) Journal of Crystal Growth 168:175-80). The vapor diffusion rate control method (Chayen et al. (1997) J. Appl. Cryst. 30:198-202) 200 microliters of oil is applied over the reservoir solution for standard sized droplet crystallization method reservoir wells. In each of these methods, the oil acts as a barrier to vapor diffusion between the reservoir and the drop. Paraffin oil permits such limited kinetics of vapor diffusion that the drop behaves as a batch experiment. Silicon oil renders results more similar to those when no oil is used. The conventional microbatch methods require that the experimental droplet be pipetted under the layer of oil. Using a mixture of paraffin oil and silicon oil permits fine adjustment of the rate of vapor diffusion between the drop and the reservoir. The rate of vapor diffusion is also a function of the thickness of the oil layer placed over the droplet or reservoir or both.

In the microbatch techniques, a drop is encapsulated in a mixture of paraffin oil and silicon oil. The higher the fraction of paraffin oil, the slower the vapor diffusion rate. A 2:1 ratio of paraffin oil to silicon oil is used in these particular experiments.

To prevent evaporation of the solutions, the oil mixture is dispensed over the crystallization mixtures prior to ejection to the silanized substrate above the wells containing the crystallization mixtures. Ejecting both the crystallization protein solutions through an overlying layer of immiscible oil, the trial drops will be rapidly encapsulated in the oil mixture. This rapid encapsulation will slow the rate of vapor diffusion and enable crystal formation.

To complete the setup of the crystallization trials, five 1536 plates containing 7680 trial drops will be placed at 4° C. and the other 7680 trial drops will be placed at 25° C. The drops may be scanned acoustically for the formation of either precipitate, protein crystals, or buffer crystals. Drops that evidence protein crystal formation may be readily distinguished from buffer salts by their different acoustic scattering properties. Acoustic microscopy may also be used to distinguish precipitate from crystals based on particle size. Typically, crystal diameters far exceed the size of precipitate consisting of denatured or aggregated protein. Once crystals have been located, they may be removed from the trial drops and used for preliminary diffraction experiments to determine the quality of diffraction. Alternatively, microcrystals may be acoustically ejected to a series of drops containing new combinations of crystallization reagents and the protein and used as seed crystals for further crystallization trials.

### EXAMPLE 6

Combinatorial Optimization of Crystallization Conditions for a Protein with Conformational Flexibility

In many crystallization experiments, an attempt is made to find solvent conditions that produce homogeneous crystals that yield a diffraction pattern that permits solving the crystal structure to a high degree of resolution (a resolution to distances of 3.5 Å or smaller being a better than 3.5 Å resolution or >3.5 Å). The inherent conformational flexibility or lack of determinate structure of the protein may prevent the formation of crystals, for example Prion protein in the cellular conformation (PrP^{C}) is difficult to crystallize. PrP^{C} has been shown to have predominantly random coil structure, with the quaternary structure being a rather random spatial relationship between a single folded domain having conventional secondary and tertiary structure and the portion of the amino acid sequence characterized as a domain having a random coil secondary and tertiary structure (Liu et al. (1999) supra; Zahn et al. (2000) Proc Natl Acad Sci USA 2000 Jan 4;97(1):145-50.). Zahn et al., supra, have demonstrated that the structured domain is more ordered and two alpha helices more structured in peptides having a shorter random coil N-terminus, e.g. PrP sequence of amino acid residues 121-230 (PrP(121-230)) has a more structured globular domain (residues 125-228) than does PrP(23-230). Indeed the structure of heterologously expressed PrP has been shown by Jackson et al., (1999) Biochim Biophys Acta 1431(l):1-13, to depend upon solvent conditions including pH by unfolding experiments, with the disulfide bond reduced sequence capable of assuming both PrPC-like and a scrapie conformer (PrP^{Sc}) like structure depending on pH. Thus the possibility exists that the random coil structure under the experimental conditions of the solution NMR experiments could be converted into a more determinate and consequently crystallizable structure by either solvent conditions, an as yet undiscovered ligand or a combination of these (crystallization requiring the same rather than multiple unit cells and consequently conformation, or at a minimum several determinate conformations rather than an infinite number of random conformations). In this case, the search for appropriate solvent, or more accurately microenvironment conditions may be complemented by the creation of variants of the protein that could form high quality crystals. An example of this approach is provided by early studies of myoglobin (Kendrew, J. C. and Parrish, R. G. (1956) Proc. R. Soc. Lond. A 238, 522-527); it was found in this study that sperm whale myoglobin produced high quality crystals, while other myoglobin variants failed to crystallize. Moreover, sperm whale myoglobin has a high degree of homology to human myoglobin, allowing structural inferences to be made among a group of protein variants.

Similarly, single amino acid substitution variants of PrP have been demonstrated to have different structural stability characteristics, specifically NMR-observability of the residues in the loop 166-172 definition of the C-terminal part of the third helix of the globular domain is enhanced for human PrP(R220K) (PrP(mutated: from [single letter amino acid code designation R] at amino acid sequence position 220 to [K], and of the complete loop 166-172 for hPrP(S170N) (Calzolai et al. (2000) Proc Natl Acad Sci USA 97(15):8340-5).

In the conjunction with the methods of the instant invention, a mutant library of proteins may be created via standard techniques (site-directed mutagenesis, error-prone PCR, directed evolution, and the like) and small quantities of protein may be expressed and isolated. This library of proteins may then be conveniently isolated by including a glutathione-S-transferase or other convenient affinity tag. A large matrix of 5,000 proteins could be subject to 1000 different conditions requiring 5,000,000 different hanging drop experiments, without duplication.

Using Picoliter dropwell technology and a non diluting approach this would require the creation of 50 drop well plates, each containing 100,000 different solutions. With a protein and crystallization solution diluting approach, 5,000 protein solutions and 1000 crystallization condition solutions could be employed using standard 1536 well plates could be used to form arrays on coverslips placed over conventional hanging drop setups. For the hanging drop array method, 40 pL droplets are arrayed at a density of about 10,000/cm² as is evident from the preceding examples, using about a 7mm×7mm square area of the 18mm diameter coverslip, permitting 5,000 experimental sites per hanging drop container, thus requiring a total of 1000 conventional hanging drop containers. Either approach is practicably attainable. Oil coating of droplets is possible for both (microbatch methods). The reservoirs of the hanging drop setups can also be capped with oil (vapor diffusion method). The drop well plates can be placed in contact with a fluid reservoir, that can be capped with oil. Alternatively 100 drop well plates can be employed with every other well containing only solvent.

Both techniques are employed with 10 fold duplication of each experiment. Because PrP^{Sc} has a large amount of hydrophobic β sheet content and aggregates, the PrP^{C} containing solutions are not contacted with any oil. The hanging drop reservoirs are capped with oil. To vary conditions the drop well method using every other well as a solvent reservoir is employed and no oil is added to control diffusion. The initial experiments are conducted by mutating hPrP(121-230). Instead of random combinatorial mutation of the entire sequence, error prone PCR is performed on the cDNA sequences coding the amino acid sequence regions of PrP(121-230) already shown to be less structured and susceptible to being more structured, and flanking regions. The mutated sequence segments are then ligated to the rest of the coding cDNA sequence to render the experimental proteins.

The drop well plates or hanging drop coverslip arrays may be rapidly scanned for nascent crystals via scanning acoustic microscopy. Buffer crystals and protein crystals are conveniently separated by this method. Wells or hanging picodroplets in which any nascent crystals are detected are diluted slightly. The drop wells or array sites containing protein crystals are further evaluated for crystal quality by scanning diffractometry. Those forming diffraction grade crystal are collected, and more of those sequences that crystallize are synthesized and used as seeds in scaled-up crystallization experiments, as necessary. Those protein crystals that are not of diffraction grade are diluted slightly for recrystallization, precipitate or precipitate/microcrystal containing array sites or drop wells are also diluted, and reevaluated acoustically and by scanning diffractometry.

### EXAMPLE 7

Combinatorial Optimization of Crystallization Conditions for a Protein with Conformational Flexibility

A conformationally labile protein such as PrP protein may be co-crystallized in the presence of antibody or ligand that provides the structural stability required to promote the growth of high quality crystals. Additionally, studies of protein complexed with a biologically relevant ligand may provide useful information about both structure and function. An example of the productive use of this technique towards obtaining high crystalline order is the complex between λ repressor and DNA (Jordan, S. R., Whitcombe, T. V., Berg, J. M., and Pabo, C. O. (1985) Science 230, 1383-1385). To obtain crystals, the composition of the λ repressor ligand, a DNA binding sequence, was systematically varied. Randomized DNA may be produced synthetically by conventional phosphoamidite DNA chemistry. In cases where a large matrix of conditions is required to obtain homogeneous crystals, 50,000 ligand variants could be combined with a protein and subject to 1000 solvent conditions for crystallization trials. This would mean a total of 50,000,000 different conditions and require 500 drop well plates, each containing 100,000 different samples. If necessary, the density of the drop well plate may be changed, and a 25mm×75mm plate can readily accommodate over 1,000,000 drops.

This density reduces the number of required plates to 50 for the experiment described herein.

Alternatively the hanging picodroplet array method described in the preceding example may be employed, requiring 10,000 conventional hanging droplet containers. Because the solvent may be added to each container by machine, this technique is practicable, but the solvent reservoir free approach is more convenient for the first generation. Any protein crystallization conditions found to yield crystals of sub-diffraction grade crystals despite post-crystallization dilution can be crystallized by the hanging picodroplet array method with and without seeding. The experimental wells and/or array sites may be evaluated acoustically for crystal quality by the methods described in the preceding example or hereinabove generally, and further manipulations such as dilution may be performed.

### EXAMPLE 8

Method for Modified Microbatch Crystallization

As described in preceding Example 5, oil on droplets or in reservoir wells or both may be used to control rates of vapor diffusion. Control of rate of vapor diffusion by coating experimental drops used in hanging or standing drop methods with paraffin oil was demonstrated by Chayen et al (1990) supra. As solvent diffusion into or out of the droplet is very slow, all reagents are effectively present at same concentration, and thus the droplet remains substantially static, explaining the use of the term “microbatch”. D'Arcy, et al. (1996) supra, uses silicon fluids which are polymers of —(Si(CH₃)₂—O—)ₙ—, for a modified oil coating method which allows more diffusion. One can thus perform this experiment under oil and have diffusion from an aqueous solvent through the oil. Chayen et al (1997) supra, intoroduced a method whereby the reservoir fluid is coated with an overlying oil layer, which can be adjusted for both composition and thickness, and combined with the microbatch methods that control diffusion by coating the droplet. In the preceding example, the protein solutions were diluted with the combinatorial crystallization buffer solutions. The instant example teaches an ejection technique wherein the protein is not diluted, and the entire crystallization experimental solution is pre-mixed in well plate wells.

Paraffin oil is ejected or otherwise aliquotted into a 1536 well plate which contains a protein dissolved in a variety of different solvent conditions. Among the parameters which are varied in the solution are pH, protein concentration, concentration of PEG, and ionic strength. The protein solution is ejected through the immiscible paraffin oil layer onto a receiving substrate surface. This results in a protein solution encapsulated in an immiscible oil. Additionally, a second oil such as a silicon oil may be ejected onto the existing protein drops. The addition of a second oil layer to the paraffin oil layer provides a means of controlling the rate of vapor diffusion from the protein solution. The more silicon oil in the paraffin/silicon oil mixture, the greater the rate of vapor diffusion. The use of a flat receiving plate allows for the simultaneous screening of a greater variety of crystallization conditions than the 1536 conditions that may be screened in the well plate. For drop volumes of 50 picoliters, over 1,000,000 drops may be screened in the area of a conventional 1536 well plate.

The protein chosen for this method is the PrP(121-230) mutation yielding the highest quality, albeit still too small, crystal from preceding Example 6. Because of concern that contacting oil to the solution containing the protein, a parallel experiment is performed using a standing droplet setup and no oil contacting protein solution, employing density of about 10,000/cm² and 7mm ×7mm area of each coverslip, and 200 conventional standing drop setups for 1,000,000, analogous to the hanging picodrop array described in preceding examples. The solvent for this standing picodrop array method is capped with the same oil mixture employed for the modified microbatch method (vapor diffusion control method). The paraffin and silicon oils can be combined in different ratios to control vapor diffusion rates, as previously mentioned.

### EXAMPLE 9

Single Reservoir Per Hanging Drop Array Crystallization of a DNA Binding Transcription Factor Complexed to Cognate DNA

A newly isolated frog transcription factor is isolated and expressed in a prokaryote by conventional methods. Sequence homology indicates the protein is a member of the zinc finger DNA binding protein family. Non-denaturing PAGE in the presence of excess zinc establishes several different conformers with different mobility. Addition of EDTA to the non-denaturing PAGE reduces the observed electrophoretic pattern to a single mobility band, as is observed by standard PAGE thus establishing that several conformations of the pure protein exist rather than impurities. NIST/CARB BMCD is accessed to provide information as to crystallization conditions and DNA sequences bound by homologous proteins. With knowledge as to the binding sequences of homologues, a heuristic combinatorial (e.g. not varying strong consensus nucleotides) ssDNA array is constructed by acoustic deposition, as described in a preceding example the DNA sequence covalently attached to the substrate surface. Routine methods of synthesizing DNA are used to heuristo-combinatorially synthesize all complementary sequences and an array of dsDNA is formed by stringent hybridization with reannealing to increase stringency of complementarity.

The array is contacted with a thin overlying aqueous layer of the protein solution under physiologic conditions in the presence of Zn²⁺. An infrared video camera is used to image the array and, after integration of the signal over time, those sites releasing the most heat are identified. The DNA sequences of the hottest sites are tested for binding, identifying the best binding DNA as ascertained by differential scanning calorimetry (DSC). The binding constant as determined by DSC is used to determine the correct excess of DNA to bind substantially all the protein without being in such great excess to interfere with crystallization. Non-denaturing PAGE in the presence of this amount of DNA, reveals a single mobility band and no discernable signal from conformers not binding DNA.

The hanging picodroplet array described in previous examples is employed to attempt to crystallize the protein. The information from NIST/CARB BMCD on similar crystallized complexes permits employment of a heuristic combinatorial crystallization strategy, employing 10,000 crystallization conditions. Each experiment is duplicated 10 times for a total of 100,000 experiments. Twenty conventional hanging drop containers each containing an array of 5,000 hanging picodroplets at a density of about 10,000 picodroplets are employed. Of the experiments demonstrated to yield protein/DNA co-crystals, several are shown to yield high quality crystals that are too small to structure. The conditions are scaled up and the small crystals are acoustically ejected directly from their array site into the scaled up droplet. The second generation scaled-up experiment yields several fine diffraction quality crystals large enough to structure by crystallographic means. Knowledge of the crystallization conditions permits crystallization of specifically substituted heavy metal carrying amino acids for phasing.

### EXAMPLE 10

Membrane Protein Crystallization

A membrane protein isolated from Xenopus neural tissue is expressed in a prokaryote. The protein is only soluble in aqueous solution with a surfactant. Sequence homology analysis reveals that the protein is in the rhodopsin family. The protein forms 2-D arrays easily and in a phospholipid bilayer low resolution structure data is obtained using electron crystallography Non-denaturing PAGE (in the presence of adequate non-ionic surfactant) establishes the protein is pure and structured. NIST/CARB BMCD data on the most homologous protein crystallized in 3-D permits a heuristic combinatorial approach using salts and non-ionic surfactants including octyl glucoside and employing the hanging picodroplet array of previous examples. The solvent reservoirs for the hanging picodroplet setup are capped with oil of varying composition. The finest crystals are obtained using a 50/50 paraffin/silicone oil ratio, but are too small to structure.

These crystals are used to scale up the experiments to yield high diffraction quality crystals sufficiently large to structure the protein crystallographically. Some of the small crystals are used to combinatorial test heavy-atom solutions to obtain heavy atom isomorphous replacement by the multiple isomorphous replacement technique (McRee, Practical Protein Crystallography, supra). Isomorphously replaced crystals of appropriate size are obtained permitting solution of the structure to a resolution of 2 Å.

We claim:

1. A method for generation of a small fluid volume containing a moiety of interest for crystallization and having a known composition and known chemical and physical conditions comprising acoustically depositing one or more reagent-containing fluid droplets at a site on a substrate surface, wherein at least one of the reagent-containing fluid droplets deposited at the site contains the moiety of interest for crystallization and at least one of the reagent-containing fluid droplets contains an agent that increases the likelihood of crystal formation.

2. The method of claim 1 further comprising detecting whether the moiety of interest for crystallization has formed crystals.

3. The method of claim 1 wherein an array of small fluid volumes each having a known composition and a known chemical and physical conditions are generated on the substrate surface.

4. The method of claim 1 wherein at least one of the reagent-containing fluid droplets deposited at the site contains one or more crystallization promoting agents selected from the group consisting of inorganic salts, inorganic molecules, organic salts, organic non-polymeric molecules and polymers.

5. The method of claim 4 wherein the crystallization promoting agent is a surfactant or chaotropic agent.

6. The method of claim 1 wherein the moiety of interest for crystallization is solubilized by a surfactant or chaotropic agent.

7. The method of claim 4 wherein the moiety of interest for crystallization is solubilized by a surfactant or chaotropic agent.

8. The method of claim 1 or 4 wherein the moiety of interest for crystallization is stabilized in a specific conformation by a ligand.

9. The method of claim 1 wherein the moiety of interest for crystallization comprises a biomacromolecule.

10. The method of claim 4 wherein the moiety of interest for crystallization comprises a biomacromolecule, wherein the biomacromolecule is stabilized in a specific conformation by a ligand selected from the group consisting of ions, non-polymeric molecules and biopolymers.

11. The method of claim 10 wherein the ligand comprises a divalent cation, a steroid, a retinoid or a biopolymer comprising a sequence of monomers, the monomers selected from the group consisting of monosaccharides, amino acids and nucleotides.

12. The method of claim 10 wherein the ligand is an ionic constituent of a salt that functions as a crystallization promoting agent.

13. The method of claim 6 wherein the surfactant or chaotropic agent that solubilizes the moiety of interest is a crystallization promoting agent.

14. The method of claim 6 wherein moiety of interest comprises a biomacromolecule the surfactant or chaotropic agent that solubilizes the biomacromolecule is a crystallization promoting agent.

15. The method of claim 1, 2, 3, 6 or 10 wherein the moiety of interest comprises a biomacromolecule comprising a partially or fully native protein domain.

16. The method of claim 15 wherein the biomacromolecule comprises a fully or partly native protein.

17. The method of claim 1, 2, 3 or 6 wherein the moiety of interest comprises a partially native protein domain.

18. The method of claim 17 wherein the moiety of interest additionally comprises a fully denatured protein domain.

19. The method of claim 18 wherein the biomacromolecule additionally comprises a fully denatured protein domain.

20. The method of claim 17 wherein the moiety of interest additionally comprises a fully denatured protein domain and a native protein domain.

21. The method of claim 10 wherein at least one of the reagent-containing fluid droplets deposited at the site contains a second biomacromolecule.

22. The method of claim 6 further comprising means for detecting whether the moiety of interest for crystallization has formed crystals.

23. The method of claim 8 further comprising means for detecting whether the moiety of interest for crystallization has formed crystals.

24. The method of claim 10 further comprising means for detecting whether the moiety of interest for crystallization has formed crystals.

25. The method of claim 6 wherein an array of small fluid volumes each having a different known composition and different known chemical and physical conditions is generated on the substrate surface.

26. The method of claim 8 wherein an array of small fluid volumes each having a different known composition and different known chemical and physical conditions is generated on the substrate surface.

27. The method of claim 10 wherein an array of small fluid volumes each having a different known composition and different known chemical and physical conditions is generated on the substrate surface.

28. The method of claim 1, 2 or 3 further comprising controlling temperature of the substrate and ambient temperature and pressure surrounding the reagent containing droplets and the small fluid volumes.

29. The method of claim 4 or 6 further comprising detecting whether the moiety of interest for crystallization has formed crystals and controlling the temperature of the substrate and ambient gas temperature and pressure surrounding the reagent-containing droplets and the small fluid volumes.

30. The method of claim 8 further comprising detecting whether the moiety of interest for crystallization has formed crystals and controlling temperature of the substrate and ambient gas temperature and pressure surrounding the reagent containing droplets and the small fluid volumes.

31. The method of claim 10 further comprising detecting whether the biomacromolecule has formed crystals and controlling temperature of the substrate and ambient gas temperature and pressure surrounding the reagent containing droplets and the small fluid volumes.

32. The method of claim 3 further comprising detecting whether the moiety of interest for crystallization has formed crystals and controlling temperature of the substrate and ambient gas temperature and pressure surrounding the reagent containing droplets and the small fluid volumes.

33. The method of claim 3 wherein at least one of the reagent-containing fluid droplets deposited at the site contains one or more crystallization promoting agents selected from the group consisting of inorganic salts, organic salts, organic non-polymeric molecules and polymers.

34. The method of claim 33 wherein the crystallization promoting agent is a surfactant or chaotropic agent.

35. The method of claim 33 wherein the moiety of interest for crystallization is solubilized by a surfactant or chaotropic agent.

36. The method of claim 35 wherein the moiety of interest for crystallization is stabilized in a specific conformation by a ligand selected from the group consisting of ions, non-polymeric molecules and biopolymers.

37. The method of claim 36 further comprising detecting whether the moiety of interest for crystallization has formed crystals and controlling temperature of the substrate and ambient gas temperature and pressure surrounding the reagent containing droplets and the small fluid volumes.

38. The method of claim 2 wherein the detecting is acoustic detecting.

39. The method of claim 37 wherein the detecting is acoustic detecting.

40. The method of claim 39 wherein each small fluid volume contains polyethylene glycol and dimethyl sulfoxide.

41. The method of claim 37 wherein the small fluid volume has a volume of about 1 picoliter to 30 nanoliters and the reagent containing droplets have a volume of about 0.1 picoliter to 10 nanoliters.

42. The method of claim 1 wherein the moiety of interest for crystallization is a biomacromolecule and the small fluid volume has a volume of about 1 picoliter to 30 nanoliters and the reagent containing droplets have a volume of about 0.1 picoliter to 10 nanoliters.

43. A method for generation of a small fluid volume, the small fluid volume containing a moiety of interest for crystallization and having a known composition and known chemical and physical conditions, and determining whether the known composition and the known chemical and physical conditions favor crystallization of the moiety of interest, the method comprising the steps:
(a) depositing one or more reagent-containing fluid droplets at a site on a substrate surface by focused energy ejection, at least one of the reagent-containing fluid droplets deposited at the site containing the moiety of interest for crystallization; and
(b) detecting for the presence and amount of crystals of the moiety of interest in the small fluid volume at the site.

44. The method of claim 43 further comprising:
(c) depositing by focused energy ejection one or more reagent-containing fluid droplets at a site on a substrate surface having a small fluid volume previously deposited at the site; and
(d) detecting for the presence and amount of crystals of the moiety of interest in the small fluid volume at the site.

45. The method of claim 44 wherein said detecting of steps (b) and (d) further comprises periodic detection of the amount and size of crystals

46. The method of claim 43 or 45 wherein said detecting is acoustic.

47. The method of claim 46 wherein an array of small fluid volumes each having a known composition and a known chemical and physical conditions are generated on the substrate surface.

48. The method of claim 43 wherein at least one of the reagent-containing fluid droplets deposited at the site contains one or more crystallization promoting agents selected from the group consisting of inorganic salts, organic salts, organic non-polymeric molecules and polymers.

49. The method of claim 47 wherein the crystallization promoting agent is a surfactant or chaotropic agent.

50. The method of claim 43 wherein the moiety of interest for crystallization is solubilized by a surfactant or chaotropic agent.

51. The method of claim 48 wherein the moiety of interest for crystallization is solubilized by a surfactant or chaotropic agent.

52. The method of claim 43 or 50 wherein the moiety of interest for crystallization is a biomacromolecule, the biomacromolecule being stabilized in a specific conformation by a ligand selected from the group consisting of ions, non-polymeric molecules and biopolymers.

53. The method of claim 52 wherein the ligand comprises a divalent cation, a steroid, a retinoid or a biopolymer comprising a sequence of monomers, the monomers selected from the group consisting of monosaccharides, amino acids and nucleotides.

54. The method of claim 52 wherein the ligand is an ionic constituent of a salt that functions as a crystallization promoting agent.

55. The method of claim 52 wherein the surfactant or chaotropic agent that solubilizes the biomacromolecule is a crystallization promoting agent.

56. The method of claim 52 wherein the biomacromolecule comprises a partially or fully native protein domain.

57. The method of claim 56 wherein the moiety of interest comprises a native protein.

58. The method of claim 55 wherein the biomacromolecule comprises a partially or fully native protein.

59. The method of claim 43 wherein the moiety of interest comprises a native protein or partially denatured protein.

60. The method of claim 59 wherein the moiety of interest additionally comprises a native protein domain.

61. The method of claim 59 wherein the moiety of interest additionally comprises a fully denatured protein domain.

62. The method of claim 59 wherein the moiety of interest additionally comprises a fully denatured protein domain and a native protein domain.

63. The method of claim 52 wherein at least one of the reagent-containing fluid droplets deposited at the site contains a second polypeptide.

64. The method of claim 50 further comprising means for detecting whether the polypeptide of interest for crystallization has formed crystals.

65. The method of claim 50 wherein an array of small fluid volumes each having a known composition and known chemical and physical conditions are generated on the substrate surface.

66. The method of claim 43 or 45 wherein said detecting is acoustic detection.

67. The method of claim 66 further comprising independently controlling temperature of the substrate and ambient temperature and pressure surrounding the reagent containing droplets and the small fluid volumes.

68. The method of claim 48 further comprising controlling the temperature of the substrate and ambient gas temperature and pressure surrounding the reagent-containing droplets and the small fluid volumes.

69. The method of claim 47 further comprising controlling temperature of the substrate.

70. The method of claim 47 wherein at least one of the reagent-containing fluid droplets deposited at the site contains one or more crystallization promoting agents selected from the group consisting of inorganic salts, inorganic molecules, organic salts, organic non-polymeric molecules and polymers.

71. The method of claim 70 wherein the moiety of interest for crystallization is a biomacromolecule, wherein the biomacromolecule is stabilized in a specific conformation by a ligand selected from the group consisting of ions, non-polymeric molecules and biopolymers.

72. The method of claim 71 further comprising independently controlling temperature of the substrate and ambient gas temperature and pressure surrounding the reagent containing droplets and the small fluid volumes.

73. The method of claim 45 wherein the detecting is acoustic detecting.

74. The method of claim 72 wherein the detecting is acoustic detecting.

75. The method of claim 72 wherein each small fluid volume contains polyethylene glycol and dimethyl sulfoxide.

76. The method of claim 75 wherein the small fluid volume has a volume of about 1 picoliter to to 30 nanoliters and the reagent containing droplets have a volume of about 0.1 picoliter to 10 nanoliters.

77. The method of claim 45 wherein the moiety of interest for crystallization is a biomacromolecule, the small fluid volume has a volume of about 1 picoliter to to 30 nanoliters and the reagent containing droplets have a volume of about 0.1 picoliter to 10 nanoliters.

78. A method for generation of a small fluid volume containing a polypeptide of interest for crystallization and having a known composition and known chemical and physical conditions comprising acoustically depositing one or more reagent-containing fluid droplets at a site on a substrate surface, at least one of the reagent-containing fluid droplets deposited at the site containing the biomacromolecule of interest for crystallization.

79. The method of claim 78 further comprising detecting whether the biomacromolecule of interest for crystallization has formed crystals.

80. The method of claim 78 wherein an array of small fluid volumes each having a known composition and known chemical and physical conditions are generated on the substrate surface.

81. The method of claim 78 wherein at least one of the reagent-containing fluid droplets deposited at the site contains one or more crystallization promoting agents selected from the group consisting of inorganic salts, organic salts, organic non-polymeric molecules and polymers.

82. The method of claim 81 wherein the crystallization promoting agent is a surfactant or chaotropic agent.

83. The method of claim 81 wherein the biomacromolecule of interest for crystallization is solubilized by a surfactant or chaotropic agent.

84. The method of claim 81 or 83 wherein the biomacromolecule of interest for crystallization is stabilized in a specific conformation by a ligand selected from the group consisting of ions, non-polymeric molecules and biopolymers.

85. The method of claim 84 wherein the ligand comprises a divalent cation, a steroid, a retinoid or a biopolymer comprising a sequence of monomers, the monomers selected from the group consisting of monosaccharides, amino acids and nucleotides.

86. The method of claim 84 wherein the ligand is an ionic constituent of a salt that functions as a crystallization promoting agent.

87. The method of claim 83 wherein the surfactant or chaotropic agent that solubilizes the biomacromolecule of interest is a crystallization promoting agent.

88. The method of claim 78 wherein the biomacromolecule of interest comprises a native protein domain or a partially denatured protein domain.

89. The method of claim 88 wherein the biomacromolecule of interest comprises a native protein.

90. The method of claim 78 wherein the biomacromolecule of interest for crystallization comprises a nucleic acid.

91. The method of claim 88 wherein the nucleic acid has a conformation.

92. The method of claim 78 wherein the biomacromolecule of interest comprises a partially native protein domain.

93. The method of claim 92 wherein the biomacromolecule of interest additionally comprises a native protein domain.

94. The method of claim 92 wherein the biomacromolecule of interest additionally comprises a fully denatured protein domain.

95. The method of claim 92 wherein the biomacromolecule of interest additionally comprises a fully denatured protein domain and a native protein domain.

96. The method of claim 84 wherein at least one of the reagent-containing fluid droplets deposited a t the site contains a second biomacromolecule.

97. The method of claim 84 further comprising means for detecting whether the biomacromolecule of interest for crystallization has formed crystals.

98. The method of claim 84 wherein an array of small fluid volumes each having a known composition and known chemical and physical conditions are generated on the substrate surface.

99. The method of claim 79 or 80 further comprising controlling temperature of the substrate and ambient temperature and pressure surrounding the reagent containing droplets and the small fluid volumes.

100. The method of claim 84 further comprising detecting whether the biomacromolecule of interest for crystallization has formed crystals.

101. The method of claim 100 further comprising independently controlling temperature of the substrate and ambient gas temperature and pressure surrounding the reagent containing droplets and the small fluid volumes.

102. The method of claim 80 further comprising detecting whether the biomacromolecule of interest for crystallization has formed crystals and controlling temperature of the substrate and ambient gas temperature and pressure surrounding the reagent containing droplets and the small fluid volumes.

103. The method of claim 80 wherein at least one of the reagent-containing fluid droplets deposited at the site contains one or more crystallization promoting agents selected from the group consisting of inorganic salts, inorganic molecules, organic salts, organic non-polymeric molecules and polymers.

104. The method of claim 103 wherein the biomacromolecule of interest for crystallization is solubilized by a surfactant or chaotropic agent.

105. The method of claim 80 or 104 wherein the biomacromolecule of interest for crystallization is stabilized in a specific conformation by a ligand selected from the group consisting of ions, non-polymeric molecules and biopolymers.

106. The method of claim 105 further comprising detecting whether the biomacromolecule of interest for crystallization has formed crystals and controlling temperature of the substrate and ambient gas temperature and pressure surrounding the reagent containing droplets and the small fluid volumes.

107. The method of claim 79 wherein the detecting is acoustic detecting.

108. The method of claim 106 wherein the detecting is acoustic detecting.

109. The method of claim 106 wherein each small fluid volume contains polyethylene glycol and dimethyl sulfoxide.

110. The method of claim 78, 79 or 80 wherein the biomacromolecule comprises a peptidic biopolymer selected from the group consisting of oligopeptides and polypeptides.

111. The method of claim 78, 79 or 80 wherein the biomacromolecule comprises a nucleotidic biopolymer selected from the group consisting of oligonucleotides and polynucleotides.

112. The method of claim 110 wherein the biomacromolecule additionally comprises a saccharidic biopolymer selected from the group consisting of oligosaccharides and polysaccharides.

113. The method of claim 78 wherein the small fluid volume has a volume of about 1 picoliter to 30 nanoliters and the reagent containing droplets have a volume of about 0.1 picoliter to 10 nanoliters.

114. The method of claim 78 wherein at least one of the reagent-containing fluid droplets deposited at the site contains two or more immiscible phases.

115. The method of claim 114 wherein the immiscible phases comprise an aqueous fluid and a phospholipid and the ejected droplets comprise the biomacromlecule of interest for crystallization embedded or anchored in a phospholipid micelle or a phospholipid bilayer.

116. A method for ejecting a different reagent-containing fluid from each of a plurality of fluid reservoirs toward designated sites on a substrate surface to form a combinatorial array of fluid droplets containing a biomacromolecule of interest for crystallization, the method comprising the steps:
(a) positioning an acoustic ejector so as to be in acoustically coupled relationship to a first reservoir containing a first reagent-containing fluid;
(b) activating the ejector to generate acoustic radiation having a focal point near the surface of the first fluid, thereby ejecting a first droplet of the first reagent-containing fluid from the first reservoir toward a first designated site on the substrate surface, whereby the droplet adheres to the designated site;
(c) repositioning the ejector so as to be in acoustically coupled relationship to a second reservoir containing a second reagent-containing fluid different from the first;
(d) activating the ejector as in step (b) to eject a second droplet of the second reagent-containing fluid from the second reservoir toward the first designated site on the substrate surface, whereby the second droplet adheres to the designated site and mixes with the first droplet;
(e) repeating steps (c) and (d) with additional reservoirs each containing a different reagent-containing fluid until the first designated site on the substrate surface has a small fluid volume adhering thereto; and
(f) repeating steps (a) through (e) for the remaining designated sites of the array until each site has a small fluid volume adhering thereto,
wherein each small fluid volume contains the biomacromolecule of interest for crystallization deposited contained in the droplets of the reagent-containing fluid, each small fluid volume occupying a designated site whereby the small fluid volumes are arrayed on the substrate surface at the designated sites and the composition and chemical conditions at each site are known from the steps of the method and the reagent-containing fluids deposited.

117. The method of claim 116 further comprising repeating steps (a) through (f) to alter the composition of the small fluid volume at each designated site.

118. The method of claim 117 further comprising controlling the physical conditions of the substrate and ambient gas physical conditions surrounding the fluid droplets and the small fluid volumes.

119. The method of claim 118 wherein the physical conditions controlled are temperature of the substrate and ambient gas temperature and pressure surrounding the fluid droplets and the small fluid volumes.

120. The method of claim 118 further comprising detecting crystallization of the biomacromolecule of interest.

121. The method of claim 120 wherein the detecting is by acoustic detection.

122. The method of claim 116 wherein at least one of the reagent-containing fluid droplets deposited at the site contains two or more immiscible phases.

123. The method of claim 116 wherein the immiscible phases comprise an aqueous fluid and a phospholipid and the ejected droplets comprise the biomacromlecule of interest for crystallization embedded or anchored in a phospholipid micelle or a phospholipid bilayer.

124. A system for combinatorial experiments to crystallize a moiety of interest and detect crystallization of the moiety of interest, the system comprising:
a plurality of sites arrayed on a substrate;
a plurality of reservoirs each adapted to contain a reagent-containing fluid;
an ejector comprising an acoustic radiation generator for generating acoustic radiation and a focusing means for focusing the acoustic radiation at a focal point near the fluid surface in each of the reservoirs; and
a means for positioning the ejector in acoustic coupling relationship to each of the reservoirs;
means for detecting crystallization of the moiety of interest; wherein
one or more of the materials arrayed on the substrate are contacted with one or more reagent-containing fluids by acoustic ejection, and any physical or chemical change detected at a site upon said contacting denotes a screening result for the material present at said site contacted with said one or more reagent-containing fluids.

125. The system of claim 124 wherein the moiety of interest is a biomacromolecule.

126. The system of claim 124, wherein said plurality of sites arrayed on the substrate, the sites present at a density of from about 1,000 to about 100,000,000 sites per square centimeter.

127. The system of claim 124 wherein the means for detecting is acoustic detection.

128. The system of claim 124 further comprising means for ascertaining the quality of the crystals.

129. The system of claim 126 wherein the means for ascertaining the quality of the crystals is by X-ray diffraction or scanning diffractometry.

130. A spatial array comprising a plurality of small fluid volumes having a known composition and known chemical and physical condition on a substrate surface divided into a plurality of discrete surface sites, each site containing one small fluid volume residing in a localized region of the site, wherein each small fluid volume contains a moiety of interest for crystallization and the different sites are present at a density of from about 1,000 to about 100,000,000 sites per square centimeter.

131. The array of claim 130 wherein the moiety of interest for crystallization is a biomacromolecule.

132. The array of claim 130, wherein said substrate surface comprises a polymer.

133. The array of claim 130, wherein said substrate surface comprises an amorphous, crystalline or molecular material.

134. The array of claim 130, wherein said substrate surface comprises a non-porous, impermeable material.

135. The array of claim 130, wherein said substrate surface comprises a porous, permeable material.

136. The array of claim 130 wherein a small fluid volume contains one or more crystallization promoting agents selected from the group consisting of inorganic salts, organic salts, organic non-polymeric molecules and polymers.

137. The array of claim 136 wherein the crystallization promoting agent is a surfactant or chaotropic agent.

138. The array of claim 136 wherein the biomacromolecule of interest for crystallization is solubilized by a surfactant or chaotropic agent.

139. The array of claim 136 wherein the biomacromolecule of interest for crystallization is stabilized in a specific conformation by a ligand selected from the group consisting of ions, non-polymeric molecules and biopolymers.

140. The array of claim 139 wherein the ligand comprises a divalent cation, a steroid, a retinoid or a biopolymer comprising a sequence of monomers, the monomers selected from the group consisting of monosaccharides, amino acids and nucleotides.

141. The array of claim 139 wherein the ligand is an ionic constituent of a salt that functions as a crystallization promoting agent.

142. The array of claim 130 wherein the plurality of small fluid volumes have a volume of about 1 picoliter to 30 nanoliters and the reagent containing droplets have a volume of about 0.1 picoliter to 10 nanoliters.

143. A method for detecting crystals in a fluid comprising emitting focused acoustic energy having a focal point in the fluid and detecting the acoustic properties at the focal point,
wherein crystals are detected by differences in acoustic properties from the fluid.

144. The method of claim 143 wherein the focal point is scanned through the fluid.

145. The method of claim 143 wherein the acoustic properties are acoustic impedance or acoustic attenuation.

146. The method of claim 143 further comprising distinguishing crystals from precipitates by differences in acoustic properties therebetween.

147. The method of claim 143 further comprising distinguishing biomacromolecule crystals from non-biomacromolecule crystals by differences in acoustic properties therebetween.

148. The method of claim 144 wherein crystal size is determined.

149. The method of claim 148, further comprising periodic detection of quantity and size of crystals for determining kinetics of crystal nucleation and growth.
